(19) United States
(12) Patent Application Publication
(10) Pub. No.: US 2003/0091333 A1
(43) Pub. Date: May 15, 2003

(54) Information recording apparatus, its control method, and information recording method

(76) Inventors: Takuya Kotani, Kanagawa (JP); Miyuki Enokida, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/292,718

(22) Filed: Nov. 13, 2002

(30) Foreign Application Priority Data
Nov. 15, 2001 (JP) 2001-350605
Nov. 15, 2001 (JP) 2001-350606
Nov. 15, 2001 (JP) 2001-350607
Nov. 15, 2001 (JP) 2001-350608
Nov. 15, 2001 (JP) 2001-350609
Aug. 12, 2002 (JP) 2002-234727
Aug. 12, 2002 (JP) 2002-234728

(51) Int. Cl. H04N 5/76

(52) U.S. Cl. 386/69; 386/111

(57) ABSTRACT

This invention relates to an information recording apparatus, which records image data that requires high-speed access upon reading data of image data to be recorded on a recording medium, on a region that allows high-speed access, and can shorten the access time to the recorded data, and its control method. Image data, which is compression-encoded by JPEG2000, is input from input means. First recording means records image data of a predetermined resolution, obtained by reducing the resolution of the input image data, on a first recording region that allows high-speed access of a recording medium.

### FIELD OF THE INVENTION

The present invention relates to an information recording apparatus for divisionally recording image data, which is compression-encoded by JPEG2000 specified by JPEG (Joint Photographic Experts Group), on a recording medium, and its control method.

The present invention also relates to an information recording apparatus and method for recording encoded data of an image, which is encoded by an encoding scheme that has scalability in an image quality direction, on a disk-shaped recording medium having inner and outer peripheral regions.

### BACKGROUND OF THE INVENTION

Some of recording media that record image data and other digital data have a region where recorded data can be accessed at high speed, and a region where recorded data cannot be accessed at high speed. For example, on an optical disk, data recorded on an inner peripheral recording region can be accessed at higher speed than those recorded on an outer peripheral recording region.

When a plurality of data recorded on a recording medium such as a magnetic disk are to be read out together, since the seek time required to move a head for reading data to a target track becomes shorter with decreasing distance between the tracks of these data and the head, data to be read out from these tracks can be accessed at higher speed.

Furthermore, as another method of accessing a plurality of data recorded on a disk at high speed, a method of shortening the seek time by reading designated data to be read out in the order they are recorded on the disk is available.

Bitstreams of image data compression-encoded by JPEG2000 and moving image data compression-encoded by Motion JPEG2000 will be explained below. Such bitstreams will be referred to as “JPEG2000 bitstreams” hereinafter.

In a JPEG2000 bitstream, data can be recorded in the order based on their resolutions, S/N ratios, and the like. The JPEG2000 bitstream can implement a function corresponding to thumbnail display that reduces the resolution of original image data using only data from the head to the middle of the bitstream. Therefore, by reading and playing back a given size of data from the head of each frame data which forms moving image data, a low-resolution, thumbnail moving image can be played back.

Note that the compression encoding method that records image data in ascending order of resolution, as described above, is called an encoding method of Resolution level•Layer•Component•Position Progression (RLCP) mode.

In the JPEG2000 bitstream, information on the MSB (most significant bit) side can be stored at the head of encoded data by encoding image data consisting of a plurality of bitplanes in turn from the MSB side using SNR scalability.

Also, the JPEG2000 bitstream has a concept named ROI (Region Of Interest). The ROI forms an image which consists of only an important region of an original image, and the information of this region is recorded on the MSB side by shifting it up.

On the other hand, in a decoding process, upon displaying an image on a display device connected to a computer system that decodes encoded data, displayable bitplanes are displayed in turn from the MSB side. Note that the aforementioned compression-encoding method is called an encoding method of Layer•Resolution level•Component•Position Progression (LRCP) mode. In this manner, by allocating required data at the head of the bitstream by utilizing the features of a JPEG2000 file, a required part can be quickly read and displayed.

In the JPEG2000 bitstream, an original image can be decoded within a given range using only data from the head to the middle of the bitstream although it is not exhaustive. Therefore, by compression-encoding an image consisting of a plurality of bitplanes in turn from the MSB by JPEG2000 using SNR scalability, image data which are arranged in the order from the upper-bit information to lower-bit information to have information on the MSB side as the head can be generated.

Image data compression-encoded by JPEG2000 to be explained in this specification is a file obtained by recording the aforementioned JPEG2000 bitstream in a file format specified by ISO/IEC-15444. Also, moving image data compression-encoded by Motion JPEG2000 is a file obtained by recording image data expressed by JPEG2000 bitstreams as frames in the playback order.

Upon compression-encoding data using JPEG2000, important data are allocated at the head of the bitstream by exploiting the features of the JPEG2000 bitstream, and only important data can be quickly read, decoded, displayed on a screen, and so forth by reading such important data.

In case of image data compression-encoded by JPEG2000, an image can be decoded within a given range using only data from the head to the middle of the image data. With JPEG2000, data can be encoded data in the recording order based on resolutions, SNR scalability, color components, and the like. Therefore, upon encoding an image consisting of a plurality of color components, since encoded data of an important color component can be stored in turn from the head, the data of the important color component can be decoded earlier. Note that the aforementioned image compression-encoding method is called an encoding method of Component•Position•Resolution level•Layer progression (CPRL) mode.

Encoded data of a JPEG2000 file is formed using data called a packet as a logical minimum unit.

Upon examining decoding of encoded data which has such packet as a basic unit, a decoder reads a packet header from the head of a packet to decode all pieces of management information of code blocks in the header. Then, after the number of bytes of encoded data of each code block is calculated on the basis of the decoded management information of the code blocks, the head position of the next packet must be calculated.

A JPEG2000 file and Motion JPEG2000 file have an internal structure called a Box structure. The Box structure has a data format in which a 4-byte data length and 4-byte identifier are followed by data having a length equal to the data length. In such format, image data, meta data described in XML (Extensible Markup Language), and the like are respectively stored in boxes.

For example, XML data stored in a JPEG2000 file or Motion JPEG2000 file is stored in a box with an identifier of 4 bytes ‘x’ (0x78), ‘m’ (0x6D), ‘1’ (0x6C), and “(0x20). Therefore, when the data length of XML data is 100 bytes, 8-byte data “0x0000 0064 786D 6C20” is allocated at the head of a box, and 100-byte XML data is allocated to follow this data.

As a conventional method characterized in that only required data is recorded in a specific region of a recording medium, and is accessed at high speed, various methods have been proposed. For example, as inventions associated with the present invention, those described in Japanese Patent Laid-Open Nos. 03-053381, 07-123346, 08-077325, and the like are known.

The invention proposed by Japanese Patent Laid-Open No. 03-053381 “Image Information High-speed Search Method” is directed to an image information high-speed search method for searching digital image information stored in a disk at high speed, and is characterized in that image information is hierarchized into a plurality of stages, image information for one of the hierarchical stages is stored in a region that allows high-speed random access of the disk, and other stages are stored in regions other than that region.

Using the invention of Japanese Patent Laid-Open No. 03-053381, a high-speed search process can be done using only the image information for one stage, which is stored in the region that allows high-speed random access, in response to search requests that are generated at a high frequency, and a search & display process can be done using image information of other stages as such search requests stop or the frequency of generation of the search requests lowers. Therefore, that invention has the same object as that of the present invention in that data with high necessity are recorded together in the region that allows high-speed random access to increase the data read speed.

The invention proposed by Japanese Patent Laid-Open No. 07-123346 “Image Recording/Reproduction Method and Apparatus” is characterized in that a first recording medium which has a high access speed but a small capacity and a second recording medium which has a low access speed but a large capacity are used in combination, and a part with high frequency of use of data recorded on the second recording medium is recorded on the first recording medium.

Using the invention of Japanese Patent Laid-Open No. 07-123346, only a part with high frequency of use of image data can be recorded on a recording medium that allows high-speed access, and required data can be accessed at high speed. Therefore, that invention has the same object as that of the present invention in that data with high frequency of use are recorded together in the region that allows high-speed access to access required data at high speed.

Furthermore, the invention proposed by Japanese Patent Laid-Open No. 08-077325 “Still Image Data Recording Apparatus” is characterized in that still image data of a plurality of resolutions are encoded as fixed-length data, and are independently recorded on regions prepared for respective resolutions.

Using the invention of Japanese Patent Laid-Open No. 08-077325, the read speed upon reading data of a required solution together can be improved, and the search speed of a free recording region can also be improved. Therefore, that invention has the same object as the present invention in that the use efficiency of recording regions is improved by encoding required data as fixed-length data, and the access speed upon accessing required data together is improved by allocating the required data together.

However, upon executing the aforementioned read process of data for a large volume of data, a process for reading required data while sequentially seeking a head that reads data with respect to tracks as recording regions of target data is required. For this reason, the time required to read data is prolonged.

Especially, in consideration of applications to the medical field, when high-resolution images are to be browsed to obtain detailed information of an affected part, the time required for decoding and the like may be prolonged, and may disturb a quick process and the like.

Even when the read order of data is optimized, if recording regions on a disk are separated from each other, the access time becomes longer than a case wherein such recording regions are close to each other.

Furthermore, when a high-quality image is displayed using full image data recorded on a recording medium, the read time of the full image data required to display a high-quality image is prolonged unless a part with a large data size other than thumbnail data is recorded on a region that allows high-speed access.

Furthermore, when all data of a given file recorded on a disk are read out to display an image, the data read time is prolonged unless a part with a large data size other than the packet header is recorded on a region that allows high-speed access on a recording medium.

Moreover, since the packet header must be read for respective bits, the access time is prolonged when the packet header recorded on the disk is directly read out for respective bits. In addition, when a file must be scanned a plurality of times, the access time is further prolonged.

Also, when a high-quality image is displayed using full image data recorded on a recording medium, the read time of the full image data required to display a high-quality image is prolonged unless another region part with a large data size other than the ROI is recorded on a region that allows high-speed access.

Further, the conventional high-speed methods implemented by divisionally recording data respectively suffer the following problems.

When the high-speed method proposed by Japanese Patent Laid-Open No. 03-053381 “Image Information High-speed Search Method” is used, data recorded on the region that allows high-speed random access may have a variable length, and the number of image data that can be recorded on the region that allows high-speed random access cannot be estimated.

When addition of new image data and deletion are made frequently, the region that allows high-speed random access suffers fragmentation, and the use efficiency of the region that allows high-speed random access may drop.

When data is always encoded as fixed-length data, the compression efficiency and image quality of image data to be recorded are limited depending on a setting value of the encoded data length. Also, data which is to be recorded on the region that allows high-speed random access must be self-sufficient.

When the high-speed method proposed by Japanese Patent Laid-Open No. 07-123346 “Image Recording/Reproduction Method and Apparatus” is used, since data are repetitively recorded on the first and second recording media, the use efficiency of the recording media drops considerably.

Furthermore, when the high-speed method proposed by Japanese Patent Laid-Open No. 08-077325 “Still Image Data Recording Apparatus” is used, since data of a predetermined resolution must be encoded as fixed-length data, image data encoded using a variable-length compression encoding method cannot be handled.

Moreover, in case of an information recording apparatus that considers applications to the medical field, the number of bits which form each color component of image data to be encoded is 12 or 16 bits, and may exceed 8 bits. When such image data is displayed on an image display device that can display bitplanes defined by 8 bits, which are used in a normal computer system, after 12- or 16-bit image data is decoded, the bit reduction processing step of obtaining 8-bit data must be executed.

### SUMMARY OF THE INVENTION

The present invention has been proposed to solve the conventional problems, and has as its object to provide an information recording apparatus which records image data, that requires high-speed access upon reading data, of image data to be recorded on a recording medium, on a region that allows high-speed access of the recording medium, and can shorten the access time to the recorded data, and its control method.

In order to achieve the above object, according to the present invention, there is provided an information recording apparatus for recording image data, which is compression-encoded by JPEG2000, on a recording medium having two recording regions with different access speeds, comprising input means for inputting image data, which is compression-encoded by JPEG2000, first recording means for recording image data of a predetermined resolution, which is obtained by reducing a resolution of the input image data, on a first recording region that allows high-speed access, and second recording means for recording image data, other than the image data of the predetermined resolution recorded on the first recording region, of the input image data on a second recording region.

In order to achieve the above object, according to the present invention, there is provided an information recording apparatus for recording image data, which is compression-encoded by JPEG2000, on a recording medium having two recording regions with different access speeds, comprising input means for inputting image data, which is compression-encoded by JPEG2000, and in which image data of a predetermined image region is allocated on a most significant bit side, designation means for designating the image data of the predetermined image region, which is allocated on the most significant bit side in the input image data, first recording means for recording the designated image data on the most significant bit side on a first recording region that allows high-speed access, and second recording means for recording image data, other than the image data recorded on the first recording region, of the input image data on a second recording region.

In order to achieve the above object, according to the present invention, there is provided an information recording apparatus for recording a still image, which is compression-encoded by JPEG2000, on a recording medium, a recording region of which is divided into a first recording region for recording a predetermined image component of the still image, and a second recording region for recording remaining image components of the still image, comprising: input means for inputting a still image, which is compression-encoded by JPEG2000, and is formed of a plurality of bitplanes; first recording means for recording an image component formed by a predetermined number of bitplanes of the input still image on the first recording region; and second recording means for recording image components, other than the image component recorded on the first recording region, on the second recording region.

In order to achieve the above object, according to the present invention, there is provided an information recording apparatus for recording a color image, which is compression-encoded by JPEG2000, on a recording medium having two recording regions with different access speeds, comprising: input means for inputting a color image compression-encoded by JPEG2000; first recording means for recording data associated with a predetermined component of the input color image on a first recording region that allows high-speed access; and second recording means for recording data, other than the data associated with the predetermined component of the color image recorded on the first recording region, on a second recording region.

It is another object of the present invention to provide an image recording apparatus, which records an image data main body, other than header information, of image data to be recorded on a recording medium on a region that allows high-speed access of a recording medium, and records the header information on another region so as to shorten the access time to all recorded image data, and its control method.

In order to achieve the above object, according to the present invention, there is provided an information recording apparatus for recording image data, which is compression-encoded by JPEG2000, on a recording medium having two recording regions with different access speeds, comprising: input means for inputting image data, which is compression-encoded by JPEG2000, and consists of a plurality of packets; first recording means for recording header information of each packet of the input image data on a first recording region; and second recording means for recording image data, other than the header information recorded on the first recording region, on a second recording region that allows high-speed access.

It is still another object of the present invention to provide an information recording apparatus and method for recording at least an image with a lowest image quality on a region that allows higher-speed access of a recording medium.

In order to achieve the above object, according to the present invention, there is provided an information recording apparatus for recording encoded data of an image, which is encoded by an encoding method having scalability in an image quality direction, on a disk-like storage medium having inner and outer peripheral regions, comprising: recording means for recording data required to form an image with predetermined image quality of the encoded data of the image on the inner peripheral region of the storage medium.

It is yet another object of the present invention to provide an information recording apparatus and method for recording data other than data, which has a larger size than at least image data with a lowest image quality, on a region that allows higher-speed access of a recording medium.

In order to achieve the above object, according to the present invention, there is provided an information recording apparatus for recording encoded data of an image, which is encoded by an encoding method having scalability in an image quality direction, on a disk-like storage medium having inner and outer peripheral regions, comprising: recording means for recording first data required to form an image with predetermined image quality of the encoded data of the image on the outer peripheral region of the storage medium.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram for explaining the arrangement of an information recording apparatus 1 according to the first embodiment of the present invention;

FIG. 2 is a schematic diagram for explaining the electrical arrangement that implements the operation of the information recording apparatus 1 (FIG. 1) which records a JPEG2000 bitstream on a recording medium 2;

FIG. 3 is a schematic view for explaining the detailed format of image data, which is compression-encoded by JPEG2000 according to Resolution level•Layer•Component•Position Progression (RLCP) mode;

FIG. 4 is a schematic view for explaining the relationship between the resolutions (image sizes) and resolution numbers;

FIG. 5 shows an example of the recording medium 2 used in the first embodiment;

FIG. 6 is a flow chart for explaining the processing sequence upon recording an input JPEG2000 bitstream on an optical disk using the information recording apparatus 1 according to the first embodiment;

FIG. 7 is a flow chart for explaining the processing sequence for reading out only a bitstream written in a special region, and displaying a thumbnail of an original image;

FIG. 8 is a flow chart for explaining the processing sequence for reading out all image data, which are divisionally recorded on two recording regions of the recording medium 2, and decoding the readout image data to obtain an original image;

FIG. 9 is a block diagram for explaining the arrangement of an-information recording apparatus, and the flows of various data according to the second embodiment;

FIG. 10 is a flow chart for explaining the processing sequence in an output processor 904 according to the second embodiment;

FIG. 11 is a flow chart for explaining the processing sequence upon recording an input JPEG2000 bitstream on an optical disk using an information recording apparatus 1 according to the third embodiment;

FIG. 12 is a flow chart for explaining the processing sequence in an output processor 904 according to the fourth embodiment;

FIG. 13 is a view for briefly explaining a Motion JPEG2000 file;

FIG. 14 is a block diagram for explaining the arrangement of an information recording apparatus 100 according to the fifth embodiment of the present invention;

FIG. 15 is a flow chart for explaining the processing sequence upon recording an input JPEG2000 bitstream on an optical disk using the information recording apparatus 100 according to the fifth embodiment;

FIG. 16 is a view for explaining an example of the recording positions of a Motion JPEG2000 file on a device in the 13th embodiment;

FIG. 17 is a view for explaining an example of the recording positions of a Motion JPEG2000 file on a device in the fifth embodiment;

FIG. 18 is a block diagram for explaining the arrangement of an information recording apparatus, and the flows of various data according to the sixth embodiment;

FIG. 19 is a block diagram for explaining the arrangement of an information recording apparatus, and the flows of various data according to the 14th embodiment;

FIG. 20 is a flow chart for explaining the processing sequence upon recording an input JPEG2000 bitstream on an optical disk using an information recording apparatus 100 according to the seventh embodiment;

FIG. 21 is a flow chart for explaining the detailed processing sequence of a general region recording process in step S2003 shown in FIG. 20;

FIG. 22 is a view for explaining an example of the recording positions of a Motion JPEG2000 file on a device in the seventh embodiment;

FIG. 23 is a view for explaining an example of the recording positions of a Motion JPEG2000 file on a device in the 15th embodiment;

FIG. 24 is a block diagram for explaining the arrangement of an information recording apparatus 900 according to the ninth embodiment of the present invention;

FIG. 25 is a schematic view for explaining the detailed format of image data, which is compression-encoded by JPEG2000 according to Layer•Resolution level•Component•Position Progression (LRCP) mode;

FIG. 26 is a flow chart for explaining the processing sequence upon recording an input JPEG2000 bitstream on an optical disk using the information recording apparatus 900 according to the ninth embodiment;

FIG. 27 is a block diagram for explaining the arrangement of an information recording apparatus, and the flows of various data according to the 10th embodiment;

FIG. 28 is a flow chart for explaining the processing sequence upon recording an input JPEG2000 bitstream on an optical disk using an information recording apparatus 900 according to the 11th embodiment;

FIG. 29 is a block diagram for explaining the arrangement of an information recording apparatus 100 according to the 13th embodiment of the present invention;

FIG. 30 is a block diagram for explaining the arrangement of an information recording apparatus according to the 17th embodiment of the present invention;

FIG. 31 is a block diagram for explaining the arrangement of an information recording apparatus, and the flows of data according to the 18th embodiment;

FIG. 32 is a schematic view for explaining the detailed format of image data, which is compression-encoded by JPEG2000 according to Component•Position•Resolution level•Layer progression mode;

FIG. 33 is a flow chart for explaining the write sequence on a disk when a YCbCr space is used;

FIG. 34 is a block diagram for explaining the arrangement of an information recording apparatus, and the flows of data according to the 22nd embodiment;

FIG. 35 is a block diagram for explaining the arrangement of an information recording apparatus according to the 25th embodiment of the present invention;

FIG. 36 is a schematic view for explaining the detailed format of image data, which is compression-encoded by JPEG2000 according to Layer•Resolution level•Component•Position Progression (LRCP) mode;

FIG. 37 is a flow chart for explaining the processing sequence upon recording an input JPEG2000 bitstream on an optical disk using an information recording apparatus 4 according to the 25th embodiment;

FIG. 38 is a schematic view for explaining the detailed format of encoded data after the encoded data shown in FIG. 36 is converted;

FIG. 39 is a flow chart for explaining the processing sequence for reading out data written on a recording medium in the sequence shown in FIG. 37;

FIG. 40 is a schematic view for explaining the data allocation of a JPEG2000 file on a recording medium;

FIG. 41 is a flow chart for explaining the processing sequence when the data length of data to be recorded on a general region 22 shown in FIG. 22 is a fixed length;

FIG. 42 is a flow chart for explaining the processing sequence when the recording sequence on a recording medium in the processing sequence of the flow chart in FIG. 41 has been changed;

FIG. 43 is a schematic view for explaining the detailed format of image data, which is compression-encoded by JPEG2000 according to Resolution level•Layer•Component•Position Progression (RLCP) mode;

FIG. 44 is a schematic view showing an example of the file format used to store a JPEG2000 bitstream in a file;

FIG. 45 shows the data contents stored in an XML box;

FIG. 46 shows the contents stored in a Continuous Codestream box;

FIG. 47 is a flow chart for explaining the processing sequence of file segmentation upon executing a process for changing the order of boxes in an input JPEG2000 file;

FIG. 48 is a block diagram showing the basic arrangement of an information recording apparatus according to the 31st embodiment of the present invention;

FIG. 49 is a flow chart showing the process for writing JPEG2000 data stored in a secondary storage unit 103 on a storage medium 107 by a data input/output unit 106;

FIG. 50 is a flow chart showing the process for reading out only data recorded on a special region, i.e., only image data with lowest image quality;

FIG. 51 is a schematic diagram showing the functional arrangement of an information recording apparatus according to the 32nd embodiment of the present invention, and an original image to be input to that apparatus;

FIG. 52 is a schematic diagram showing the functional arrangement of an information recording apparatus for encoding an input image by Progressive JPEG according to set parameters, and divisionally recording the generated encoded data on a storage medium, and an image to be input;

FIG. 53 is a flow chart showing the process for writing JPEG2000 data stored in a secondary storage unit 103 on a storage medium 107 by a data input/output unit 106 in the 34th embodiment; and

FIG. 54 is a flow chart showing the process for reading out data recorded on a special region, i.e., only image data with a lowest image quality.

### DETAILED DESCRIPTION OF THE PREFERRED EMBODIMENTS

Preferred embodiments of the present invention will now be described in detail in accordance with the accompanying drawings.

<First Embodiment>

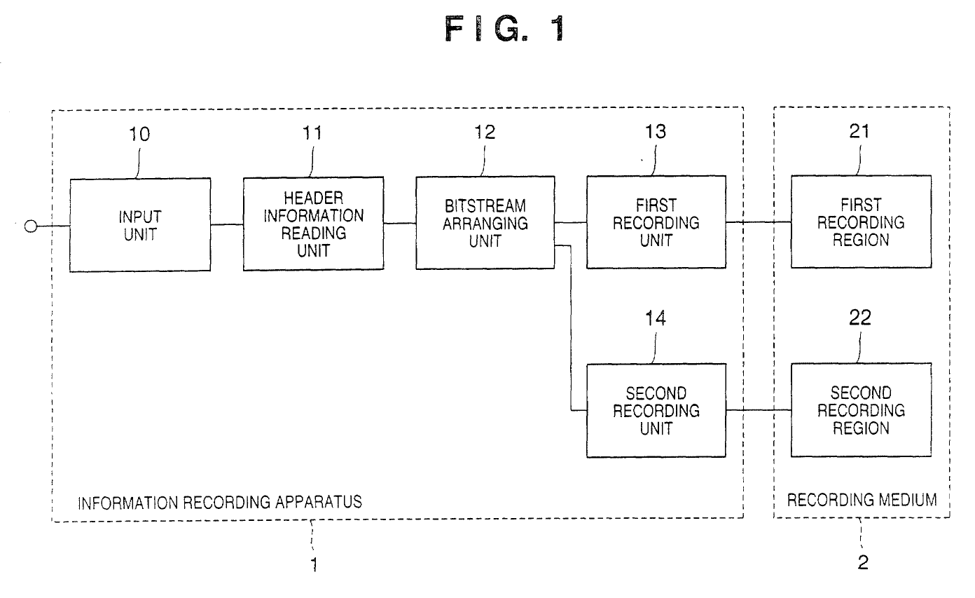

FIG. 1 is a block diagram for explaining the arrangement of an information recording apparatus 1 according to the first embodiment of the present invention. The information recording apparatus 1 of this embodiment records image data, which is compression-encoded by JPEG2000 complying with ISO/IEC-15444, on a recording region of a detachable recording medium 2. Note that a bitstream of image data, which is compression-encoded by JPEG2000, will be referred to as a JPEG2000 bitstream hereinafter.

The recording region of the recording medium 2 is divided into a first recording region 21 for recording thumbnails of image data, and a second recording region 22 for recording image data other than the thumbnails recorded on the first recording region 21, as shown in FIG. 1. Assume that access speeds to these two recording regions of the recording medium 2 are different in this embodiment, and the access speed to the first recording region 21 for recording thumbnails of image data is higher than that to the second recording region 22.

The information recording apparatus 1 comprises an input unit 10 for inputting a JPEG2000 bitstream, a header information reading unit 11 for reading header information from the input JPEG2000 bitstream, a bitstream arranging unit 12 for rearranging the bitstream of image data to a predetermined bitstream on the basis of the read header information, a first recording unit 13 for recording a thumbnail part of the JPEG2000 bitstream on the first recording region 21 of the recording medium 2, and a second recording unit 14 for recording the JPEG2000 bitstream, other than image data recorded on the first recording region 21, on the second recording region 22.

That is, the present invention is directed to an information recording apparatus 1 for recording image data, which is compression-encoded by JPEG2000, on a recording medium 2 having different access speeds depending on recording positions, characterized by comprising an input unit 10 for inputting image data compression-encoded by JPEG2000, and a recording unit 13 for recording component data indicating a reduced-scale image in the input image data on a recording region that allows high-speed access (first recording region 21) in preference to the remaining component data.

Also, the present invention is characterized in that the reduced-scale image in the input image data is a thumbnail of the image data. Furthermore, the present invention is characterized by further comprising a header information reading unit 11 for reading header information of the input image data, and a bitstream arranging unit 12 for rearranging the bitstream of the input image data to a predetermined bitstream on the basis of the read header information.

By reading the input header information, information such as a size or the like of the thumbnail is detected. Therefore, a designation unit for designating the range of thumbnail component data in the image data and separating it from other component data may be added to the aforementioned arrangement. That is, the present invention is characterized by further comprising a designation unit for designating component data indicating the reduced-scale image from the input image data.

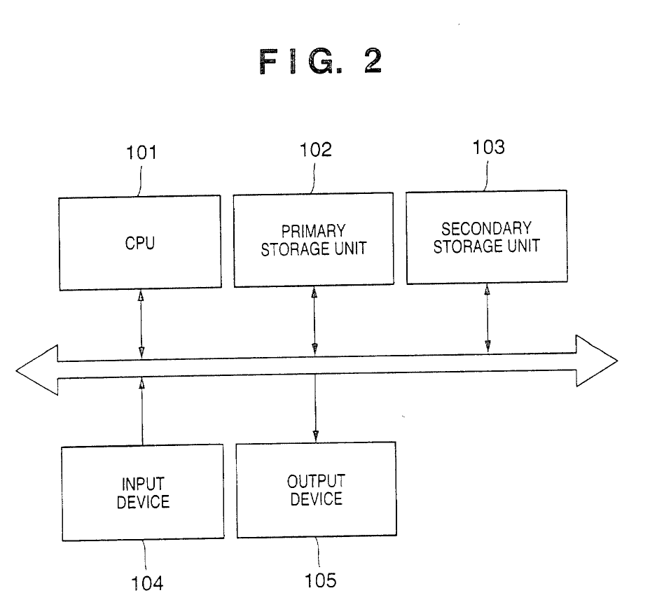

FIG. 2 is a schematic diagram for explaining the electrical arrangement that implements the operation of the information recording apparatus 1 (FIG. 1) which records a JPEG2000 bitstream on the recording medium 2. Referring to FIG. 2, a CPU 101 is an arithmetic device for controlling the operation of the overall information recording apparatus 1. A secondary storage unit 103 is a hard disk that stores a computer program and the like. A primary storage unit 102 is a memory used to load and store the computer program stored in the secondary storage unit 103 when that program is executed by the CPU 101. In general, the capacity of the primary storage unit 102 is smaller than that of the secondary storage unit 103, and a computer program, data, and the like that cannot be stored in the primary storage unit 102 are stored in the secondary storage unit 103. Also, data and the like, which must be stored for a long period of time, are stored in the secondary storage unit 103.

An input device 104 comprises a mouse, keyboard, and the like, and is used to send an interrupt signal upon execution of the computer program. An output device 105 comprises a monitor, printer, and the like. Using the electrical arrangement shown in FIG. 2, the processes in the header information reading unit 11, bitstream arranging unit 12, first recording unit 13, and second recording unit 14 of the information recording apparatus 1 shown in FIG. 1 are implemented. Furthermore, when the input unit 10 shown in FIG. 1 is connected to the electrical arrangement in FIG. 2, a JPEG2000 bitstream can be input.

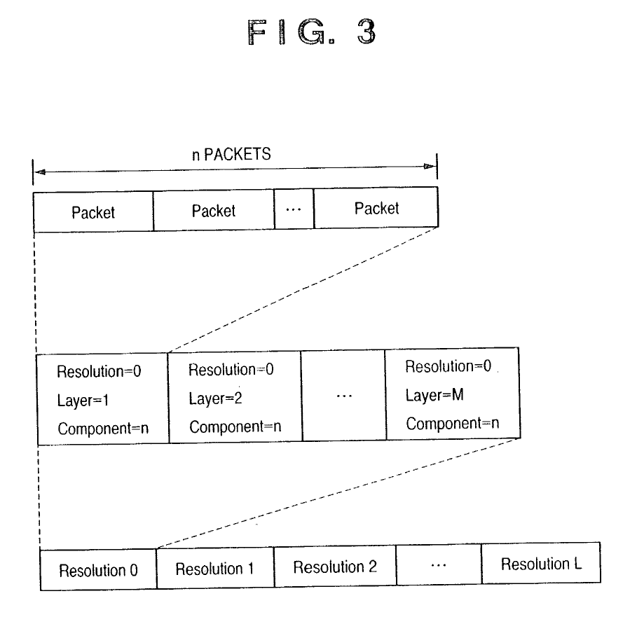

Encoded data, which is compression-encoded by general JPEG2000, will be explained below. FIG. 3 is a schematic view for explaining the detailed format of image data, which is compression-encoded by JPEG2000 according to Resolution level•Layer•Component•Position Progression (to be abbreviated as “RLCP” hereinafter) mode. In this embodiment, since image data is encoded in RLCP mode, data of a bitstream are recorded in the order of Resolution, Layer, Component, and Position. That is, the present invention is characterized in that a bitstream of image data is arranged in the order of Resolution level, Layer, Component, and Position.

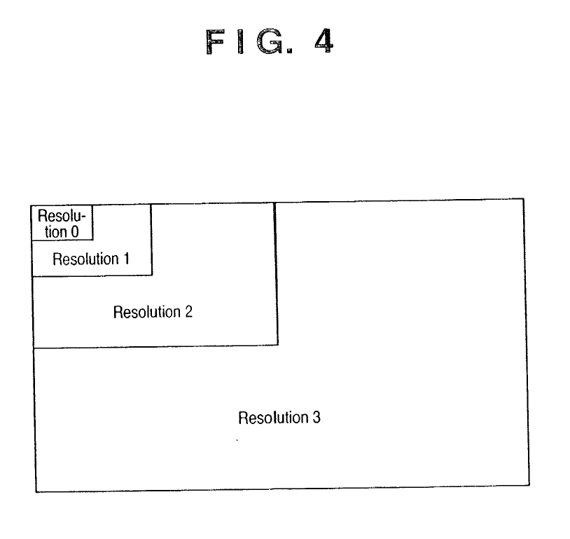

FIG. 4 is a schematic view for explaining the relationship between the resolutions (image sizes) and resolution numbers. As shown in FIG. 4, an image with the lowest resolution has resolution number 0, and the width and height of an image are doubled every time the resolution number is incremented by 1. For example, an image of resolution number 3 (Resolution 3) in FIG. 4 has a width and height twice those of an image of resolution number 2 (Resolution 2).

In each resolution, data are arranged in ascending order of layer number, as shown in FIG. 3. The layer number corresponds to the S/N ratio of an image to be decoded to an original image, and the S/N ratio lowers with decreasing layer number.

Assume that the maximum values of the resolution number, layer number, and component number in image data encoded by JPEG2000 (JPEG2000 bitstream) are set in advance by an encoder in this embodiment. These parameters are encoded as header information, and an original image is encoded according to those parameters, thus generating a JPEG2000 bitstream of the image.

Note that the component number matches the number of dimensions of the color space of an image. For example, when the color space of an objective image is a three-dimensional RGB color space, the component number=3. An image with a specific resolution and specific S/N ratio is formed by packets as many as the number of components. For example, in case of an RGB image, the image is formed by packets for respectively storing R, G, and B components.

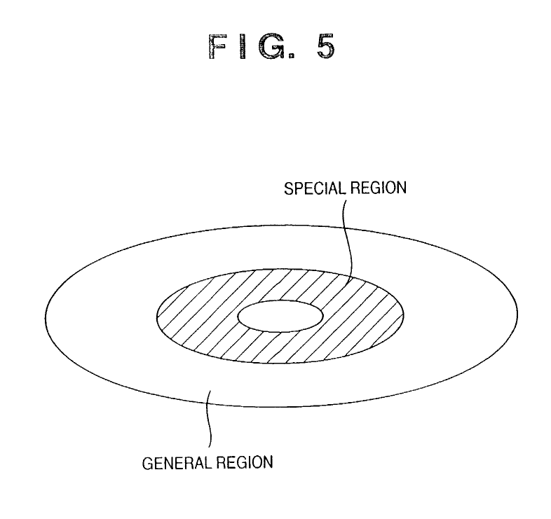

FIG. 5 shows an example of the recording medium 2 used in the first embodiment. Assume that the recording medium 2 used in this embodiment is an optical disk. In general, the optical disk can access data recorded on an inner peripheral recording region faster than data recorded on an outer peripheral recording region. In the first embodiment, the inner peripheral recording region of the optical disk is defined as a special region for recording thumbnails of image data. The access time to the outer peripheral recording region becomes longer than that to the inner peripheral recording region. In this embodiment, this outer peripheral recording region is defined as a general region for recording image data other than thumbnails recorded on the special region. That is, the present invention is characterized in that the recording medium 2 is an optical disk, and a recording region that allows high-speed access (first recording region 21) is assured on the inner peripheral portion (special region) of the optical disk.

Also, this embodiment adopts Universal Disk Format (UDF) as the file system of the optical disk. In the UDF, one file can be segmented and written at a plurality of positions. The file to be segmented and recorded is recorded using UDF entries as many as the number of segments. More specifically, the present invention is characterized in that the file system which manages image data recorded on the recording medium 2 is Universal Disk Format.

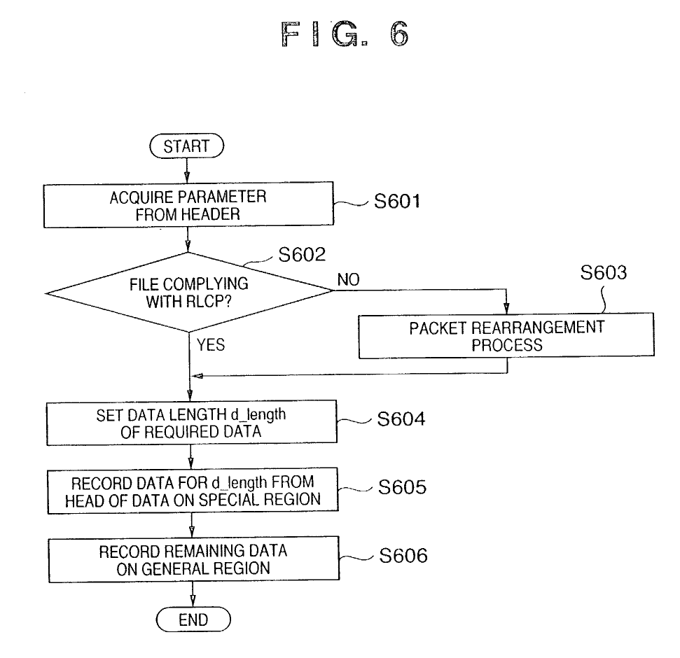

FIG. 6 is a flow chart for explaining the processing sequence upon recording an input JPEG2000 bitstream on the optical disk using the information recording apparatus 1 according to the first embodiment.

The header information reading unit 11 reads header information in a JPEG2000 bitstream as a file input from the input unit 10 so as to acquire parameters such as a maximum layer number, maximum resolution number, component number, resolution number corresponding to a predetermined image size, stream recording method, and the like in the file (step S601). It is then checked based on the information acquired in step S601 if the stream recording method used to encode the file is the aforementioned RLCP mode (step S602).

As a result, if the input image data is encoded by RLCP mode (Yes), the flow advances to step S604. On the other hand, if the input image data is not encoded according to RLCP mode (No), the flow advances to step S603.

In step S603, the bitstream arranging unit 12 rearranges the storage order of data in packets in the JPEG2000 bitstream to the order of data encoded by RLCP mode, and corrects the stream recording method in the header information to RLCP mode. Upon completion of this process, the flow advances to step S604.

In step S604, the data length d_length of data to be recorded on the first recording region 21 that allows high-speed access (the inner peripheral special region on the optical disk shown in FIG. 5) on the recording medium 2 is checked. In this embodiment, this data length d_length is a fixed data length corresponding to thumbnail data having a predetermined size. The first recording unit 13 records a part with the length d_length from the-head of the bitstream of that file on the first recording region 21 (special region) using the UDF function (step S605). Subsequently, the second recording unit 14 records data after the length d_length from the head of the bitstream of that file on the second recording region 22 (general region) (step S606).

That is, the present invention is characterized in that recording means (first recording unit 13) records a bitstream having a predetermined length from the head of a bitstream of input image data on a recording region (first recording region 21).

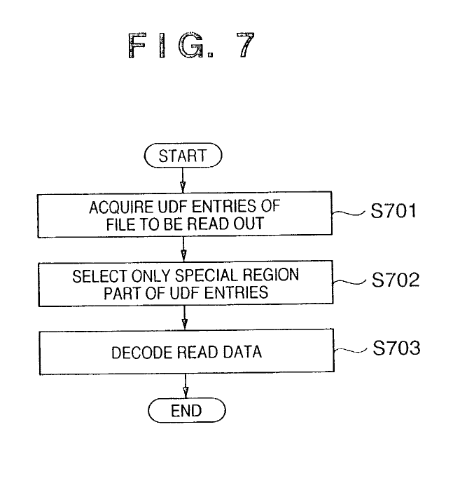

A method of accessing predetermined data of image data written on the optical disk according to the sequence shown in FIG. 6 at high speed will be explained below. FIG. 7 is a flow chart for explaining the processing sequence for reading out only a bitstream written on the special region, and displaying a thumbnail of an original image.

UDF entries of a file to be read out are acquired (step S701). Only an entry indicating a part of the special region is selected from the UDF entries selected in step S701 (step S702). Then, data of the selected part is read and decoded (step S703).

In this embodiment, data recorded on the special region corresponds to a thumbnail of original image data. Thumbnails are recorded together on the special region by applying the process shown in FIG. 6, and only data recorded on the special region are read out by applying the process in the sequence shown in the flow chart of FIG. 7. In this manner, upon displaying a large number of image files, thumbnail image data can be quickly decoded and displayed. Also, no seek upon accessing the disk occurs, or the seek time can be short if it has occurred.

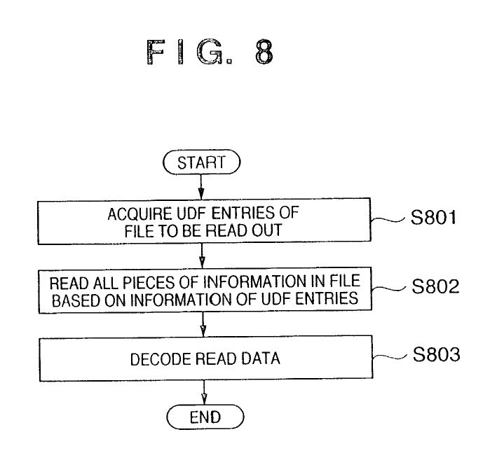

FIG. 8 is a flow chart for explaining the processing sequence for reading out all image data, which are divisionally recorded on the two recording regions of the recording medium 2, and decoding the readout image data to obtain an original image.

UDF entries of image data to be read out are acquired (step S801). All image data are read out from the respective recording regions in accordance with the information of the UDF entries (step S802). Furthermore, the readout data are decoded (step S803). In this manner, all image data recorded on the recording medium 2 can be read out and can be displayed on a screen.

In this embodiment, data to be recorded on the special region has a fixed length. Alternatively, header information may be read to acquire the resolution number and layer number of the required resolution and required S/N ratio, and the data length of data to be recorded on the special region may be determined.

<Second Embodiment>

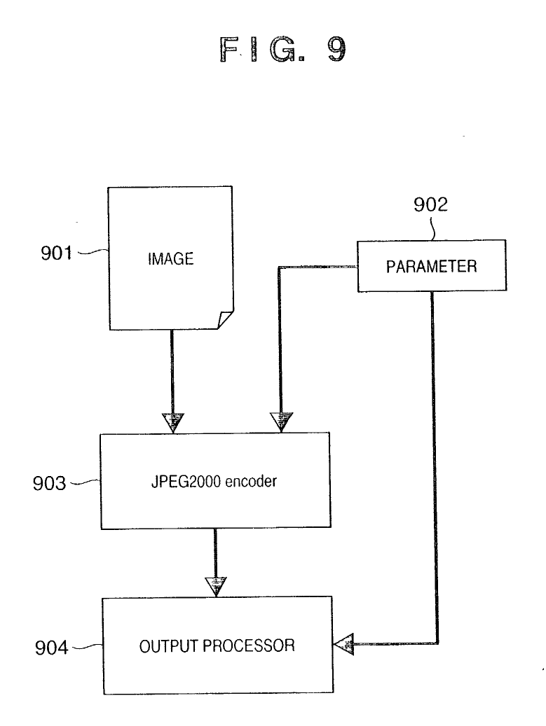

FIG. 9 is a block diagram for explaining the arrangement of an information recording apparatus, and the flows of various data according to the second embodiment. An original image 901 is input to a JPEG2000 encoder 903. The JPEG2000 encoder 903 encodes the input image data. In this case, the image data is encoded on the basis of the contents of control parameters 902. These parameters are recorded in the image data as header information.

The parameters 902 include a maximum value of Resolution as resolution scalability, a maximum value of Layer as S/N ratio scalability, Component indicating the number of dimensions of a color space, and the like upon encoding image data.

The JPEG2000 encoder 903 sequentially outputs a JPEG2000 bitstream complying with RLCP mode to an output processor 904. The output processor 904 divisionally records the bitstream input from the JPEG2000 encoder 903 on special and general regions with different access speeds on a recording medium having the same format as in the first embodiment, using the parameters 902.

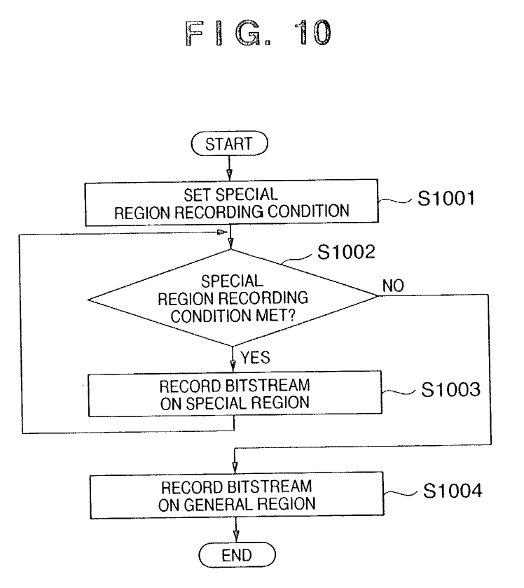

FIG. 10 is a flow chart for explaining the processing sequence in the output processor 904 according to the second embodiment. Using header information of image data, which is compression-encoded by JPEG2000, recording conditions of data to be recorded on the inner peripheral special region of an optical disk are set (step S1001). For example, data that simultaneously meets the following two recording conditions is recorded on the special region that allows high-speed access:

(1) less than 4 kB from the head of a bitstream; and

(2) encoded data having an image size of not more than 160 pixels (vertical)×120 pixels (horizontal).

It is checked if the above two recording conditions are met (step S1002). As a result, if the two conditions are met (Yes), the bitstream is recorded on the special region (step S1003). On the other hand, if the two conditions are not met (No), the bitstream is recorded on the general region (step S1004).

In the first and second embodiments described above, of image data input to the information recording apparatus, image data required to display a thumbnail is recorded on the inner peripheral special region (first recording region 21) that allows high-speed access of the recording medium (optical disk), and the remaining image data is recorded on the outer peripheral general region (second recording region 22). Therefore, thumbnails can be displayed from image data written on the recording medium quicker than the conventional apparatus.

<Third Embodiment>

An embodiment in which image data required to display a thumbnail is recorded not on an inner peripheral special region that allows high-speed access, but on an outer peripheral general region will be explained below.

This embodiment uses an information recording apparatus 1 with the arrangement shown in the block diagram of FIG. 1 as in the first embodiment described above. The information recording apparatus 1 of this embodiment also records image data, which is compression-encoded by JPEG2000 complying with ISO/IEC-15444, on a recording region of a detachable recording medium 2.

Assume that access speeds to two recording regions of the recording medium 2 used in this embodiment are also different, and the access speed to a first recording region 21 for recording thumbnails of image data is lower than that to a second recording region 22.

That is, the present invention is directed to an information recording apparatus 1 for recording image data, which is compression-encoded by JPEG2000, on a recording medium 2 having different access speeds depending on recording positions, characterized by comprising an input unit 10 for inputting image data compression-encoded by JPEG2000, and recording means (second recording unit 14) for recording component data other than component data indicating a reduced-scale image (thumbnail) in the input image data on a recording region that allows high-speed access (second recording region 22) in preference to the component data indicating the reduced-scale image.

Also, the present invention is characterized in that the recording means (second recording unit 14) records a bitstream other than a bitstream having a predetermined length from the head of that of the input image data on the recording region (second recording region 22).

In this embodiment, the electrical arrangement which implements the operation of the information recording apparatus 1 which records a JPEG2000 bitstream on the recording medium 2 is the same as that shown in FIG. 2.

Furthermore, image data is compression-encoded by JPEG2000 complying with RLCP mode shown in FIG. 3. Therefore, since image data is encoded by RLCP mode, data of a bitstream are recorded in the order of Resolution, Layer, Component, and Position.

Moreover, the recording medium 2 used in this embodiment is an optical disk shown in FIG. 5, and an outer peripheral recording region of the optical disk is defined as a general region for recording thumbnails of image data. An inner peripheral recording region of the optical disk is defined as a special region used to record image data other than the thumbnails recorded on the general region. That is, the present invention is characterized in that the recording medium 2 is an optical disk, and the second recording region 22 is assured on the inner peripheral portion (special region) of the optical disk. In addition, this embodiment adopts Universal Disk Format as the file system of the optical disk.

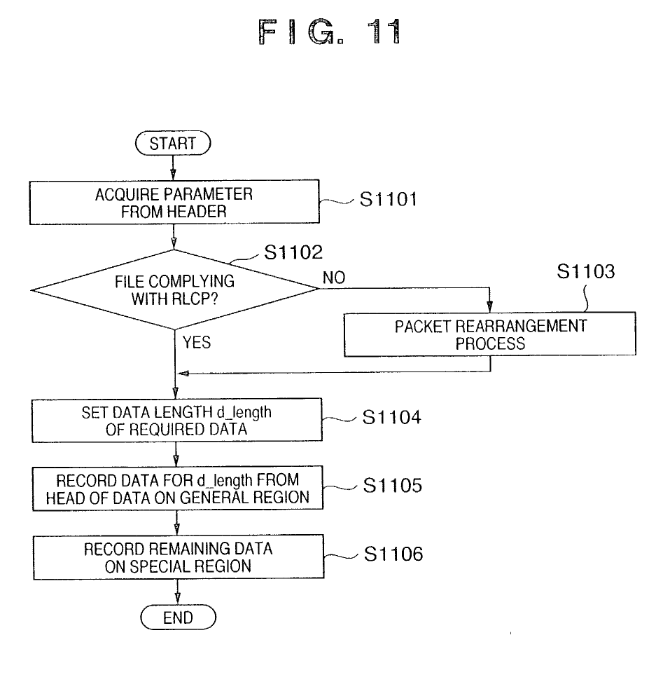

FIG. 11 is a flow chart for explaining the processing sequence upon recording an input JPEG2000 bitstream on the optical disk using the information recording apparatus 1 according to the third embodiment.

The header information reading unit 11 reads header information in a JPEG2000 bitstream as a file input from the input unit 10 so as to acquire parameters such as a maximum layer number, maximum resolution number, component number, resolution number corresponding to a predetermined image size, stream recording method, and the like in the file (step S1101). It is then checked based on the information acquired in step S1101 if the stream recording method used to encode the file is the aforementioned RLCP mode (step S1102).

As a result, if the input image data is encoded by RLCP mode (Yes), the flow advances to step S1104. On the other hand, if the input image data is not encoded according to RLCP mode (No), the flow advances to step S1103.

In step S1103, the bitstream arranging unit 12 rearranges the storage order of data in packets in the JPEG2000 bitstream to the order of data encoded by RLCP mode, and corrects the stream recording method in the header information to RLCP mode. Upon completion of this process, the flow advances to step S1104.

In step S1104, the data length d_length of data to be recorded on the first recording region 21 (the outer peripheral special region on the optical disk shown in FIG. 5) on the recording medium 2 is checked. In this embodiment, this data length d_length is a fixed data length corresponding to thumbnail data having a predetermined size. The first recording unit 13 records a part with the length d_length from the head of the bitstream of that file on the first recording region 21 (general region) using the UDF function (step S1105) Subsequently, the second recording unit 14 records data after the length d_length from the head of the bitstream of that file on the second recording region 22 (special region) that allows high-speed access (step S1106).

A method of accessing predetermined data of image data written on the optical disk according to the sequence shown in FIG. 11 at high speed will be explained below. In the first embodiment described above, only the bitstream written in the special region is read out to display a thumbnail of an original image, as shown in FIG. 7. However, in the third embodiment, thumbnails are recorded on the first recording region 21 (general region) of the recording medium 2. Hence, only an entry indicating a part of the general region is selected from UDF entries of a file to be read out, and data of the selected part is read out, thus decoding the readout data. In this manner, only a thumbnail of an original image can be displayed.

The processing sequence for reading out all image data, which are divisionally recorded on the two recording regions of the recording medium 2, and decoding the readout image data to obtain an original image is the same as that shown in the flow chart in FIG. 8. That is, UDF entries of image data to be read out are acquired (step S801). All image data are read out from the respective recording regions in accordance with the information of the UDF entries (step S802). Furthermore, the readout data are decoded (step S803). In this embodiment, since large-size data are recorded on the special region, all image data recorded on the recording medium 2 can be read out and displayed on a screen quicker than the conventional apparatus.

In this embodiment, data to be recorded on the special region has a fixed length. Alternatively, header information may be read to acquire the resolution number and layer number of the required resolution and required S/N ratio, and the data length of data to be recorded on the general region may be determined.

<Fourth Embodiment>

The block diagram for explaining the arrangement of an information recording apparatus, and the flow of various data according to the fourth embodiment is the same as that shown in FIG. 9. That is, an original image 901 is input to a JPEG2000 encoder 903. The JPEG2000 encoder 903 encodes the input image data. In this case, the image data is encoded on the basis of the contents of control parameters 902. These parameters are recorded in the image data as header information.

The JPEG2000 encoder 903 sequentially outputs a JPEG2000 bitstream complying with RLCP mode to an output processor 904. The output processor 904 divisionally records the bitstream input from the JPEG2000 encoder 903 on special and general regions with different access speeds on a recording medium having the same format as in the first embodiment, using the parameters 902.

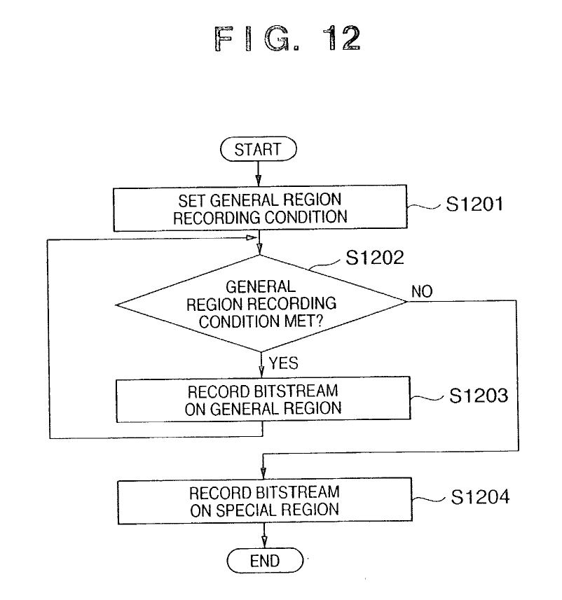

FIG. 12 is a flow chart for explaining the processing sequence in the output processor 904 according to the fourth embodiment. Using header information of image data, which is compression-encoded by JPEG2000, recording conditions of data to be recorded on the outer peripheral general region of an optical disk are set (step S1201). For example, data that simultaneously meets the following two recording conditions is recorded on the general region:

(1) less than 4 kB from the head of a bitstream; and

(2) encoded data having an image size of not more than 160 pixels (vertical)×120 pixels (horizontal).

It is checked if the above two recording conditions are met (step S1202). As a result, if the two conditions are met (Yes), the bitstream is recorded on the general region (step S1203). On the other hand, if the two conditions are not met (No), the bitstream is recorded on the special region (step S1204).

In the third and fourth embodiments described above, of image data input to the information recording apparatus, image data required to display a thumbnail is recorded on the outer peripheral general region (first recording region 21), and the remaining image data is recorded on the inner peripheral special region (second recording region 22) that allows high-speed access. Therefore, all image data written on the recording medium can be decoded quicker than the conventional apparatus.

That is, in the third and fourth embodiments, upon displaying a high-quality image read out from the recording medium 2 that records image data, since data other than thumbnails are recorded on a region that allows high-speed access of the recording medium 2, the read time upon displaying a high-quality image can be shortened.

<Fifth Embodiment>

In subsequent embodiments, a method of recording moving image data, which is compression-encoded by Motion JPEG2000, on a recording medium will be explained.

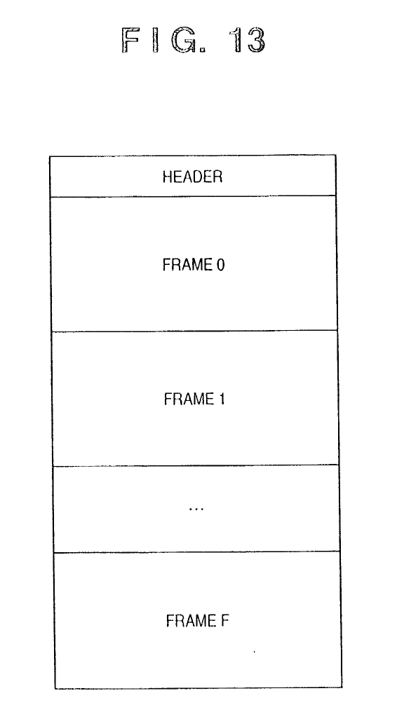

A Motion JPEG2000 file will be briefly explained first. The Motion JPEG2000 file records bitstreams, which are compression-encoded by JPEG2000 for respective frames, in the playback order as a single file. FIG. 13 is a view for briefly explaining the Motion JPEG2000 file. FIG. 13 illustrates a case wherein a moving image is formed by F+1 frames.

In FIG. 13, a header of the file stores information required to manage this file. Each frame is obtained by compression-encoding only image data of that frame by JPEG2000. Note that the data format of each frame of a moving image used in this embodiment is the same as that of image data in the first embodiment described above.

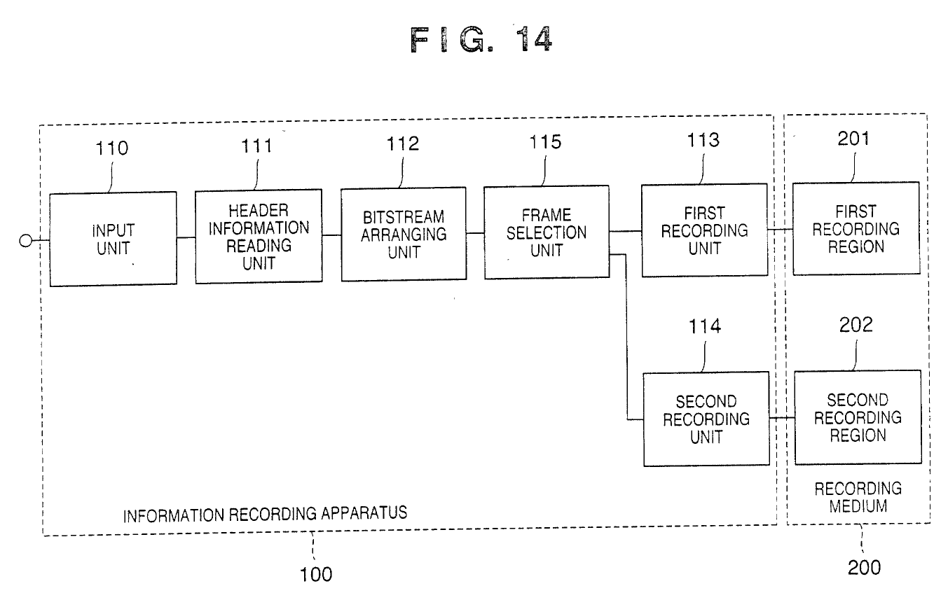

FIG. 14 is a block diagram for explaining the arrangement of an information recording apparatus 100 according to the fifth embodiment of the present invention. The information recording apparatus 100 of this embodiment records image data, which is compression-encoded by JPEG2000 complying with ISO/IEC-15444, on a detachable recording medium 200. Note that a bitstream of moving image data, which is compression-encoded by JPEG2000, will be referred to as a JPEG2000 bitstream hereinafter.

Note that a recording region of the recording medium 200 is divided into a first recording region 201 for recording thumbnails of predetermined frames of moving image data, and a second recording region 202 for recording moving image data other than the thumbnails recorded on the first recording region 201, as shown in FIG. 14. Assume that access speeds to these two recording regions of the recording medium 200 are different in this embodiment, and the access speed to the first recording region 201 for recording thumbnails of image data is higher than that to the second recording region 202.

The information recording apparatus 1 comprises an input unit 110 for inputting JPEG2000 bitstreams of a moving image, a header information reading unit 111 for reading header information from each input JPEG2000 bitstream, a bitstream arranging unit 112 for rearranging each bitstream of moving image data to a predetermined bitstream on the basis of the read header information, a frame selection unit 115 for selecting a predetermined frame from the input moving image data, a first recording unit 113 for recording a given component of the selected frame of the JPEG2000 bitstream on the first recording region 201 of the recording medium 200, and a second recording unit 114 for recording the JPEG2000 bitstreams of the moving image, other than components recorded on the first recording region 201, on the second recording region 202.

That is, the present invention is directed to an information recording apparatus 100 for recording moving image data, which is compression-encoded by Motion JPEG2000, on a recording medium 200 having different access speeds depending on recording positions, characterized by comprising an input unit 110 for inputting moving image data compression-encoded by Motion JPEG2000, a frame selection unit 115 for selecting a predetermined frame from the input moving image data, and recording means (first recording unit 113) for recording component data indicating a reduced-scale image in the selected frame on a recording region that allows high-speed access (first recording region 201) in preference to the remaining component data.

Also, the present invention is characterized in that the reduced-scale image in a frame selected from the input moving image data is a thumbnail of the selected frame. Furthermore, the present invention is characterized by further comprising a header information reading unit 111 for reading header information of the input moving image data, and a bitstream arranging unit 112 for rearranging the bitstream of each frame of the input moving image data to a predetermined bitstream on the basis of the read header information.

By reading the input header information, information such as a size or the like of the thumbnail is detected. Therefore, a designation unit for designating the range of thumbnail component data in a frame selected from the moving image data and separating it from other component data may be added to the aforementioned arrangement. That is, the present invention is characterized by further comprising a designation unit for designating component data indicating the reduced-scale image from the selected frame of the input moving image data.

The electrical arrangement that implements the operation of the information recording apparatus 100 (FIG. 14) which records a JPEG2000 bitstream on the recording medium 200 is the same as that shown in FIG. 2 described in the first embodiment above.

Furthermore, in this embodiment, since moving image data is encoded in RLCP mode shown in FIG. 3 explained in the above embodiment, data of a bitstream are recorded in the order of Resolution, Layer, Component, and Position. That is, the present invention is characterized in that a bitstream of each frame of moving image data is arranged in the order of Resolution level, Layer, Component, and Position.

Also, the relationship between the resolutions (image sizes) and resolution numbers is as has been explained in the above embodiment using FIG. 4. In each resolution, data are arranged in ascending order of layer number, as shown in FIG. 3. The layer number corresponds to the S/N ratio of an image to be decoded to an original image, and the S/N ratio lowers with decreasing layer number.

Assume that the maximum values of the resolution number, layer number, and component number in moving image data compression-encoded by JPEG2000 (JPEG2000 bitstream) are set in advance by an encoder in this embodiment.

Also, the component number matches the number of dimensions of a color space of an image. For example, when the color space of an objective image is a three-dimensional RGB color space, the component number 3. An image with a specific resolution and specific S/N ratio is formed by packets as many as the number of components. For example, in case of an RGB image, the image is formed by packets for respectively storing R, G, and B components.

Moreover, the recording medium 200 used in this embodiment is an optical disk shown in FIG. 5. In general, the optical disk can access data recorded on an inner peripheral recording region faster than data recorded on an outer peripheral recording region. In the fifth embodiment, the inner peripheral recording region of the optical disk is defined as a special region for recording thumbnails of frames selected from moving image data. The access time to the outer peripheral recording region becomes longer than that to the inner peripheral recording region. In this embodiment, this outer peripheral recording region is defined as a general region for recording moving image data other than thumbnails recorded on the special region. That is, the present invention is characterized in that the recording medium 200 is an optical disk, and a recording region that allows high-speed access (first recording region 201) is assured on the inner peripheral portion (special region) of the optical disk.

Also, this embodiment adopts Universal Disk Format (UDF) as the file system of the optical disk. In the UDF, one file can be segmented and written at a plurality of positions. The file to be segmented and recorded is recorded using UDF entries as many as the number of segments. More specifically, the present invention is characterized in that the file system which manages image data recorded on the recording medium 200 is Universal Disk Format.

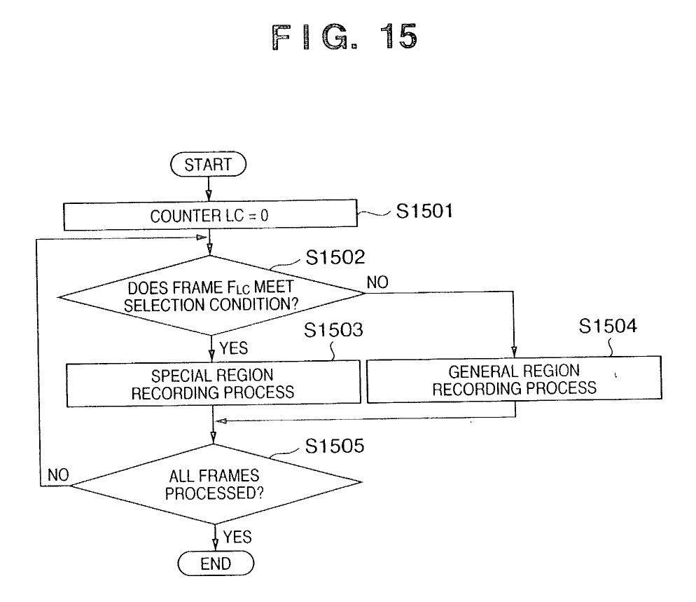

FIG. 15 is a flow chart for explaining the processing sequence upon recording an input JPEG2000 bitstream on the optical disk using the information recording apparatus 100 according to the fifth embodiment.

A counter LC used to count frames is reset to zero (step S1501). A frame number FLC of the frame to be selected is compared with the value of the counter LC (step S1502). Note that a selection condition in this embodiment is determined using the frame number, and for example, when 10 frames are input, one frame is selected. That is, when the value of the counter LC reaches 0, 10, 20, . . . , the corresponding frame is selected. That is, the present invention is characterized in that the frame selection unit 115 selects one frame every predetermined number of frames from input moving image data.

If the selection condition is satisfied in step S1502 (Yes), the flow advances to step S1503. On the other hand, if the selection condition is not satisfied in step S1502 (No), the flow advances to step S1504.

Step S1503 corresponds to a recording process on the special region (first recording region 201) and step S1504 corresponds to a recording process on the general region (second recording region 202). In this case, the write method of encoded data of the frame of interest is the same as that in the above embodiment.

Upon completion of the process in step S1503 or S1504, it is checked if the above process is complete for all input frames (step S1505). If the above process is complete for all frames (Yes), selection of frames is to end. On the other hand, if the above process is not complete for all frames (No), the frame number is incremented, and the flow returns to step S1502, thus repeating the above process.

The flow chart for explaining the detailed processing sequence of the special region recording process in step S1503 in FIG. 15 is the same as the flow chart in FIG. 6. The header information reading unit 111 reads header information in a JPEG2000 bitstream as a file input from the input unit 110 so as to acquire parameters such as a maximum layer number, maximum resolution number, component number, resolution number corresponding to a predetermined image size, stream recording method, and the like in the file (step S601). It is then checked based on the information acquired in step S601 if the stream recording method used to encode each frame of the file is the aforementioned RLCP mode (step S602).

As a result, if the frame of interest is encoded by RLCP mode (Yes), the flow advances to step S604. On the other hand, if the frame of interest is not encoded according to RLCP mode (No), the flow advances to step S603.

In step S603, the bitstream arranging unit 112 rearranges the storage order of data in packets in the JPEG2000 bitstream to the order of data encoded by RLCP mode, and corrects the stream recording method in the header information to RLCP mode. Upon completion of this process, the flow advances to step S604.

In step S604, the data length d_length of data to be recorded on the first recording region 201 that allows high-speed access (the inner peripheral special region on the optical disk shown in FIG. 5) on the recording medium 200 is checked. In this embodiment, this data length d_length is a fixed data length corresponding to thumbnail data having a predetermined size. The first recording unit 113 records a part with the length d_length from the head of the bitstream of that file on the first recording region 201 (special region) using the UDF function (step S605). Subsequently, the second recording unit 114 records data after the length d_length from the head of the bitstream of that file on the second recording region 202 (general region) (step S606).

That is, the present invention is characterized in that the recording means (first recording unit 113) records a bitstream having a predetermined length from the head of a bitstream of the selected frame on a recording region (first recording region 201). Also, the present invention is characterized by further comprising a second recording unit 114 for recording component data other than predetermined component data, which is recorded on the recording region (first recording region), of moving image data on a second recording region 202 on the recording medium 200.

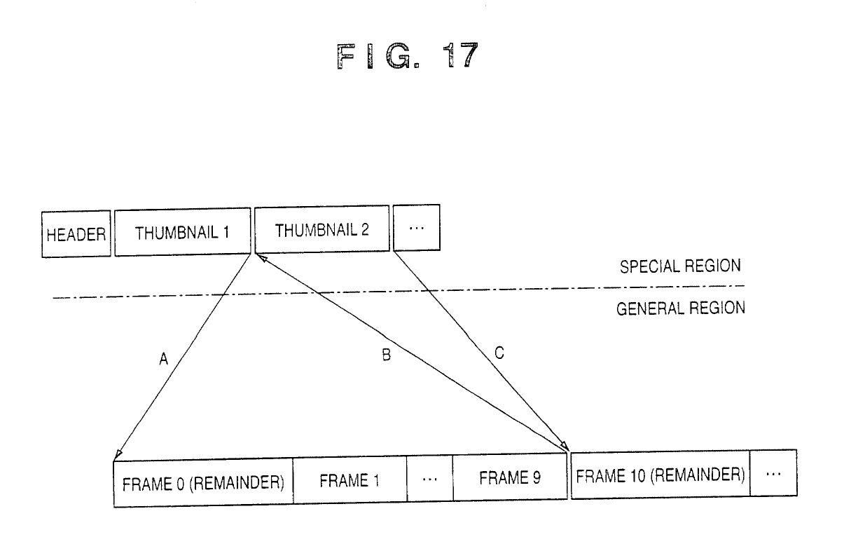

FIG. 17 is a view for explaining an example of the recording positions of a Motion JPEG2000 file on a device in the fifth embodiment.

As shown in FIG. 17, encoded data from a header to a thumbnail corresponding part of frame 0 (first frame) are recorded on the special region (first recording region 201), and the remaining encoded data of that frame is recorded on the general region (second recording region 202). Encoded data from frame 1 (second frame) to frame 9 (10th frame) are recorded on the general region. Encoded data of a thumbnail corresponding part of frame 10 (11th frame) is recorded on the special region as in frame 0, and the remaining encoded data of frame 10 is recorded on the general region.

In this embodiment, data recorded on the special region correspond to thumbnails of frames selected from original moving image data. As for a method of accessing thumbnails of frames recorded on the special region of moving image data written on the optical disk according to the aforementioned sequence at high speed, the sequence that has been explained using FIG. 7 in the above embodiment is applied to thumbnails of the selected frames. When recorded data are read out by applying the process in the sequence shown in the flow chart in FIG. 7, no seek upon accessing the disk occurs, or the seek time can be short if it has occurred.

Also, as for the processing sequence for reading out all moving image data divisionally recorded on the two recording regions of the recording medium 200 and decoding the readout data to obtain an original moving image, the sequence shown in the flow chart of FIG. 8 in the above embodiment can be applied to all frames.

In this embodiment, data to be recorded on the special region has a fixed length. Alternatively, header information may be read to acquire the resolution number and layer number of the required resolution and required S/N ratio, and the data length of data to be recorded on the special region may be determined.

<Sixth Embodiment>

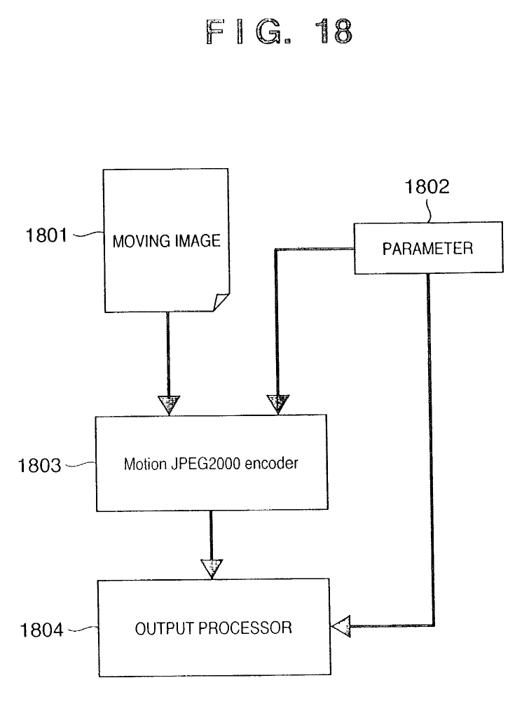

FIG. 18 is a block diagram for explaining the arrangement of an information recording apparatus, and the flows of various data according to the sixth embodiment. A moving image 1801 is input to a Motion JPEG2000 encoder 1803. The Motion JPEG2000 encoder 1803 encodes the input moving image data. In this case, the moving image data is encoded on the basis of the contents of control parameters 1802. These parameters are recorded in the moving image data as header information.

The parameters 1802 include a maximum value of Resolution as resolution scalability, a maximum value of Layer as S/N ratio scalability, Component indicating the number of dimensions of a color space, and the like upon encoding image data.

The Motion JPEG2000 encoder 1803 sequentially outputs JPEG2000 bitstreams complying with RLCP mode to an output processor 1804. The output processor 1804 divisionally records the bitstreams input from the Motion JPEG2000 encoder 1803 on special and general regions with different access speeds on a recording medium having the same format as in the fifth embodiment, using the parameters 1802.

The flow chart used to explain the processing sequence in the output processor 1804 of the sixth embodiment is the same as the flow chart of FIG. 10. Using header information of moving image data, which is compression-encoded by Motion JPEG2000, recording conditions of data to be recorded on the inner peripheral special region of an optical disk are set (step S1001). For example, in this embodiment, data that simultaneously meets the following two recording conditions is recorded on the special region that allows high-speed access:

(1) less than 4 kB from the head of a bitstream; and

(2) encoded data having an image size of not more than 160 pixels (vertical)×120 pixels (horizontal).

It is checked if the above two recording conditions are met (step S1002). As a result, if the two conditions are met (Yes), the bitstream is recorded on the special region (step S1003). On the other hand, if the two conditions are not met (No), the bitstream is recorded on the general region (step S1004).

In the fifth and sixth embodiments described above, of moving image data input to the information recording apparatus, image data required to display a thumbnail of the selected frame is recorded on the inner peripheral special region (first recording region 201) that allows high-speed access of the recording medium (optical disk), and the remaining image data is recorded on the outer peripheral general region (second recording region 202). Therefore, thumbnails can be displayed from moving image data written on the recording medium quicker than the conventional apparatus.

<Seventh Embodiment>

An embodiment in which image data required to display a thumbnail of a frame selected from input moving image data is recorded not on an inner peripheral special region that allows high-speed access, but on an outer peripheral general region will be explained below.

This embodiment uses an information recording apparatus 100 with the arrangement shown in the block diagram of FIG. 14 as in the fifth embodiment described above. The information recording apparatus 100 of this embodiment also records image data, which is compression-encoded by JPEG2000 complying with ISO/IEC-15444, on a detachable recording medium 200.

Assume that access speeds to two recording regions of the recording medium 200 used in this embodiment are also different, and the access speed to a first recording region 201 for recording thumbnails of image data is lower than that to a second recording region 202.

That is, the present invention is directed to an information recording apparatus 100 for recording moving image data, which is compression-encoded by Motion JPEG2000, on a recording medium 200 having different access speeds depending on recording positions, characterized by comprising an input unit 110 for inputting moving image data compression-encoded by Motion JPEG2000, a frame selection unit 115 for selecting a predetermined frame from the input moving image data, and recording means (second recording unit 114) for recording component data other than component data indicating a reduced-scale image in the selected frame on a recording region that allows high-speed access (second recording region 202) in preference to the remaining component data.

Also, the present invention is characterized in that the recording means (second recording unit) records moving image data other than a bitstream having a predetermined length from the head of that of the selected frame on the recording region (second recording region 202).

In this embodiment, the electrical arrangement which implements the operation of the information recording apparatus 100 which records a JPEG2000 bitstream on the recording medium 200 is the same as that shown in FIG. 2.

Furthermore, each frame of moving image data is compression-encoded by Motion JPEG2000 complying with RLCP mode shown in FIG. 3. Therefore, since each frame of moving image data is encoded by RLCP mode, data of a bitstream are recorded in the order of Resolution, Layer, Component, and Position.

Moreover, the recording medium 200 used in this embodiment is an optical disk shown in FIG. 5, and an outer peripheral recording region of the optical disk is defined as a general region (first recording region 201) for recording thumbnails of frames selected from moving image data. An inner peripheral recording region of the optical disk is defined as a special region (second recording region 202) used to record image data other than the thumbnails recorded on the general region. That is, the present invention is characterized in that the recording medium 200 is an optical disk, and the second recording region 202 is assured on the inner peripheral portion (special region) of the optical disk. In addition, this embodiment adopts Universal Disk Format as the file system of the optical disk.

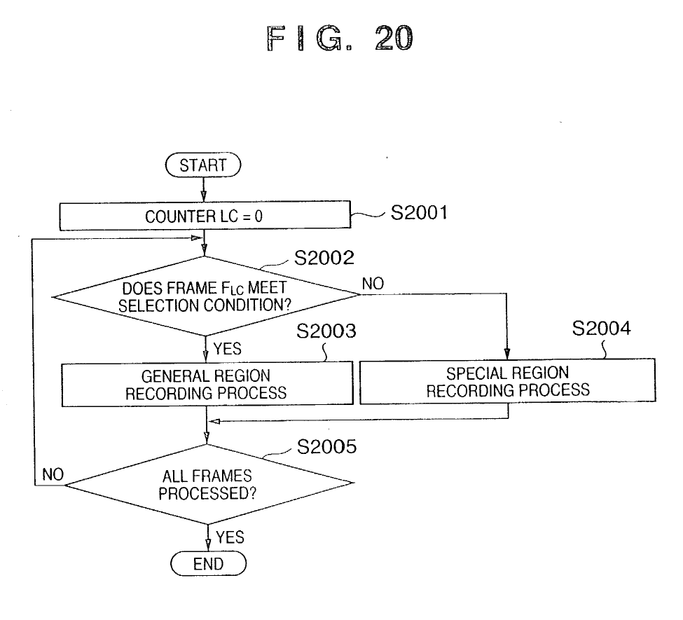

FIG. 20 is a flow chart for explaining the processing sequence upon recording an input JPEG2000 bitstream on the optical disk using the information recording apparatus 100 according to the seventh embodiment.

A counter LC used to count frames is reset to zero (step S2001). A frame number FLC of the frame to be selected is compared with the value of the counter LC (step S2002). Note that a selection condition in this embodiment is determined using the frame number, and for example, when 10 frames are input, one frame is selected. That is, when the value of the counter LC reaches 0, 10, 20, . . . , the corresponding frame is selected.

If the selection condition is satisfied in step S2002 (Yes), the flow advances to step S2003. On the other hand, if the selection condition is not satisfied in step S2002 (No), the flow advances to step S2004.

Step S2003 corresponds to a recording process on the general region (first recording region 201) and step S2004 corresponds to a recording process on the special region (second recording region 202). In this case, the write method of encoded data of the frame of interest is the same as that in the above embodiment.

Upon completion of the process in step S2003 or S2004, it is checked if the above process is complete for all input frames (step S2005). If the above process is complete for all frames (Yes), selection of frames is to end. On the other hand, if the above process is not complete for all frames (No), the frame number is incremented, and the flow returns to step S2002, thus repeating the above process.

The flow chart for explaining the detailed processing sequence of the special region recording process in step S2003 in FIG. 20 is the same as the flow chart in FIG. 11. The header information reading unit 111 reads header information in a JPEG2000 bitstream as a file input from the input unit 110 so as to acquire parameters such as a maximum layer number, maximum resolution number, component number, resolution number corresponding to a predetermined image size, stream recording method, and the like in the file (step S1101). It is then checked based on the information acquired in step S1101 if the stream recording method used to encode each frame of the file is the aforementioned RLCP mode (step S1102).

As a result, if the frame of interest is encoded by RLCP mode (Yes), the flow advances to step S1104. On the other hand, if the frame of interest is not encoded according to RLCP mode (No), the flow advances to step S1103.

In step S1103, the bitstream arranging unit 112 rearranges the storage order of data in packets in the JPEG2000 bitstream to the order of data encoded by RLCP mode, and corrects the stream recording method in the header information to RLCP mode. Upon completion of this process, the flow advances to step S1104.

In step S1104, the data length d_length of data to be recorded on the first recording region 201 (the outer peripheral general region on the optical disk shown in FIG. 5) on the recording medium 200 is checked. In this embodiment, this data length d_length is a fixed data length corresponding to thumbnail data having a predetermined size. The first recording unit 113 records a part with the length d_length from the head of the bitstream of that file on the first recording region 201 (general region) using the UDF function (step S1105). Subsequently, the second recording unit 114 records data after the length d_length from the head of the bitstream of that file on the second recording region 202 (special region) (step S1106).

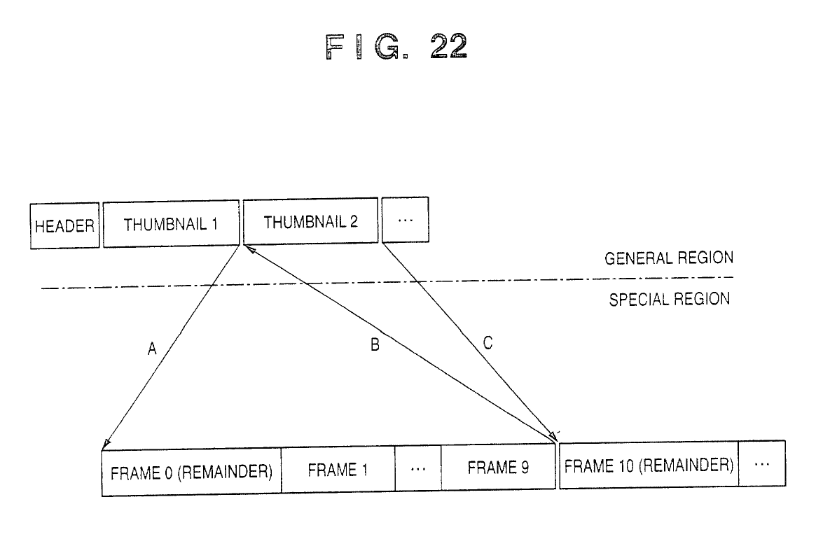

FIG. 22 is a view for explaining an example of the recording positions of a Motion JPEG2000 file on a device in the seventh embodiment. As shown in FIG. 22, encoded data from a header to a thumbnail corresponding part of frame 0 (first frame) are recorded on the general region (first recording region 201), and the remaining encoded data of that frame is recorded on the special region (second recording region 202). Encoded data from frame 1 (second frame) to frame 9 (10th frame) are recorded on the special region. Encoded data of a thumbnail corresponding part of frame 10 (11th frame) is recorded on the general region as in frame 0, and the remaining encoded data of frame 10 is recorded on the special region.

As for a method of accessing thumbnails of frames recorded on the general region of moving image data written on the optical disk according to the aforementioned sequence, the sequence that has been explained using FIG. 7 in the above embodiment is applied to the general region where the thumbnails of the selected frames are recorded. When recorded data are read out by applying the process in the sequence shown in the flow chart in FIG. 7, a moving image formed by only thumbnails can be played back.

Also, as for the processing sequence for reading out all moving image data divisionally recorded on the two recording regions of the recording medium 200 and decoding the readout data to obtain an original moving image, the sequence shown in the flow chart of FIG. 8 in the above embodiment can be applied to all frames.

In this embodiment, data to be recorded on the special region has a fixed length. Alternatively, header information may be read to acquire the resolution number and layer number of the required resolution and required S/N ratio, and the data length of data to be recorded on the general region may be determined.

<Eighth Embodiment>

The block diagram for explaining the arrangement of an information recording apparatus, and the flows of various data according to the eighth embodiment is the same as that shown in FIG. 18. That is, a moving image 1801 is input to a Motion JPEG2000 encoder 1803. The Motion JPEG2000 encoder 1803 encodes the input moving image data. In this case, the moving image data is encoded on the basis of the contents of control parameters 1802. These parameters are recorded in the moving image data as header information.

The Motion JPEG2000 encoder 1803 sequentially outputs JPEG2000 bitstreams complying with RLCP mode to an output processor 1804. The output processor 1804 divisionally records the bitstreams input from the Motion JPEG2000 encoder 1803 on special and general regions with different access speeds on a recording medium having the same format as in the seventh embodiment, using the parameters 1802.

The flow chart used to explain the processing sequence in the output processor 1804 of the eighth embodiment is the same as the flow chart of FIG. 12. Using header information of moving image data, which is compression-encoded by Motion JPEG2000, recording conditions of data to be recorded on the outer peripheral general region of an optical disk are set (step S1201). For example, in this embodiment, data that simultaneously meets the following two recording conditions is recorded on the general region:

(1) less than 4 kB from the head of a bitstream; and

(2) encoded data having an image size of not more than 160 pixels (vertical)×120 pixels (horizontal).

It is checked if the above two recording conditions are met (step S1202). As a result, if the two conditions are met (Yes), the bitstream is recorded on the general region (step S1203). On the other hand, if the two conditions are not met (No), the bitstream is recorded on the special region (step S1204).

In the seventh and eighth embodiments described above, of moving image data input to the information recording apparatus, image data required to display a thumbnail of the selected frame is recorded on the outer peripheral general region (first recording region 201) of the recording medium (optical disk), and the remaining image data is recorded on the inner peripheral special region (second recording region 202) that allows high-speed access. Therefore, the entire recorded moving image data can be played back quicker than the conventional apparatus.

Furthermore, the present invention has the following advantages over the problems of the prior arts.

The present invention can solve the problem of Japanese Patent Laid-Open No. 03-053381 “Image Information High-speed Search Method”, since data of a predetermined part of variable-length encoded data is recorded on the special region while maintaining full compatibility with the standardized JPEG2000 format. Also, even when JPEG2000 data is broken at an arbitrary position from the head of data, an image can be played back using only that data. Hence, whether or not data to be recorded on the special region is completed need not be checked.

As for the problem of Japanese Patent Laid-Open No. 07-123346 “Image Recording/Reproduction Method and Apparatus”, the present invention can prevent data from being repetitively recorded on a region that allows high-speed access, and another region, and can improve the use efficiency of the recording medium.

Furthermore, as for the problem of Japanese Patent Laid-Open No. 08-077325 “Still Image Data Recording Apparatus”, the present invention can obtain the same effect not only for fixed-length encoded image data but also for variable-length encoded data.

As described above, according to the present invention, of image data to be recorded on a recording medium, image data that requires high-speed access upon reading out data is recorded on a region that allows high-speed access of the recording medium, thus shortening the access time to recorded data.

<Ninth Embodiment>

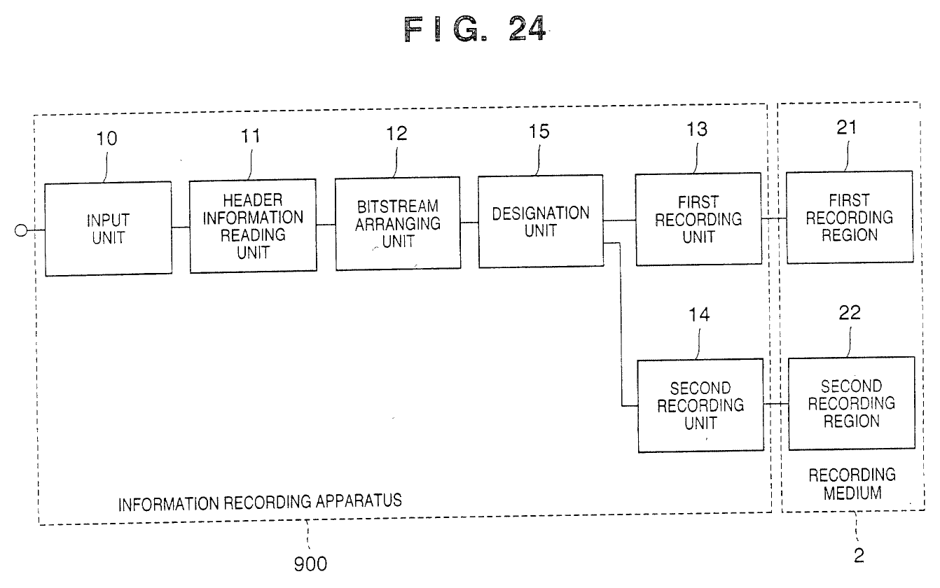

FIG. 24 is a block diagram for explaining the arrangement of an information recording apparatus 900 according to the ninth embodiment of the present invention. The information recording apparatus 900 of this embodiment records image data, which is compression-encoded by JPEG2000 complying with ISO/IEC-15444, on a recording region of a detachable recording medium 2. Note that a bitstream of image data, which is compression-encoded by JPEG2000, will be referred to as a JPEG2000 bitstream hereinafter.

The recording region of the recording medium 2 is divided into a first recording region 21 for recording image data of a predetermined image region, and a second recording region 22 for recording image data other than the image data recorded on the first recording region 21, as shown in FIG. 24. Assume that access speeds to these two recording regions of the recording medium 2 are different in this embodiment, and the access speed to the first recording region 21 for recording predetermined image data is higher than that to the second recording region 22.

The information recording apparatus 900 comprises an input unit 10 for inputting a JPEG2000 bitstream, a header information reading unit 11 for reading header information from the input JPEG2000 bitstream, a bitstream arranging unit 12 for rearranging the bitstream of image data to a predetermined bitstream on the basis of the read header information, a designation unit 15 for designating predetermined image data from the MSB side of a bitstream, a first recording unit 13 for recording a predetermined image data part of the JPEG2000 bitstream on the first recording region 21 of the recording medium 2, and a second recording unit 14 for recording the JPEG2000 bitstream, other than image data recorded on the first recording region 21, on the second recording region 22.

That is, the present invention is directed to an information recording apparatus 900 for recording image data, which is compression-encoded by JPEG2000, on a recording medium 2 having different access speeds depending on recording positions, characterized by comprising an input unit 10 for inputting image data, which is compression-encoded by JPEG2000, and in which image data of a predetermined image region is allocated on the most significant bit side, a designation unit 15 for designating the image data of the predetermined image region, which is allocated on the most significant bit side of the input image data, and recording means (first recording unit 13) for recording the designated image data on the most significant bit side on a recording region that allows high-speed access (first recording region 21) in preference to the remaining image data.

Also, the present invention is characterized by further comprising a header information reading unit 11 for reading header information of the input image data, and a bitstream arranging unit 12 for rearranging the bitstream of the input image data to a predetermined bitstream on the basis of the read header information.

The schematic diagram used to explain the electrical arrangement that implements the operation of the information recording apparatus 900 (FIG. 24) which records a JPEG2000 bitstream on the recording medium 2 is the same as that in FIG. 2 described in the first embodiment. Therefore, the functions and operations of respective units are as has been explained in the first embodiment. That is, in FIG. 2, a CPU 101 is an arithmetic device for controlling the operation of the overall information recording apparatus 900. A secondary storage unit 103 is a hard disk that stores a computer program and the like. A primary storage unit 102 is a memory used to load and store the computer program stored in the secondary storage unit 103 when that program is executed by the CPU 101. In general, the capacity of the primary storage unit 102 is smaller than that of the secondary storage unit 103, and a computer program, data, and the like that cannot be stored in the primary storage unit 102 are stored in the secondary storage unit 103. Also, data and the like, which must be stored for a long period of time, are stored in the secondary storage unit 103.

An input device 104 comprises a mouse, keyboard, and the like, and is used to send an interrupt signal upon execution of the computer program. An output device 105 comprises a monitor, printer, and the like. Using the electrical arrangement shown in FIG. 2, the processes in the header information reading unit 11, bitstream arranging unit 12, first recording unit 13, and second recording unit 14 of the information recording apparatus 900 shown in FIG. 24 are implemented. Furthermore, when the input unit 10 shown in FIG. 24 is connected to the electrical arrangement in FIG. 2, a JPEG2000 bitstream can be input.

Encoded data, which is compression-encoded by general JPEG2000, will be explained below. Assume that ROI (Region of Interest) designation that designates a predetermined region and is recorded on the most significant bit (MSB) side has been made in encoded data compressed by JPEG2000 in this embodiment.

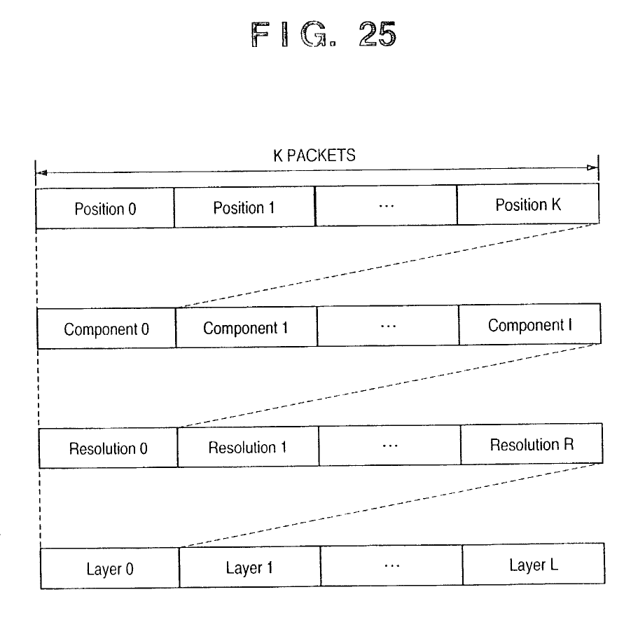

FIG. 25 is a schematic view for explaining the detailed format of image data, which is compression-encoded by JPEG2000 according to Layer—Resolution level—Component—Position Progression (to be referred to as “LRCP” hereinafter) mode. In this embodiment, since image data is encoded in LRCP mode, data of a bitstream are recorded in the order of Layer, Resolution, Component, and Position. That is, the present invention is characterized in that a bitstream of image data is arranged in the order of Layer, Resolution level, Component, and Position. Also, in the layer structure, a plurality of bitplanes which form each color component are recorded in turn from a bitplane on the most significant bit (MSB) side.

The schematic view for explaining the relationship between the resolutions (image sizes) and resolution numbers is as shown in FIG. 4 explained in the first embodiment.

In each resolution, data are arranged in ascending order of layer number, as shown in FIG. 25. The layer number corresponds to the S/N ratio of an image to be decoded to an original image, and the S/N ratio lowers with decreasing layer number. Furthermore, ROI data is located on the MSB side of data of other regions since it has been shifted up. Note that the head layer stores data required to decode this ROI part.

Assume that the maximum values of the resolution number, layer number, and component number in image data encoded by JPEG2000 (JPEG2000 bitstream) are set in advance by an encoder in this embodiment. These parameters are encoded as header information, and an original image is encoded according to those parameters, thus generating a JPEG2000 bitstream of the image.

Note that the component number matches the number of dimensions of a color space of an image. For example, when the color space of an objective image is a three-dimensional RGB color space, the component number=3. On the other hand, monochrome image data mainly used in the medical field has a component number=1.

Furthermore, a packet is one management unit in encoded data, and each position is formed by one packet in this embodiment. Therefore, one layer includes packets as many as (the number of positions)×(the number of components)×(the number of resolutions).

The recording medium 2 used in this embodiment is an optical disk, as shown in FIG. 5 of the first embodiment. In general, the optical disk can access data recorded on an inner peripheral recording region faster than data recorded on an outer peripheral recording region. In the ninth embodiment, the inner peripheral recording region of the optical disk is defined as a special region for recording ROI data of image data. The access time to the outer peripheral recording region becomes longer than that to the inner peripheral recording region. In this embodiment, this outer peripheral recording region is defined as a general region for recording image data other than ROI data recorded on the special region. That is, the present invention is characterized in that the recording medium 2 is an optical disk, and a recording region that allows high-speed access (first recording region 21) is assured on the inner peripheral portion (special region) of the optical disk.

Also, this embodiment adopts Universal Disk Format (UDF) as the file system of the optical disk. In the UDF, one file can be segmented and written at a plurality of positions. The file to be segmented and recorded is recorded using UDF entries as many as the number of segments. More specifically, the present invention is characterized in that the file system which manages image data recorded on the recording medium 2 is Universal Disk Format.

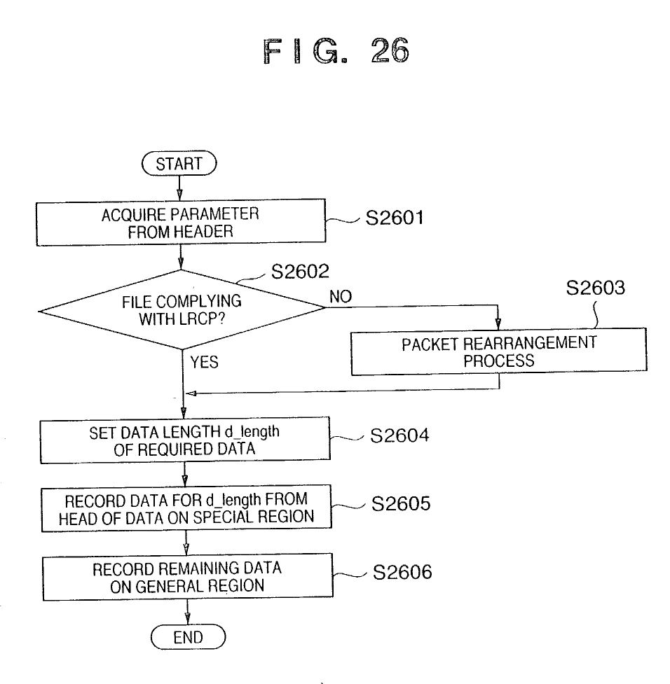

FIG. 26 is a flow chart for explaining the processing sequence upon recording an input JPEG2000 bitstream on the optical disk using the information recording apparatus 900 according to the ninth embodiment. Note that this embodiment covers high-resolution monochrome image data mainly used in the medical field.

The header information reading unit 11 reads header information in a JPEG2000 bitstream as a file input from the input unit 10 so as to acquire parameters such as a maximum layer number, maximum resolution number, component number, resolution number corresponding to a predetermined image size, stream recording method, and the like in the file (step S2601). It is then checked based on the information acquired in step S2601 if the stream recording method used to encode the file is the aforementioned LRCP mode (step S2602).

As a result, if the input image data is encoded by LRCP mode (Yes), the flow advances to step S2604. On the other hand, if the input image data is not encoded according to LRCP mode (No), the flow advances to step S2603.

In step S2603, the bitstream arranging unit 12 rearranges the storage order of data in packets in the JPEG2000 bitstream to the order of data encoded by LRCP mode, and corrects the stream recording method in the header information to LRCP mode. Upon completion of this process, the flow advances to step S2604.

In step S2604, the designation unit 15 designates the data length d_length of data to be recorded on the first recording region 21 that allows high-speed access (the inner peripheral special region on the optical disk shown in FIG. 5) on the recording medium 2. In this embodiment, this data length d_length is a fixed data length corresponding to data having a predetermined size. The first recording unit 13 records a part with the length d_length from the head of the bitstream of that file on the first recording region 21 (special region) using the UDF function (step S2605).

Subsequently, the second recording unit 14 records data after the length d_length from the head of the bitstream of that file on the second recording region 22 (general region) (step S2606). Note that the length d_length can be determined by setting the number of bytes that can store bitplanes of the ROI part. In this manner, since image data consisting of a plurality of bitplanes are recorded on the special region that allows high-speed access in turn from the MSB side, only bitplane data on the MSB side can be recorded on the special region.

That is, the present invention is characterized in that the recording unit (first recording unit 13) records a bitstream having a predetermined length from the head of a bitstream of input image data on a recording region (first recording region 21). Also, the present invention is characterized by further comprising a second recording unit 14 for recording a bitstream other than the bitstream of the image data recorded on the recording region (first recording region 21) on a second recording region 22 (general region) on the recording medium 2.

A method of accessing predetermined data of image data written on the optical disk according to the sequence shown in FIG. 26 at high speed will be explained below. The flow chart used to explain the processing sequence for reading out only a bitstream written on the special region, and displaying the ROI of an original image is as has been described in the first embodiment using FIG. 7. Note that this embodiment covers ROI data in place of thumbnail data.

UDF entries of a file to be read out are acquired (step S701). Only an entry indicating a part of the special region is selected from the UDF entries selected in step S701 (step S702). Then, data of the selected part is read and decoded (step S703).

In this embodiment, data recorded on the special region corresponds to image data for a plurality of bits from the MSB side in encoded data. ROI data are recorded together on the special region by applying the process shown in FIG. 26 to bitplane information indicating the number of bitplanes that can display the ROI data, and only data recorded on the special region are read out by applying the process in the sequence shown in the flow chart of FIG. 7. In this manner, upon displaying a large number of image files, only important regions of original images can be quickly decoded and displayed. Also, no seek upon accessing the disk occurs, or the seek time can be short if it has occurred.

Furthermore, in case of JPEG2000, even when data is broken in the middle of encoded data, a decoding process can be done using that encoded data. In this way, using only ROI image data, a plurality of image data can be browsed quickly.

The flow chart for explaining the processing sequence for reading out all image data, which are divisionally recorded on the two recording regions of the recording medium 2, and decoding the readout image data to obtain an original image is as has been explained in the first embodiment using FIG. 8.

That is, UDF entries of image data to be read out are acquired (step S801). All image data are read out from the respective recording regions in accordance with the information of the UDF entries (step S802). Furthermore, the readout data are decoded (step S803). In this manner, all image data recorded on the recording medium 2 can be read out and can be displayed on a screen.

In this embodiment, data to be recorded on the special region has a fixed length. Alternatively, header information may be read to calculate the number of packets to be recorded on the special region, and the data length of data to be recorded on the special region may be determined. In this manner, all data required to decode ROI data from the MSB side can be recorded on the special region.

<10th Embodiment>

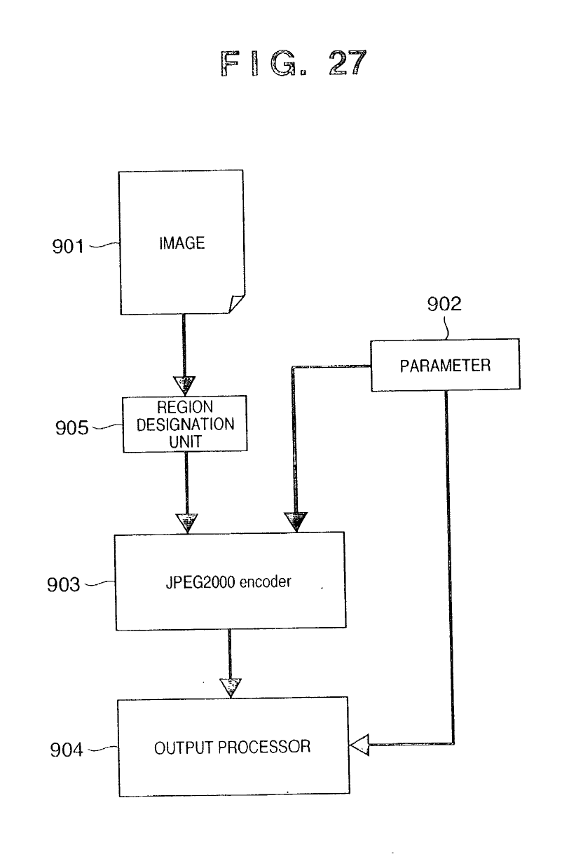

FIG. 27 is a block diagram for explaining the arrangement of an information recording apparatus, and the flows of various data according to the 10th embodiment. A region designation unit 905 designates a region of interest (ROI) of an original image 901. The original image 901 designated with the ROI is input to a JPEG2000 encoder 903. The JPEG2000 encoder 903 encodes the input image data. In this case, the image data is encoded on the basis of the contents of control parameters 902. These parameters are recorded in the image data as header information.

The parameters 902 include a maximum value of Resolution as resolution scalability, a maximum value of Layer as S/N ratio scalability, Component indicating the number of dimensions of a color space, and the like upon encoding image data. Note that the number of components indicates the number of color components of the input original image 901. On the other hand, layer segmentation is set to include at least two layers, i.e., a layer which contains up to bitplanes of only a shift-up part of ROI data designated by the region designation unit 905 from the MSB side, and a layer of other data.

The JPEG2000 encoder 903 sequentially outputs a JPEG2000 bitstream complying with LRCP mode to an output processor 904 in accordance with the parameters 902 and image data containing the ROI data. The output processor 904 divisionally records the bitstream input from the JPEG2000 encoder 903 on special and general regions with different access speeds on a recording medium having the same format as in the first embodiment, using the parameters 902.

Note that the flow chart for explaining the processing sequence in the output processor 904 according to the 10th embodiment is the same as that shown in FIG. 10 explained in the second embodiment. However, in this embodiment, data that simultaneously meets the following two recording conditions is recorded on the special region that allows high-speed access (step S1001):

(1) less than 4 kB from the head of a bitstream; and

(2) a bitplane required to decode an ROI part.

It is checked if the above two recording conditions are met (step S1002) As a result, if the two conditions are met (Yes), the bitstream is recorded on the special region (step S1003). On the other hand, if the two conditions are not met (No), the bitstream is recorded on the general region (step S1004). Note that the JPEG2000 encoder 903 may output a control signal upon completion of encoding of each packet, and may pass it to the output processor 904. In this case, a region to be stored can be designated for each packet. In this embodiment, control for determining the end of data required to decode an ROI from the MSB side can be made based on the number of packets.

That is, the present invention is characterized by further comprising image region designation means (region designation unit 905) for designating a predetermined image region of input image data, compression encoding means (JPEG2000 encoder 903) for compression-encoding input image data by JPEG2000 while allocating image data of the predetermined image region on the most significant bit side, and parameter input means for inputting predetermined parameters 902 required upon compression encoding by JPEG2000.

As described above, according to the information recording apparatuses of the ninth and 10th embodiments, since only data for important bitplanes from the MSB side of encoded data consisting of a plurality of bitplanes of a JPEG2000 bitstream are recorded on an inner peripheral region that allows high-speed access of a recording medium, required data can be accessed at high speed.

When image data must be quickly displayed but the time used to display image data of all bitplanes is short like image data used in the medical field, since data for bitplanes that can preferentially display only a most important part are recorded on an inner peripheral region that allows high-speed access of a recording medium, even a general display device can display the image data at high speed without any image conversion process and the like.

<11th Embodiment>

An embodiment in which ROI image data is recorded not on an inner peripheral special region that allows high-speed access, but on an outer peripheral general region will be explained below.

This embodiment uses an information recording apparatus 900 with the arrangement shown in the block diagram of FIG. 24 as in the ninth embodiment described above. The information recording apparatus 900 of this embodiment also records image data, which is compression-encoded by JPEG2000 complying with ISO/IEC-15444, on a detachable recording medium 2.

Assume that access speeds to two recording regions of the recording medium 2 used in this embodiment are also different, and the access speed to a first recording region 21 for recording ROI data of image data is lower than that to a second recording region 22.

That is, the present invention is directed to an information recording apparatus 900 for recording image data, which is compression-encoded by JPEG2000, on a recording medium 2 having different access speeds depending on recording positions, characterized by comprising an input unit 10 for inputting image data, which is compression-encoded by JPEG2000, a designation unit 15 for designating image data of a predetermined image region, which is allocated on the most significant bit side of the input image data, and a recording unit (second recording unit 14) for recording image data other than the designated image data on the most significant bit side on a recording region that allows high-speed access (second recording region 22) in preference to the image data on the most significant bit side.

Also, the present invention is characterized in that the recording unit (second recording unit 14) records a bitstream other than a bitstream having a predetermined length from the head of that of the input image data on the recording region (second recording region 22).

In this embodiment, the electrical arrangement which implements the operation of the information recording apparatus 900 which records a JPEG2000 bitstream on the recording medium 2 is the same as that shown in FIG. 2.

Furthermore, image data is compression-encoded by JPEG2000 complying with LRCP mode shown in FIG. 25. Therefore, since image data is encoded by LRCP mode, data of a bitstream are recorded in the order of Layer, Resolution, Component, and Position.

Moreover, the recording medium 2 used in this embodiment is an optical disk shown in FIG. 5, and an outer peripheral recording region of the optical disk is defined as a general region for recording ROI data of image data. An inner peripheral recording region of the optical disk is defined as a special region used to record image data other than the ROI data recorded on the general region. That is, the present invention is characterized in that the recording medium 2 is an optical disk, and the second recording region 22 is assured on the inner peripheral portion (special region) of the optical disk. In addition, this embodiment adopts Universal Disk Format as the file system of the optical disk.

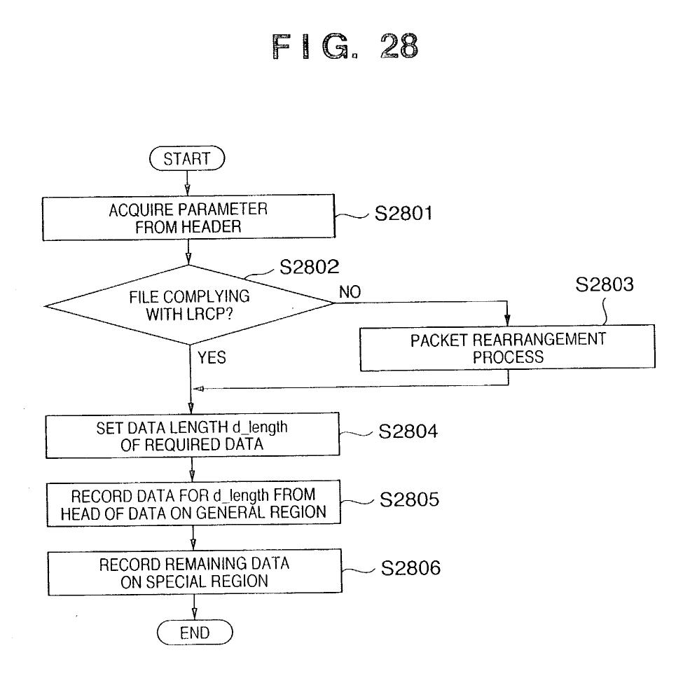

FIG. 28 is a flow chart for explaining the processing sequence upon recording an input JPEG2000 bitstream on the optical disk using the information recording apparatus 900 according to the 11th embodiment.

The header information reading unit 11 reads header information in a JPEG2000 bitstream as a file input from the input unit 10 so as to acquire parameters such as a maximum layer number, maximum resolution number, component number, resolution number corresponding to a predetermined image size, stream recording method, and the like in the file (step S2801). It is then checked based on the information acquired in step S2801 if the stream recording method used to encode the file is the aforementioned LRCP mode (step S2802).

As a result, if the input image data is encoded by LRCP mode (Yes), the flow advances to step S2804. On the other hand, if the input image data is not encoded according to LRCP mode (No), the flow advances to step S2803. In step S2803, the bitstream arranging unit 12 rearranges the storage order of data in packets in the JPEG2000 bitstream to the order of data encoded by LRCP mode, and corrects the stream recording method in the header information to LRCP mode. Upon completion of this process, the flow advances to step S2804.

In step S2804, the designation unit 15 designates the data length d_length of data to be recorded on the first recording region 21 (the outer peripheral general region on the optical disk shown in FIG. 5) on the recording medium 2. In this embodiment, this data length d_length is a fixed data length corresponding to ROI data having a predetermined size. The first recording unit 13 records a part with the length d_length from the head of the bitstream of that file on the first recording region 21 (general region) using the UDF function (step S2805). Subsequently, the second recording unit 14 records data after the length d_length from the head of the bitstream of that file on the second recording region 22 (special region) (step S2806).

A method of accessing predetermined data of image data written on the optical disk according to the sequence shown in FIG. 28 at high speed will be explained below. In the ninth embodiment described above, only the bitstream written in the special region is read out to display an ROI part of an original image, as shown in FIG. 26. However, in the 11th embodiment, ROI data are recorded on the first recording region 21 (general region) of the recording medium 2. Hence, only an entry indicating a part of the general region is selected from UDF entries of a file to be read out, and data of the selected part is read out, thus decoding the readout data. In this manner, only an ROI part of an original image can be displayed.

The processing sequence for reading out all image data, which are divisionally recorded on the two recording regions of the recording medium 2, and decoding the readout image data to obtain an original image is the same as that shown in the flow chart in FIG. 8. That is, UDF entries of image data to be read out are acquired (step S801). All image data are read out from the respective recording regions in accordance with the information of the UDF entries (step S802). Furthermore, the readout data are decoded (step S803). In this embodiment, since large-size data are recorded on the special region, all image data recorded on the recording medium 2 can be read out and displayed on a screen quicker than the conventional apparatus.

In this embodiment, data to be recorded on the special region has a fixed length. Alternatively, header information may be read to acquire the resolution number and layer number of the required resolution and required S/N ratio, and the data length of data to be recorded on the general region may be determined.

<12th Embodiment>

The block diagram for explaining the arrangement of an information recording apparatus, and the flows of various data according to the 12th embodiment is the same as that shown in FIG. 27. That is, a region designation unit 905 designates a region of interest (ROI) of an original image 901. The original image 901 designated with the ROI is input to a JPEG2000 encoder 903. The JPEG2000 encoder 903 encodes the input image data. In this case, the image data is encoded on the basis of the contents of control parameters 902. These parameters are recorded in the image data as header information.

The JPEG2000 encoder 903 sequentially outputs a JPEG2000 bitstream complying with LRCP mode to an output processor 904 in accordance with the parameters 902 and image data containing the ROI data. The output processor 904 divisionally records the bitstream input from the JPEG2000 encoder 903 on special and general regions with different access speeds on a recording medium having the same format as in the first embodiment, using the parameters 902.

The flow chart for explaining the processing sequence in the output processor 904 according to the 12th embodiment is the same as that shown in FIG. 12 explained in the fourth embodiment. However, in this embodiment, data that simultaneously meets the following two recording conditions is recorded on the general region (step S1201):

(1) less than 4 kB from the head of a bitstream; and

(2) a bitplane required to decode an ROI part.

It is checked if the above two recording conditions are met (step S1202). As a result, if the two conditions are met (Yes), the bitstream is recorded on the general region (step S1203). On the other hand, if the two conditions are not met (No), the bitstream is recorded on the special region (step S1204).

In the 11th and 12th embodiments described above, of image data input to the information recording apparatus, image data required to decode an ROI part is recorded on the outer peripheral general region (first recording region 21), and the remaining image data is recorded on the inner peripheral special region (second recording region 22) that allows high-speed access. Therefore, all image data written on the recording medium 2 can be decoded quicker than the conventional apparatus.

That is, in the present invention, upon displaying a high-quality image read out from the recording medium 2 that records image data, since data other than ROI data are recorded on a region that allows high-speed access of the recording medium 2, the read time upon displaying a high-quality image can be shortened.

<13th Embodiment>

In this embodiment, a method of recording moving image data, which is compression-encoded by Motion JPEG2000, on a recording medium will be explained. Note that an outline of a Motion JPEG2000 file is as has been explained in the fifth embodiment using FIG. 13.

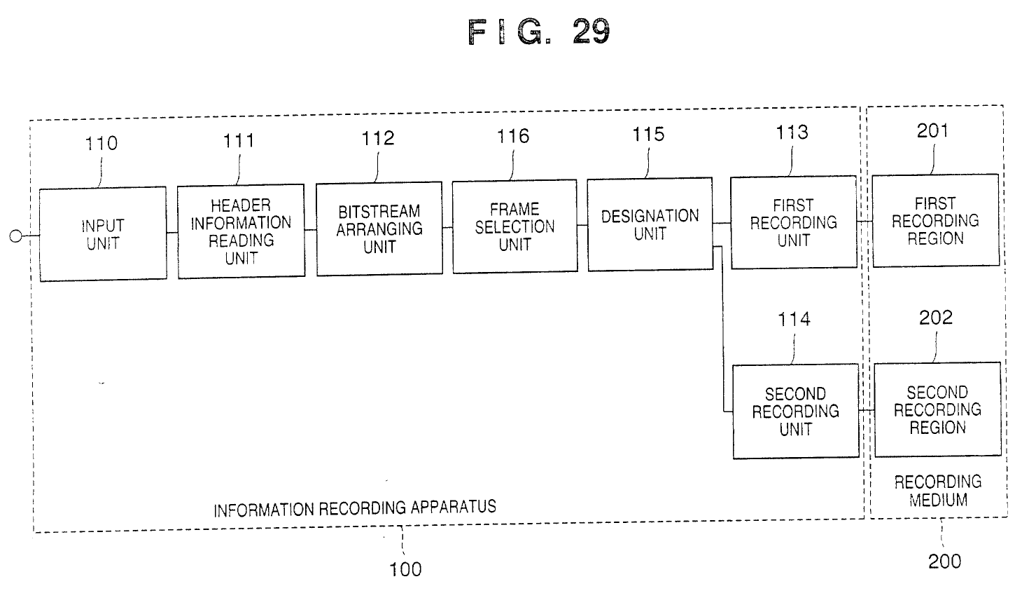

FIG. 29 is a block diagram for explaining the arrangement of an information recording apparatus 100 according to the 13th embodiment of the present invention. The information recording apparatus 100 of this embodiment records image data, which is compression-encoded by JPEG2000 complying with ISO/IEC-15444, on a detachable recording medium 200. Note that a bitstream of moving image data, which is compression-encoded by JPEG2000, will be referred to as a JPEG2000 bitstream hereinafter.

Note that a recording region of the recording medium 200 is divided into a first recording region 201 for recording ROI data of predetermined frames of moving image data, and a second recording region 202 for recording moving image data other than the ROI data recorded on the first recording region 201, as shown in FIG. 29. Assume that access speeds to these two recording regions of the recording medium 200 are different in this embodiment, and the access speed to the first recording region 201 for recording ROI data of the selected frames is higher than that to the second recording region 202.

The information recording apparatus 900 comprises an input unit 110 for inputting JPEG2000 bitstreams of a moving image, a header information reading unit 111 for reading header information from each input JPEG2000 bitstream, a bitstream arranging unit 112 for rearranging the bitstreams of each frame of moving image data to a predetermined bitstream on the basis of the read header information, a frame selection unit 116 for selecting a predetermined frame from the input moving image data, a designation unit 115 for designating a predetermined region of the selected frame, a first recording unit 113 for recording a given component of the selected frame of the JPEG2000 bitstream on the first recording region 201 of the recording medium 200, and a second recording unit 114 for recording the JPEG2000 bitstreams of the moving image, other than components recorded on the first recording region 201, on the second recording region 202.

That is, the present invention is directed to an information recording apparatus 100 for recording moving image data, which is compression-encoded by Motion JPEG2000, on a recording medium 200 having different access speeds depending on recording positions, characterized by comprising an input unit 110 for inputting moving image data, which is compression-encoded by Motion JPEG2000, and in which image data of a predetermined image region is allocated on the most significant bit side in image data of each frame that forms the moving image data, a frame selection unit 116 for selecting a predetermined frame from the input moving image data, a designation unit 115 for designating the image data of the predetermined image region allocated on the most significant bit side from a bitstream of the selected frame, and a recording unit (first recording unit 113) for recording the designated image data on the most significant bit side on a recording region that allows high-speed access (first recording region 201) in preference to the remaining moving image data.

Furthermore, the present invention is characterized by further comprising a header information reading unit 111 for reading header information of the input moving image data, and a bitstream arranging unit 112 for rearranging the bitstream of each frame of the input moving image data to a predetermined bitstream on the basis of the read header information.

The electrical arrangement that implements the operation of the information recording apparatus 100 (FIG. 29) which records a JPEG2000 bitstream on the recording medium 200 is the same as that shown in FIG. 2 described in the first embodiment previously.

Furthermore, in this embodiment, since moving image data is encoded in LRCP mode shown in FIG. 25 explained in the above embodiment, data of a bitstream are recorded in the order of Layer, Resolution, Component, and Position. That is, the present invention is characterized in that a bitstream of each frame of moving image data is arranged in the order of Layer, Resolution level, Component, and Position. Also, in the layer structure, a plurality of bitplanes which form each color component are recorded in turn from a bitplane on the most significant bit (MSB) side.

Also, the relationship between the resolutions (image sizes) and resolution numbers is as has been explained in the above embodiment using FIG. 4. In each resolution, data are arranged in ascending order of layer number, as shown in FIG. 25. The layer number corresponds to the S/N ratio of an image to be decoded to an original image, and the S/N ratio lowers with decreasing layer number.

On the other hand, ROI data is located on the MSB side of data of other regions since it has been shifted up. Hence, upon adopting the layer structure, an ROI is inevitably stored at the head of a file. Note that the head layer stores data required to decode this ROI part.

Assume that the maximum values of the resolution number, layer number, and component number in moving image data compression-encoded by Motion JPEG2000 (JPEG2000 bitstream) are set in advance by an encoder in this embodiment.

Also, the component number matches the number of dimensions of the color space of an image. For example, when the color space of an objective image is a three-dimensional YCbCr color space, the component number=3. A packet is one management unit in encoded data, and each position is formed by one packet in this embodiment. Therefore, one layer includes packets as many as (the number of positions)×(the number of components)×(the number of resolutions).

Furthermore, the recording medium 200 used in this embodiment is an optical disk shown in FIG. 5. In general, the optical disk can access data recorded on an inner peripheral recording region faster than data recorded on an outer peripheral recording region. In the 13th embodiment, the inner peripheral recording region of the optical disk is defined as a special region for recording ROI data of frames selected from moving image data. The access time to the outer peripheral recording region becomes longer than that to the inner peripheral recording region. In this embodiment, this outer peripheral recording region is defined as a general region for recording moving image data other than the ROI data recorded on the special region. That is, the present invention is characterized in that the recording medium 200 is an optical disk, and a recording region that allows high-speed access (first recording region 201) is assured on the inner peripheral portion (special region) of the optical disk.

Moreover, this embodiment adopts Universal Disk Format (UDF) as the file system of the optical disk. In the UDF, one file can be segmented and written at a plurality of positions. The file to be segmented and recorded is recorded using UDF entries as many as the number of segments. More specifically, the present invention is characterized in that the file system which manages image data recorded on the recording medium 200 is Universal Disk Format.

Note that the flow chart for explaining the processing sequence upon recording an input JPEG2000 bitstream on the optical disk using the information recording apparatus 100 according to the 13th embodiment is the same as that of FIG. 15 explained in the fifth embodiment.

That is, a counter LC used to count frames is reset to zero (step S1501). A frame number FLC of the frame to be selected is compared with the value of the counter LC (step S1502). Note that a selection condition in this embodiment is determined using the frame number, and for example, when 10 frames are input, one frame is selected. That is, when the value of the counter LC reaches 0, 10, 20, . . . , the corresponding frame is selected. That is, the present invention is characterized in that the frame selection unit 115 selects one frame every predetermined number of frames from input moving image data.

If the selection condition is satisfied in step S1502 (Yes), the flow advances to step S1503. On the other hand, if the selection condition is not satisfied in step S1502 (No), the flow advances to step S1504.

Step S1503 corresponds to a recording process on the special region (first recording region 201) and step S1504 corresponds to a recording process on the general region (second recording region 202). In this case, the write method of encoded data of the frame of interest is the same as that in the above embodiment.

Upon completion of the process in step S1503 or S1504, it is checked if the above process is complete for all input frames (step S1505). If the above process is complete for all frames (Yes), selection of frames is to end. On the other hand, if the above process is not complete for all frames (No), the frame number is incremented, and the flow returns to step S1502, thus repeating the above process.

The flow chart for explaining the detailed processing sequence of the special region recording process in step S1503 in FIG. 15 is the same as the flow chart in FIG. 26. The header information reading unit 11 reads header information in a JPEG2000 bitstream as a file input from the input unit 10 so as to acquire parameters such as a maximum layer number, maximum resolution number, component number, resolution number corresponding to a predetermined image size, stream recording method, and the like in the file (step S2601). It is then checked based on the information acquired in step S2601 if the stream recording method used to encode the file is the aforementioned LRCP mode (step S2602).

As a result, if the input image data is encoded by LRCP mode (Yes), the flow advances to step S2604. On the other hand, if the input image data is not encoded according to LRCP mode (No), the flow advances to step S2603.

In step S2603, the bitstream arranging unit 12 rearranges the storage order of data in packets in the JPEG2000 bitstream to the order of data encoded by LRCP mode, and corrects the stream recording method in the header information to LRCP mode. Upon completion of this process, the flow advances to step S2604.

In step S2604, the designation unit 15 designates the data length d_length of data to be recorded on the first recording region 21 that allows high-speed access (the inner peripheral special region on the optical disk shown in FIG. 5) on the recording medium 2. In this embodiment, this data length d_length is a fixed data length corresponding to data having a predetermined size. The first recording unit 13 records a part with the length d_length from the head of the bitstream of that file on the first recording region 21 (special region) using the UDF function (step S2605). Subsequently, the second recording unit 14 records data after the length d_length from the head of the bitstream of that file on the second recording region 22 (general region) (step S2606).

That is, the present invention is characterized by further comprising a second recording unit 114 for recording a bitstream other than a predetermined bitstream, which is recorded on the recording region (first recording region), of moving image data on a second recording region 202 on the recording medium 200.

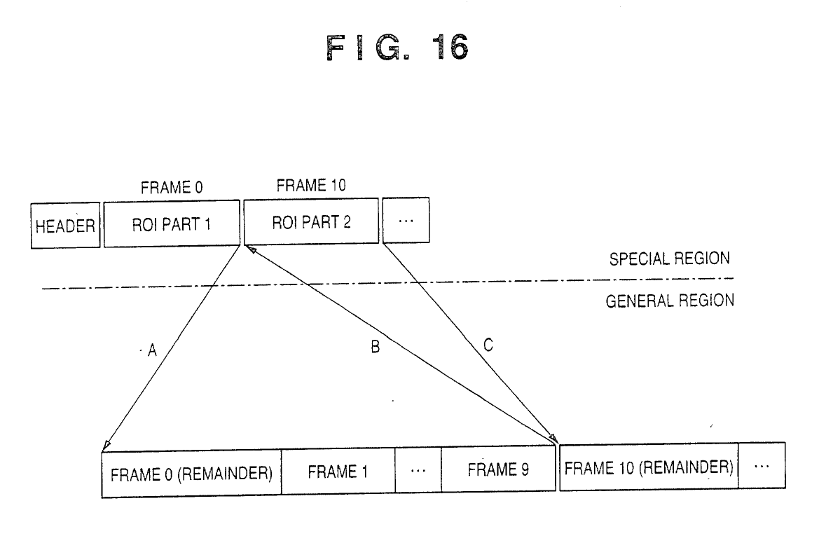

FIG. 16 is a view for explaining an example of the recording positions of a Motion JPEG2000 file on a device in the 13th embodiment.

As shown in FIG. 16, encoded data from a header to an ROI part of frame 0 (first frame) are recorded on the special region (first recording region 201), and the remaining encoded data of that frame is recorded on the general region (second recording region 202). Encoded data from frame 1 (second frame) to frame 9 (10th frame) are recorded on the general region. Encoded data of an ROI part of frame 10 (11th frame) is recorded on the special region as in frame 0, and the remaining encoded data of frame 10 is recorded on the general region.

In this embodiment, data recorded on the special region correspond to ROI parts of frames selected from original moving image data. As for a method of accessing ROI parts of frames recorded on the special region of moving image data written on the optical disk according to the aforementioned sequence at high speed, the sequence that has been explained using FIG. 7 in the ninth embodiment is applied to ROI parts of the selected frames. When recorded data are read out by applying the process in the sequence shown in the flow chart in FIG. 7, no seek upon accessing the disk occurs, or the seek time can be short if it has occurred.

Also, as for the processing sequence for reading out all moving image data divisionally recorded on the two recording regions of the recording medium 200 and decoding the readout data to obtain an original moving image, the sequence shown in the flow chart of FIG. 8 in the ninth embodiment can be applied to all frames.

In this embodiment, data to be recorded on the special region has a fixed length. Alternatively, header information may be read to calculate the number of packets to be recorded on the special region, and the data length of data to be recorded on the special region may be determined. In this manner, all data required to decode ROI data from the MSB side can be recorded on the special region. When encoded data does not have any layer structure, the header in each packet may be read and written out while generating a layer structure. In such case, since neither decoding nor encoding are required, and encoded data can be directly manipulated, the image quality is free from any deterioration.

<14th Embodiment>

In this embodiment, a sequence for designating a predetermined region of moving image data as an ROI, and compression-encoding the moving image data by Motion JPEG2000 will be explained.

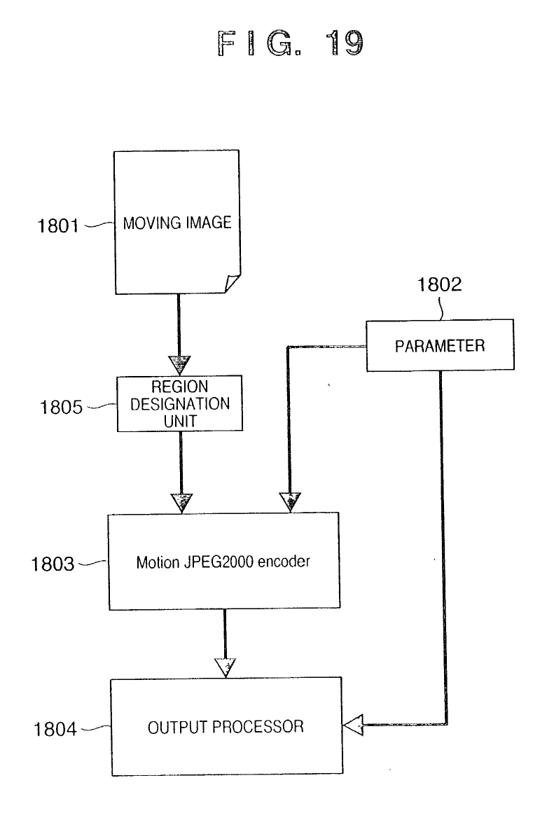

FIG. 19 is a block diagram for explaining the arrangement of an information recording apparatus, and the flows of various data according to the 14th embodiment. A region designation unit 1805 designates an ROI in a moving image 1801. The moving image 1801 designated with the ROI is input to a Motion JPEG2000 encoder 1803. The Motion JPEG2000 encoder 1803 encodes the input moving image data. In this case, the moving image data is encoded on the basis of the contents of control parameters 1802. These parameters are recorded in the moving image data as header information.

The parameters 1802 include a maximum value of Resolution as resolution scalability, a maximum value of Layer as S/N ratio scalability, Component indicating the number of dimensions of a color space, and the like upon encoding image data. Note that the number of components indicates the number of color components of the input moving image 1801. On the other hand, layer segmentation is set to include at least two layers, i.e., a layer which contains up to bitplanes of only a shift-up part of ROI data designated by the region designation unit 1805 from the MSB side, and a layer of other data.

The Motion JPEG2000 encoder 1803 sequentially outputs JPEG2000 bitstreams complying with LRCP mode to an output processor 1804. The output processor 1804 divisionally records the bitstreams input from the Motion JPEG2000 encoder 1803 on special and general regions with different access speeds on a recording medium having the same format as in the fifth embodiment, using the parameters 1802.

That is, the present invention is characterized by further comprising image region designation means (region designation unit 1805) for designating a predetermined image region of each frame of input moving image data, compression encoding means (Motion JPEG2000 encoder 1803) for compression-encoding each frame of the input moving image data by Motion JPEG2000, and a parameter input unit for inputting predetermined parameter 1802 required upon compression-encoding by Motion JPEG2000.

Note that the flow chart for explaining the processing sequence in the output processor 1804 according to the 14th embodiment is the same as that shown in FIG. 10 explained in the sixth embodiment. However, in this embodiment, data that simultaneously meets the following two recording conditions is recorded on the special region that allows high-speed access (step S1001):

(1) less than 4 kB from the head of a bitstream; and

(2) a bitplane required to decode an ROI part.

It is checked if the above two recording conditions are met (step S1002). As a result, if the two conditions are met (Yes), the bitstream is recorded on the special region (step S1003). On the other hand, if the two conditions are not met (No), the bitstream is recorded on the general region (step S1004). Note that the Motion JPEG2000 encoder may output a control signal upon completion of encoding of each packet, and may pass it to the output processor 1804. In this case, a region to be stored can be designated for each packet. In this embodiment, control for determining the end of data required to decode an ROI from the MSB side can be made based on the number of packets.

In the 13th and 14th embodiments described above, of moving image data input to the information recording apparatus, data for only important bitplanes from the MSB side of a selected bitplane are recorded on the inner peripheral special region (first recording region 201) that allows high-speed access of the recording medium (optical disk), and other image data are recorded on the outer peripheral general region (second recording region 202). Therefore, only important images can be displayed from moving image data written on the recording medium quicker than the conventional apparatus.

<15th Embodiment>

An embodiment in which ROI data as an important image region of a frame selected from input moving image data is recorded not on an inner peripheral special region that allows high-speed access, but on an outer peripheral general region will be explained below.

This embodiment uses an information recording apparatus 100 with the arrangement shown in the block diagram of FIG. 29 as in the 13th embodiment described above. The information recording apparatus 100 of this embodiment also records image data, which is compression-encoded by JPEG2000 complying with ISO/IEC-15444, on a detachable recording medium 200.

Assume that access speeds to two recording regions of the recording medium 200 used in this embodiment are also different, and the access speed to a first recording region 201 for recording ROI data of image data is lower than that to a second recording region 202.

That is, the present invention is directed to an information recording apparatus 100 for recording moving image data, which is compression-encoded by Motion JPEG2000, on a recording medium 200 having different access speeds depending on recording positions, characterized by comprising an input unit 110 for inputting moving image data, which is compression-encoded by Motion JPEG2000, and in which image data of a predetermined image region is allocated on the most significant bit (MSB) side in image data of each frame that forms the moving image data, a frame selection unit 116 for selecting a predetermined frame from the input moving image data, a designation unit 115 for designating the image data of the predetermined image region allocated on the MSB side from a bitstream of the selected frame, and recording means (second recording unit 114) for recording image data other than the designated image data on the MSB side on a recording region that allows high-speed access (second recording region 202) in preference to the image data of the predetermined image region.

Also, the present invention is characterized in that the recording means (second recording unit 114) records a bitstream other than a bitstream with a predetermined length from the head of that of a frame selected from input moving image data on the recording region (second recording region 202).

In this embodiment, the electrical arrangement that implements the operation of the information recording apparatus which records a JPEG2000 bitstream on the recording medium 200 is the same as that shown in FIG. 2.

Furthermore, assume that each frame of moving image data is encoded by Motion JPEG2000 according to LRCP mode shown in FIG. 25. Therefore, data of each frame of moving image data are recorded in the order of Layer, Resolution, Component, and Position.

Moreover, the recording medium 200 used in this embodiment is an optical disk shown in FIG. 5, and an outer peripheral recording region of the optical disk is defined as a general region (first recording region 201) for recording ROI data of frames selected from moving image data. An inner peripheral recording region of the optical disk is defined as a special region (second recording region 202) used to record image data other than the ROI data recorded on the general region. That is, the present invention is characterized in that the recording medium 200 is an optical disk, and the second recording region 202 is assured on the inner peripheral portion of the optical disk. In addition, this embodiment adopts Universal Disk Format as the file system of the optical disk.

The flow chart for explaining the processing sequence upon recording an input JPEG2000 bitstream on the optical disk using the information recording apparatus 100 according to the 15th embodiment is the same as that shown in FIG. 20 explained in the sixth embodiment.

A counter LC used to count frames is reset to zero (step S2001). A frame number FLC of the frame to be selected is compared with the value of the counter LC (step S2002). Note that a selection condition in this embodiment is determined using the frame number, and for example, when 10 frames are input, one frame is selected. That is, when the value of the counter LC reaches 0, 10, 20, . . . , the corresponding frame is selected.

If the selection condition is satisfied in step S2002 (Yes), the flow advances to step S2003. On the other hand, if the selection condition is not satisfied in step S2002 (No), the flow advances to step S2004. Step S2003 corresponds to a recording process on the general region (first recording region 201) and step S2004 corresponds to a recording process on the special region (second recording region 202). In this case, the write method of encoded data of the frame of interest is the same as that in the above embodiment.

Upon completion of the process in step S2003 or S2004, it is checked if the above process is complete for all input frames (step S2005) If the above process is complete for all frames (Yes), selection of frames is to end. On the other hand, if the above process is not complete for all frames (No), the frame number is incremented, and the flow returns to step S2002, thus repeating the above process.

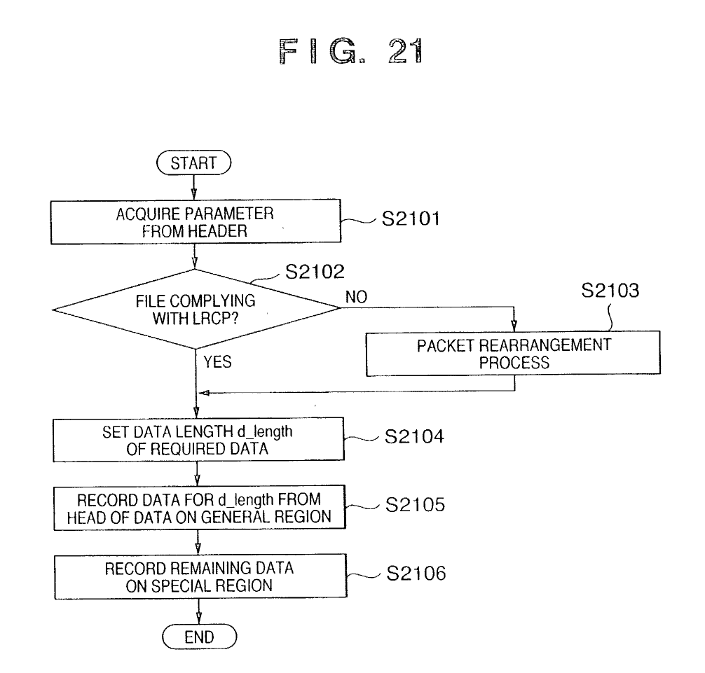

FIG. 21 is a flow chart for explaining the detailed processing sequence of a general region recording process in step S2003 shown in FIG. 20. The header information reading unit 111 reads header information in a JPEG2000 bitstream as a file input from the input unit 110 so as to acquire parameters such as a maximum layer number, maximum resolution number, component number, resolution number corresponding to a predetermined image size, stream recording method, and the like (step S2101). It is then checked based on the information acquired in step S2101 if the stream recording method used to encode each frame of the file is the aforementioned LRCP mode (step S2102).

As a result, if the frame of interest is encoded by LRCP mode (Yes), the flow advances to step S2104. On the other hand, if the frame of interest is not encoded according to LRCP mode (No), the flow advances to step S2103.

In step S2103, the bitstream arranging unit 112 rearranges the storage order of data in packets in the JPEG2000 bitstream to the order of data encoded by LRCP mode, and corrects the stream recording method in the header information to LRCP mode. Upon completion of this process, the flow advances to step S2104.

In step S2104, the data length d_length of data to be recorded on the first recording region 201 (the outer peripheral general region on the optical disk shown in FIG. 5) on the recording medium 200 is checked. In this embodiment, this data length d_length is a fixed data length corresponding to ROI data having a predetermined size. The first recording unit 113 records a part with the length d_length from the head of the bitstream of that file on the first recording region 201 (general region) using the UDF function (step S2105). Subsequently, the second recording unit 114 records data after the length d_length from the head of the bitstream of that file on the second recording region 202 (special region) that allows high-speed access (step S2106).

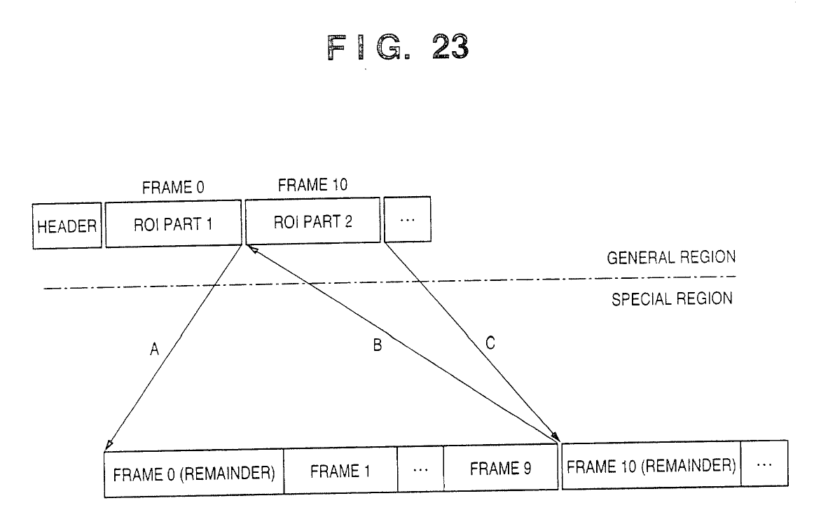

FIG. 23 is a view for explaining an example of the recording positions of a Motion JPEG2000 file on a device in the 15th embodiment. As shown in FIG. 23, encoded data from a header to an ROI corresponding part of frame 0 (first frame) are recorded on the general region (first recording region 201), and the remaining encoded data of that frame is recorded on the special region (second recording region 202). Encoded data from frame 1 (second frame) to frame 9 (10th frame) are recorded on the special region. Encoded data up to an ROI corresponding part of frame 10 (11th frame) is recorded on the general region as in frame 0, and the remaining encoded data of frame 10 is recorded on the special region.

As for a method of accessing ROI data of frames recorded on the general region of moving image data written on the optical disk according to the aforementioned sequence, the sequence that has been explained using FIG. 7 in the above embodiment is applied to the general region where the ROI data of the selected frames are recorded. Since the general region records frame data for several bitplanes, these data are read out together and are passed to a Motion JPEG2000 decoder, thus playing back moving image data of only the selected frames. When recorded data are read out by applying the process in the sequence shown in the flow chart of FIG. 7, moving images formed of only ROI parts can be played back.

Also, as for the processing sequence for reading out all moving image data divisionally recorded on the two recording regions of the recording medium 200 and decoding the readout data to obtain an original moving image, the sequence shown in the flow chart of FIG. 8 in the above embodiment can be applied to all frames.

In this embodiment, data to be recorded on the special region has a fixed length. Alternatively, header information may be read to acquire the resolution number and layer number of the required resolution and required S/N ratio, and the data length of data to be recorded on the general region may be determined.

<16th Embodiment>

In the 15th embodiment, the recording method of a Motion JPEG2000 file when the already encoded Motion JPEG2000 file is present has been explained. In this embodiment, a processing sequence for obtaining a Motion JPEG2000 file by encoding a moving image will be explained.

The block diagram for explaining the arrangement of an information recording apparatus, and the flows of various data according to the 16th embodiment is the same as that shown in FIG. 19. That is, a region designation unit 1805 designates an ROI in a moving image 1801. The moving image 1801 designated with the ROI is input to a Motion JPEG2000 encoder 1803. The Motion JPEG2000 encoder 1803 encodes the input moving image data. In this case, the moving image data is encoded on the basis of the contents of control parameters 1802. These parameters are recorded in the moving image data as header information.

The Motion JPEG2000 encoder 1803 sequentially outputs JPEG2000 bitstreams complying with LRCP mode to an output processor 1804. The output processor 1804 divisionally records the bitstreams input from the Motion JPEG2000 encoder 1803 on special and general regions with different access speeds on a recording medium having the same format as in the seventh embodiment, using the parameters 1802.

The flow chart used to explain the processing sequence in the output processor 1804 of the 16th embodiment is the same as the flow chart of FIG. 12. Using header information of moving image data, which is compression-encoded by Motion JPEG2000, recording conditions of data to be recorded on the outer peripheral general region of an optical disk are set (step S1201). For example, in this embodiment, data that simultaneously meets the following two recording conditions is recorded on the general region:

(1) less than 4 kB from the head of a bitstream; and

(2) a bitplane required to decode an ROI part.

It is checked if the above two recording conditions are met (step S1202). As a result, if the two conditions are met (Yes), the bitstream is recorded on the general region (step S1203). On the other hand, if the two conditions are not met (No), the bitstream is recorded on the special region (step S1204).

In the 15th and 16th embodiments described above, of moving image data input to the information recording apparatus 100, image data required to decode a ROI part of the selected frame is recorded on the outer peripheral general region (first recording region 201) of the recording medium (optical disk), and the remaining image data is recorded on the inner peripheral special region (second recording region 202) that allows high-speed access. Therefore, the entire recorded moving image data can be played back quicker than the conventional apparatus.

Furthermore, the present invention has the following advantages over the problems of the prior arts.

The present invention can solve the problem of Japanese Patent Laid-Open No. 03-053381 “Image Information High-speed Search Method”, since data of a predetermined part of variable-length encoded data is recorded on the special region while maintaining full compatibility with the standardized JPEG2000 format. Also, even when JPEG2000 data is broken at an arbitrary position from the head of data, an image can be played back using only that data. Hence, whether or not data to be recorded on the special region is complete need not be checked.

As for the problem of Japanese Patent Laid-Open No. 07-123346 “Image Recording/Reproduction Method and Apparatus”, the present invention can prevent data from being repetitively recorded on a region that allows high-speed access, and another region, and can improve the use efficiency of the recording medium.

Furthermore, as for the problem of Japanese Patent Laid-Open No. 08-077325 “Still Image Data Recording Apparatus”, the present invention can obtain the same effect not only for fixed-length encoded image data but also for variable-length encoded data.

As described above, according to the present invention, of image data to be recorded on a recording medium, image data that requires high-speed access upon reading out data is recorded on a region that allows high-speed access of the recording medium, thus shortening the access time to recorded data.

<17th Embodiment>

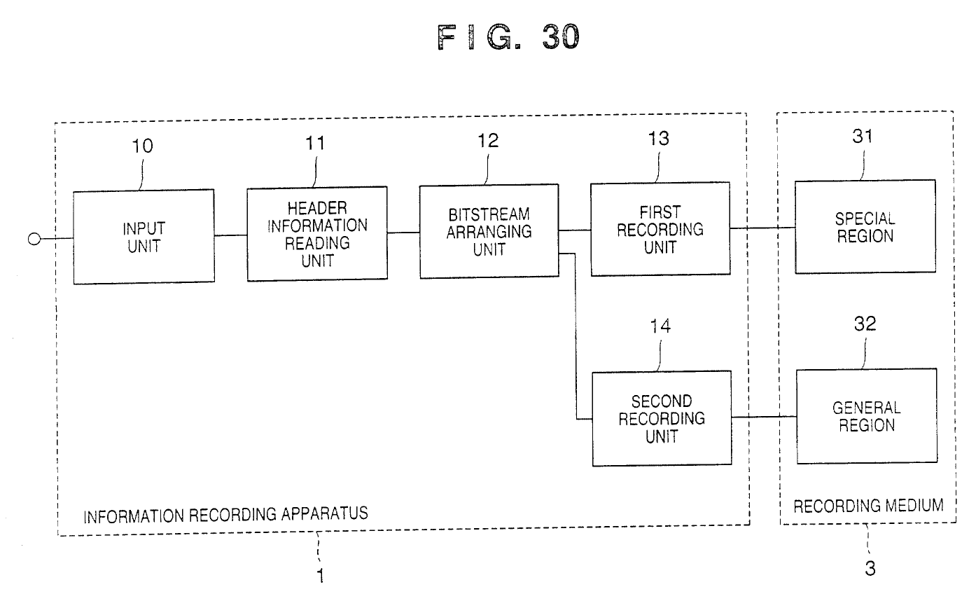

FIG. 30 is a block diagram for explaining the arrangement of an information recording apparatus 1 according to the 17th embodiment of the present invention. The information recording apparatus 1 of this embodiment records image data, which is compression-encoded by JPEG2000 complying with ISO/IEC-15444, on a recording region of a detachable recording medium 3. Note that a bitstream of image data, which is compression-encoded by JPEG2000, will be referred to as a JPEG2000 bitstream hereinafter. The recording region of the recording medium 3 is divided into a special region 31 for recording a predetermined component of image data, and a general region 32 for recording image data other than the predetermined component, as shown in FIG. 30.

The information recording apparatus 1 comprises an input unit 10 for inputting a JPEG2000 bitstream, a header information reading unit 11 for reading header information from the input JPEG2000 bitstream, a bitstream arranging unit 12 for rearranging the JPEG2000 bitstream to a predetermined bitstream on the basis of the read header information, a first recording unit 13 for recording a predetermined component of the JPEG2000 bitstream on the special region 31 of the recording medium 3, and a second recording unit 14 for recording the JPEG2000 bitstream, other than the predetermined component recorded on the special region 31, on the general region 32.

That is, the present invention is directed to an information recording apparatus 1 for recording a still image compression-encoded by JPEG2000 on a recording medium 3, a recording region of which is divided into a first recording region (special region 31) for recording a predetermined image component of a still image, and a second recording region (general region 32) for recording the remaining image components of the still image, characterized by comprising an input unit 10 for inputting a still image which is compression-encoded by JPEG2000, and consists of a plurality of bitplanes, a first recording unit 13 for recording an image component formed by a predetermined number of bitplanes of the input still image on the first recording region (special region 31), and a second recording unit 14 for recording image components other than the image component recorded on the first recording region (special region 31) on the second recording region (general region 32).

Also, the present invention is characterized by further comprising a header information reading unit 11 for reading header information of the input still image, and a bitstream arranging unit 12 for rearranging the bitstream of the input still image to a predetermined bitstream on the basis of the read header information.

The schematic diagram for explaining the electrical arrangement that implements the operation of the information recording apparatus 1 (FIG. 30) which records a JPEG2000 bitstream on the recording medium 3 is the same as FIG. 2 explained in the first embodiment. Referring to FIG. 2, a CPU 101 is an arithmetic device for controlling the operation of the overall information recording apparatus 1. A secondary storage unit 103 is a hard disk that stores a computer program and the like. A primary storage unit 102 is a memory used to load and store the computer program stored in the secondary storage unit 103 when that program is executed by the CPU 101. In general, the capacity of the primary storage unit 102 is smaller than that of the secondary storage unit 103, and a computer program, data, and the like that cannot be stored in the primary storage unit 102 are stored in the secondary storage unit 103. Also, data and the like, which must be stored for a long period of time, are stored in the secondary storage unit 103.

An input device 104 comprises a mouse, keyboard, and the like, and is used to send an interrupt signal upon execution of the computer program. An output device 105 comprises a monitor, printer, and the like. Using the electrical arrangement shown in FIG. 2, the processes in the bitstream arranging unit 12, first recording unit 13, and second recording unit 14 of the information recording apparatus 1 shown in FIG. 30 are implemented. Furthermore, when the input unit 10 shown in FIG. 30 is connected to the electrical arrangement in FIG. 2, a JPEG2000 bitstream can be input.

In this embodiment, since image data is encoded by LRCP mode, data of a bitstream are recorded in the order of Layer, Resolution, Component, and Position. In the layer structure, a plurality of bitplanes which form each color component are arranged in turn from information of a bitplane on the most significant bit (MSB) side.

As shown in FIG. 4 described in the first embodiment, an image with the lowest resolution has resolution number 0, and the width and height of an image are doubled every time the resolution number is incremented by 1. For example, an image of resolution number 3 (Resolution 3) in FIG. 4 has a width and height twice those of an image of resolution number 2 (Resolution 2).

In each resolution, data are arranged in ascending order of layer number, as shown in FIG. 25. The layer number corresponds to the S/N ratio of an image to be decoded to an original image, and the S/N ratio lowers with decreasing layer number.

Assume that the maximum values of the resolution number, layer number, and component number in image data encoded by JPEG2000 (JPEG2000 bitstream) are set in advance by an encoder in this embodiment. These parameters are encoded as header information, and an original image is encoded according to those parameters, thus generating a JPEG2000 bitstream of the image.

Note that the component number matches the number of dimensions of a color space of an image. For example, when the color space of an objective image is a three-dimensional YCbCr color space, the component number=3. Furthermore, a packet is one management unit in image data. This embodiment covers image data mainly used in the medical field. Although high-resolution images are frequently used in the medical field, this embodiment covers a 12-bit monochrome image for the sake of simplicity. That is, in the image used in this embodiment, the number of components is 1.

Since each position is formed by one packet, one layer includes packets as many as (the number of positions)×(the number of components)×(the number of resolutions).

Assume that the recording medium used in this embodiment is an optical disk. As shown in FIG. 5, in general, the optical disk can access data recorded on an inner peripheral recording region faster than data recorded on an outer peripheral recording region. In this embodiment, the inner peripheral recording region is defined as “special region” for recording important data. Since the access time to the outer peripheral recording region becomes longer than that to the inner peripheral recording region, it is defined as “general region” for recording data other than data recorded on the special region.

That is, the present invention is characterized in that the first recording region (special region) is assured on a portion that allows high-speed access of the recording medium. Also, the present invention is characterized in that the recording medium is an optical disk, and the first recording region (special region) is assured on the inner peripheral portion of the optical disk.

Also, this embodiment adopts Universal Disk Format (UDF) as the file system of the optical disk. In the UDF, one file can be segmented and written at a plurality of positions. The file to be segmented and recorded is recorded using UDF entries as many as the number of segments. More specifically, the present invention is characterized in that the file system which manages still images recorded on the recording medium is Universal Disk Format.

The flow chart used to explain the processing sequence for recording a JPEG2000 bitstream of an encoded 12-bit monochrome image on the optical disk using the information recording apparatus 1 of this embodiment is the same as that shown in FIG. 26.

The header information reading unit 11 reads header information in a JPEG2000 bitstream as a file input from the input unit 10 so as to acquire parameters such as a maximum layer number, maximum resolution number, component number, resolution number corresponding to a predetermined image size, bitstream arranging method, and the like in the file (step S2601). It is then checked based on the acquired bitstream arranging method if the input file is encoded according to the aforementioned LRCP mode (step S2602). As a result, if the image data is encoded by LRCP mode (Yes), the flow advances to step S2604. On the other hand, if the image data is not encoded according to LRCP mode (No), the flow advances to step S2603.

In step S2603, the bitstream arranging unit 12 rearranges the storage order of data in packets in the JPEG2000 bitstream to the order of data encoded by LRCP mode, and corrects the stream recording method in the header information to LRCP mode. Upon completion of this process, the flow advances to step S2604.

In step S2604, the data length d_length of data to be recorded on the special region 31 on the recording medium (optical disk) is checked. In this embodiment, this data length d_length is a fixed length which corresponds to the number of bytes capable of storing data for 8 bits from the MSB side of bitplane information consisting of a plurality of bitplanes. The first recording unit 13 records a part with the length d_length from the head of the bitstream of that file (i.e., the number of bytes capable of storing data for 8 bits from the MSB side of bitplane information consisting of a plurality of bitplanes) on the special region 31 using the UDF function (step S2605). Subsequently, the second recording unit 14 records remaining data after the length d_length from the head of the bitstream of that file (i.e., the number of bytes capable of storing data for 8 bits from the MSB side of bitplane information consisting of a plurality of bitplanes) on the general region 32 (step S2606).

Therefore, since the JPEG2000 bitstream includes bitstreams obtained by arranging image data consisting of a plurality of bitplanes in turn from the MSB side to a lower bitplane, data for a predetermined bitplane (e.g., 8 bits in this embodiment) from the MSB side of all bitplanes recorded on the optical disk can be accessed at high speed.

That is, the present invention is characterized in that the first recording unit 13 records an image component formed of a plurality of bitplanes required to decode a still image of predetermined image quality on the first recording region (special region 31). Also, the present invention is characterized in that the second recording unit records image components consisting of bitstreams after that of the image component recorded on the first recording region (special region 31) of the bitstream of the input still image on the second recording region (general region 32). Furthermore, the present invention is characterized in that the first recording unit 13 records an image component formed by a bitplane for 8 bits from the most significant bit of a plurality of bitplanes that form the input still image on the first recording region (special region 31).

A method of accessing predetermined data from 12-bit monochrome image data written on the optical disk in the sequence shown in FIG. 26 at high speed will be explained below. The processing sequence for reading out a bitstream written on the special region 31 and decoding an original image within a possible range is as has been described in the first embodiment using the flow chart of FIG. 7.

In this manner, upon displaying a large number of image files, data up to 8 bits can be easily decoded and displayed. Also, no seek upon accessing the disk occurs, or the seek time can be short if it has occurred.

Furthermore, since image data is compression-encoded by JPEG2000, even when data recorded on the special region or the like is not full 8-bit data, an original image can be decoded within a given range using the available data. As a result, using an image display device (not shown), an outline of large-size image data recorded on the recording medium can be quickly browsed.

The processing sequence for reading out all image data, which are divisionally recorded on the recording medium, and decoding the readout image data to obtain an original image is as has been explained in the first embodiment using FIG. 8.

Thus, an original image is decoded from a bitstream for 12-bit bitplanes recorded on the recording medium, and can be displayed on a display device or the like that can display image data which is used in the medical field and consists of 12-bit bitplanes.

In this embodiment, data to be recorded on the special region has a fixed length which corresponds to the number of bytes capable of storing data for 8 bits from the MSB side of bitplane information consisting of a plurality of bitplanes, which are defined in advance. Alternatively, the header information may be read to calculate the number of packets to be recorded on the special region, and the data length of data to be recorded on the special region may be determined. In this manner, all image data up to 8 bits from the MSB side can be recorded on the special region of the recording medium.

In this embodiment, monochrome image data compression-encoded by JPEG2000 has been exemplified. Also, the present invention can be applied to color image data consisting of a plurality of color components by executing the same process for each color component. Furthermore, this embodiment has exemplified a case wherein the density is expressed by 12 bits. However, the same applies to cases other than that number of bits (e.g., 16 bits).

Furthermore, when encoded image data does not have any layer structure, the header in each packet may be read out to generate a layer structure. In such case, since neither decoding nor encoding are required, and encoded data can be directly manipulated, the image quality is free from any deterioration.

Note that in place of always recording image data other than the bitplanes on the MSB side, which are recorded on the special region, on the general region, bitplanes on the MSB side may be preferentially recorded on the special region, and the remaining image data may also be recorded on the special region. That is, the present invention may also be directed to an information recording apparatus 1 for recording image data, which is compression-encoded by JPEG2000, on a recording medium 3 having different access speeds depending on recording position, characterized by comprising an input unit 10 for inputting image data compression-encoded by JPEG2000, and recording means (first recording unit 13) for recording component data for a predetermined number of bitplanes on the MSB side of the input image data on a recording region (first recording region 31) that allows high-speed access in preference to remaining component data. The same applies to the subsequent embodiments.

<18th Embodiment>

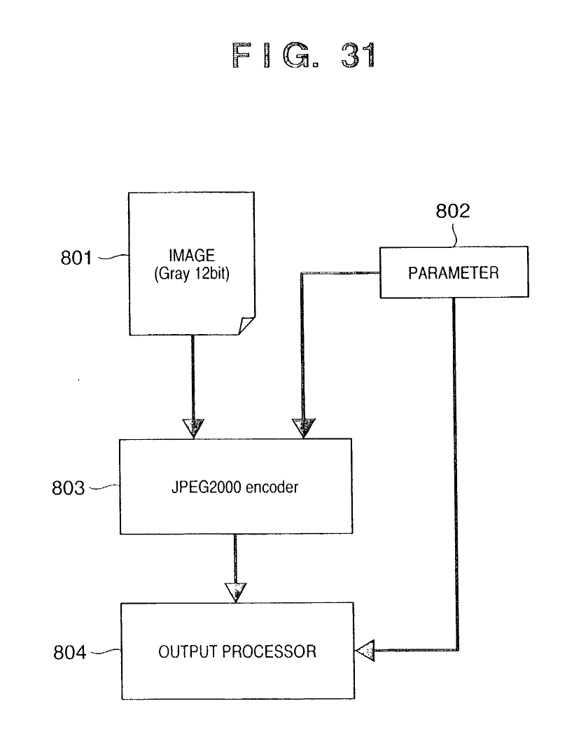

This embodiment will explain a case wherein the arrangement of the information recording apparatus 1 explained in the 17th embodiment includes an encoder, and data to be input is image data before compression encoding. FIG. 31 is a block diagram for explaining the arrangement of an information recording apparatus, and the flows of data according to the 18th embodiment. Twelve-bit monochrome image data 801 is input to a JPEG2000 encoder 803. The JPEG2000 encoder 803 encodes the input monochrome image data 801 by LRCP mode described above. In this case, control parameters 802 are also input to the JPEG2000 encoder 803, which encodes the monochrome image data 801 on the basis of the contents of the parameters.

The parameters 802 include a maximum value of Resolution as resolution scalability, a maximum value of Layer as S/N ratio scalability, Component indicating the number of dimensions of a color space, and the like upon encoding the monochrome image data 801. Since the image used in this embodiment is a monochrome image, the number of components is 1. Also, layer segmentation is set to include at least two layers, i.e., a layer up to 8 bits from the MSB side, and a layer of subsequent data.

The JPEG2000 encoder 803 sequentially outputs a bitstream encoded by JPEG2000 complying with LRCP mode to an output processor 804. The output processor 804 divisionally records the bitstream input from the JPEG2000 encoder 803 on special and general regions on an optical disk shown in FIG. 5, using the parameters 802.

The functions of the JPEG encoder 803 and output processor 804 can be implemented by the apparatus shown in FIG. 2, as in the 17th embodiment. In this case, the parameters 802 can be input using, e.g., an input device 104.

The flow chart for explaining the processing sequence in the output processor 804 is the same as that shown in FIG. 10 explained in the second embodiment. Using the parameters 802, recording conditions of data to be recorded on the inner peripheral side (special region) of the optical disk are set (step S1001). For example, in this embodiment, a bitstream that meets the following two conditions at the same time is recorded on the special region:

(1) data of less than 4 kB from the head of a bitstream; and

(2) bitplane data up to 8 bits from the MSB side.

It is checked if the above two recording conditions are met (step S1002). As a result, if the two conditions are met (Yes), the bitstream is recorded on the special region (step S1003). On the other hand, if the two conditions are not met (No), the bitstream is recorded on the general region (step S1004).

Note that the JPEG2000 encoder 803 may output each packet as a control signal upon completion of encoding. In this case, a region to be stored can be designated for each packet. For example, in this embodiment, control for outputting encoded data for 8 bits from the MSB side can be made based on the number of packets.

<19th Embodiment>

In this embodiment, a method of recording a bitstream of a moving image compression-encoded by Motion JPEG2000 on a recording medium will be explained. An information recording apparatus to be implemented by this embodiment uses the same apparatus as the information recording apparatus 1 in the 17th embodiment described above.

That is, the present invention is directed to an information recording apparatus for recording a moving image compression-encoded by Motion JPEG2000 on a recording medium 3, a recording region of which is divided into a first recording region (special region 31) for recording a predetermined image component of a moving image, and a second recording region (general region 32) for recording the remaining image components of the moving image, characterized by comprising an input unit 10 for inputting a moving image which is compression-encoded by Motion JPEG2000, and consists of a plurality of frame images, a first recording unit 13 for recording data for a predetermined number of bits from the MSB side of a plurality of bitplanes which form a predetermined image component in a predetermined frame image that forms the input moving image on the first recording region (special region 31), and a second recording unit 14 for recording the remaining image components of the moving image other than the image component recorded on the first recording region (special region 31) on the second recording region (general region 32).

Also, the present invention is characterized by further comprising a header information reading unit 11 for reading header information of the input moving image, and a bitstream arranging unit 12 for rearranging the bitstream of the input moving image to a predetermined bitstream on the basis of the read header information.

Note that a Motion JPEG2000 file is as has been explained in the fifth embodiment using FIG. 13. That is, as shown in FIG. 13, bitstreams which are compression-encoded by JPEG2000 for respective frames are recorded in the playback order as one file.

In FIG. 13, a header stores information required to manage this file. Each frame is a bitstream which is obtained by compression-encoding only image data of that frame by JPEG2000, and will be referred to as a JPEG2000 bitstream as in the above embodiment. Note that the JPEG2000 bitstream is encoded by LRCP mode as in the above embodiment.

Also, the recording medium used in this embodiment is an optical disk having two recording regions shown in FIG. 5, and the file format of the optical disk is UDF as in the above embodiment. Furthermore, image data used in this embodiment is a 16-bit monochrome image. That is, the present invention is characterized in that the file system which manages image components of a moving image recorded on the recording medium is Universal Disk Format.

The processing sequence for recording data for 8 bits of the 16-bit monochrome image data on the special region of the optical disk, and recording remaining data on the general region is the same as that in the flow chart shown in FIG. 15.

That is, a counter LC used to count frames is reset to zero (step S1501). A frame number (frame FLC) of the frame to be selected is compared with the value of the counter LC (step S1502). Note that a selection condition in this embodiment is determined using the frame number, and is met every 10 frames when the frame number reaches, e.g., 1, 11, 21, . . . .

As a result, if the selection condition is satisfied in step S1502 (Yes), the flow advances to step S1503. On the other hand, if the selection condition is not satisfied in step S1502 (No), the flow advances to step S1504.

Step S1503 corresponds to a recording process on the special region and step S1504 corresponds to a recording process on the general region. In this case, the recording method of a bitstream of each frame is the same as the method explained in the ninth embodiment using FIG. 26.

Upon completion of the process in step S1503 or S1504, it is checked if the above process is complete for all input frames (step S1505). As a result, if the above process is complete for all frames (Yes), recording of all moving image data is to end. On the other hand, if the above process is not complete for all frames (No), the frame number is incremented, and the flow returns to step S1502, thus repeating the above process.

As described above, when moving image data consisting of a plurality of bitplanes is written on the special region in turn from the MSB side using the layer structure, only designated bitplanes (8 bits) of all the bitplanes (16 bits) can be written on the special region, and the remaining bitplanes can be written on the general region. The schematic view used to explain the recorded data of the Motion JPEG2000 file according to this embodiment is as has been explained using FIG. 17. Based on header information, encoded data up to a designated bitplane (8 bits) in frame 0 is recorded on the special region. In FIG. 17, thumbnail 1 corresponds to this portion. The remaining encoded data of frame 0 is recorded on the general region (a portion between A and B in FIG. 17 corresponds to this process).

Encoded data from frame 1 to frame 9 are recorded on the general region. After that, bitplane information up to 8 bits from the MSB side of frame 10 is recorded on the special region as in frame 9 (portion from B to C in FIG. 17). The remaining encoded data of frame 10 is recorded on the general region.

After the Motion JPEG2000 file is recorded on the recording medium in this manner, only important bitplanes can be accessed at high speed by reading out only a part recorded on the special region of UDF entries. For example, a moving image of only 8 bits of a monochrome moving image consisting of 16 bits can be played back.

That is, the present invention is characterized in that the first recording unit 13 records an image component formed by a plurality of bit planes required to decode a frame image with predetermined image quality on the first recording region (special region 31). Also, the present invention is characterized in that the second recording unit 14 records an image component consisting of a bitstream after that of the image component recorded on the first recording region (special region 31) of the bitstream of each frame image of the input moving image on the second recording region (general region 32). Furthermore, the present invention is characterized in that a moving image recorded on the first recording region (special region 31) is formed by image components of portions each consisting of bitplanes for 8 bits from a bitplane of the most significant bit (MSB) of a plurality of bitplanes of each of frame images that form the input moving image. Moreover, the present invention is characterized in that the first recording unit 13 records an image component formed by a plurality of bit planes required to decode a frame image with predetermined image quality on the first recording region (special region 31) for every predetermined number of frame images.

A read process of the aforementioned data will be explained below. The special region records frame data of important bitplanes for 8 bits. When these frame data are read out together and are passed to a Motion JPEG file decoder, 8-bit data of frames selected by the process explained using FIG. 17 can be read out and played back as a moving image.

For example, in this embodiment, data to be recorded on the special region corresponds to image data for a plurality of bits from the MSB side of encoded data, and corresponds to the number of bitplanes that can be displayed on a display device used in a normal computer system. By recording such bitplane information on the special region together, and reading out 8-bit data, it becomes easy to decode and display data up to 8 bits upon displaying a large number of image files, and nearly no seek time upon accessing the optical disk is generated.

Furthermore, in case of JPEG2000, even when data is broken in the middle of encoded data, a decoding process can be done using that encoded data. In this way, by using images for about 8 bits, a plurality of image data can be browsed quickly on a normal image display device.

In this embodiment, the data to be recorded on the special region has a fixed length. Alternatively, the header information-may be read to calculate the number of packets to be stored in the special region, and the data length of data to be recorded on the special region may be determined. In this manner, all encoded data up to 8 bits from the MSB side can be recorded on the special region.

In the aforementioned embodiment, a case has been explained wherein the encoded Motion JPEG2000 file is a monochrome image. Also, the present invention can be applied to a color moving image consisting of a plurality of color components. Furthermore, in this embodiment, an image which is used in the medical field and is defined by 16 bits per color has been explained, but the same process can be done for other numbers of bits. For example, in CT or the like, a plurality of images may be taken, and may be displayed like a moving image using the present invention.

When encoded data does not have any layer structure, the header in each packet may be read and written out while generating a layer structure. In such case, since neither decoding nor encoding are required, and encoded data can be directly manipulated, the image quality is free from any deterioration.

<20th Embodiment>

This embodiment will explain a case wherein the arrangement of the information recording apparatus according to the 19th embodiment includes an encoder. The block diagram for explaining the arrangement of the information recording apparatus including an encoder used in this embodiment is the same as that in FIG. 18. In this embodiment, a moving image 1801 consisting of a plurality of monochrome 16-bit images is input to a Motion JPEG2000 encoder 1803. Note that the Motion JPEG2000 encoder 1803 may be the same as the JPEG2000 encoder which processes a still image in the description of the 18th embodiment.

Upon encoding data by the Motion JPEG2000 encoder 1803, control parameters 1802 are required. The parameters 1802 include a maximum value of Resolution as resolution scalability, a maximum value of Layer as S/N ratio scalability, Component indicating the number of dimensions of a color space, and the like upon encoding. For example, the number of components in this embodiment is 1. Also, layer segmentation is set to include at least two layers, i.e., a layer up to 8 bits from the MSB side, and a layer of other data.

The Motion JPEG2000 encoder 1803 sequentially outputs JPEG2000 bitstreams for respective frames to an output processor 1804 in accordance with LRCP mode. The output processor 1804 divisionally records the bitstreams input from the Motion JPEG2000 encoder 1803 on special and general regions using the parameters 1802.

The process in the output processor 1804 is the same as that in the 18th embodiment described above. That is, in step S1001 (FIG. 10), determination conditions of data to be recorded on the inner peripheral recording region are set using header information of the Motion JPEG2000 bitstream. For example, in this embodiment, a bitstream that simultaneously meets the following two conditions is recorded on the special region:

(1) less than 4 kB from the head of a bitstream; and

(2) encoded data for 8 bits from the MSB side.

The motion JPEG2000 encoder 1803 may output a control signal upon completion of encoding of each packet, and may pass it to the output processor. In this case, a region to be stored can be designated for each packet. For example, in this embodiment, control for determining the end of encoded data for 8 bits from the MSB side can be made based on the number of packets.

Furthermore, when the number of bytes of encoded data of each frame to be recorded on the special region has a fixed length, the encoded data recorded on the special region is rarely delimited at an appropriate position but is often broken in the middle of the stream due to the syntax of the JPEG2000 bitstream. In such case, even when moving image data in only the special region is displayed, these data can be continuously read out without any seek upon accessing the disk.

As described above, since the information recording apparatus of this embodiment records only important bitplane data from the MSB side of moving image data, which is compression-encoded by JPEG2000 and consists of a plurality of bitplanes, on the special region that allows high-speed access in the recording medium, required data can be accessed at high speed.

Data of all bitplanes of an image, which consists of bitplanes of more than 8 bits (e.g., 16-bit bitplanes) like that used in the medical field, cannot be displayed on a normal image display device. Hence, when data for the number of bitplanes (e.g., for 8 bits) that can be displayed by the normal image display device are recorded on a region that allows high-speed access, the normal image display device can display images at high speed without any data conversion process and the like. Furthermore, when large-size data which must be read out from the recording medium is stored on a region that allows high-speed access, the access speed to the full data can be improved. In this manner, the read time upon reading all data recorded on the recording medium can be shortened.

Furthermore, the present invention has the following advantages over the problems of the prior arts. The present invention can solve the problem of Japanese Patent Laid-Open No. 03-053381 “Image Information High-speed Search Method”, since data of a predetermined part of variable-length encoded data is recorded on the special region while maintaining full compatibility with the standardized JPEG2000 format. Also, even when JPEG2000 data is broken at an arbitrary position from the head of data, an image can be played back using only that data. Hence, whether or not data to be recorded on the special region is complete need not be checked.

As for the problem of Japanese Patent Laid-Open No. 07-123346 “Image Recording/Reproduction Method and Apparatus”, the present invention can prevent data from being repetitively recorded on a region that allows high-speed access, and another region, and can improve the use efficiency of the recording medium.

Furthermore, as for the problem of Japanese Patent Laid-Open, No. 08-077325 “Still Image Data Recording Apparatus”, the present invention can obtain the same effect not only for fixed-length encoded image data but also for variable-length encoded data.

As described above, according to the present invention, of image data to be recorded on a recording medium, image data that requires high-speed access upon reading out data is recorded on a region that allows high-speed access of the recording medium, thus shortening the access time to recorded data.

<21st Embodiment>

The block diagram used to explain the arrangement of an information recording apparatus according to the 21st embodiment of the present invention is the same as that in FIG. 30 explained in the 17th embodiment. That is, an information recording apparatus 1 of this embodiment records image data, which is compression-encoded by JPEG2000 complying with ISO/IEC-15444, on a recording region of a detachable recording medium 3. Note that a bitstream of image data, which is compression-encoded by JPEG2000, will be referred to as a JPEG2000 bitstream hereinafter. The recording region of the recording medium 3 is divided into a special region 31 for recording a predetermined component of image data, and a general region 32 for recording image data other than the predetermined component, as shown in FIG. 30.

The information recording apparatus 1 comprises an input unit 10 for inputting a JPEG2000 bitstream, a header information reading unit 11 for reading header information from the input JPEG2000 bitstream, a bitstream arranging unit 12 for rearranging the JPEG2000 bitstream to a predetermined bitstream on the basis of the read header information, a first recording unit 13 for recording a predetermined component of the JPEG2000 bitstream on the special region 31 of the recording medium 3, and a second recording unit 14 for recording the JPEG2000 bitstream, other than the predetermined component recorded on the special region 31, on the general region 32.

That is, the present invention is directed to an information recording apparatus 1 for recording a color image compression-encoded by JPEG2000 on a recording medium 3 having two recording regions with different access speeds, characterized by comprising an input unit 10 for inputting a color image compression-encoded by JPEG2000, a first recording unit 13 for recording data associated with a predetermined component of the input color image on the first recording region (special region 31), and a second recording unit 14 for recording data other than the data associated with the predetermined component of the color image recorded on the first recording region (special region 31) on the second recording region (general region 32).

Also, the present invention is characterized by further comprising a header information reading unit 11 for reading header information of the input color image, and a bitstream arranging unit 12 for rearranging the bitstream of the input color image to a predetermined bitstream on the basis of the read header information.

The schematic diagram for explaining the electrical arrangement that implements the operation of the information recording apparatus 1 (FIG. 30) which records a JPEG2000 bitstream on the recording medium 3 is the same as that shown in FIG. 2. Referring to FIG. 2, a CPU 101 is an arithmetic device for controlling the operation of the overall information recording apparatus 1. A secondary storage unit 103 is a hard disk that stores a computer program and the like. A primary storage unit 102 is a memory used to load and store the computer program stored in the secondary storage unit 103 when that program is executed by the CPU 101. In general, the capacity of the primary storage unit 102 is smaller than that of the secondary storage unit 103, and a computer program, data, and the like that cannot be stored in the primary storage unit 102 are stored in the secondary storage unit 103. Also, data and the like, which must be stored for a long period of time, are stored in the secondary storage unit 103.

An input device 104 comprises a mouse, keyboard, and the like, and is used to send an interrupt signal upon execution of the computer program. An output device 105 comprises a monitor, printer, and the like. Using the electrical arrangement shown in FIG. 2, the processes in the bitstream arranging unit 12, first recording unit 13, and second recording unit 14 of the information recording apparatus 1 shown in FIG. 30 are implemented. Furthermore, when the input unit 10 shown in FIG. 30 is connected to the electrical arrangement in FIG. 2, a JPEG2000 bitstream can be input.

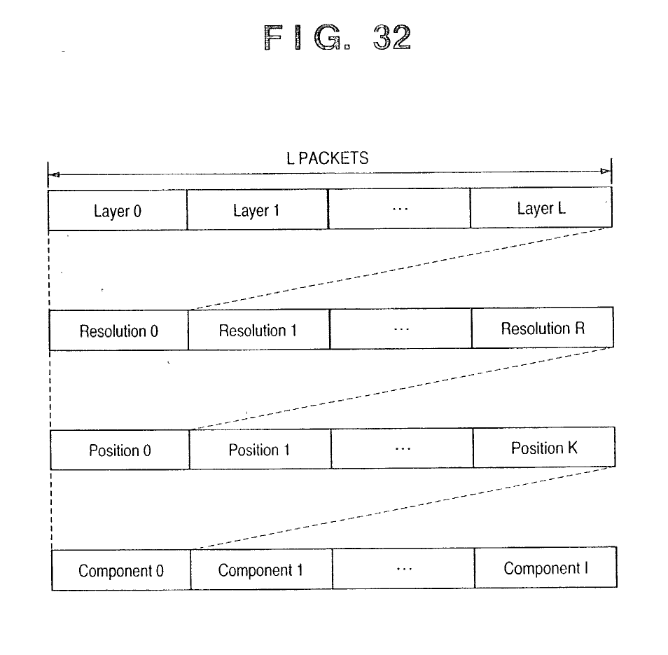

FIG. 32 is a schematic view for explaining the detailed format of image data, which is compression-encoded by JPEG2000 according to Component—Position—Resolution level—Layer progression (to be referred to as “CPRL” hereinafter) mode in the 21st embodiment. In this embodiment, since image data is encoded by CPRL mode, image data are recorded in the order of Component, Position, Resolution, and Layer. That is, the information recording apparatus according to the present invention is characterized in that predetermined datastreams are arranged in the order of Component, Position, Resolution, and Layer.

The schematic view used to explain the relationship between the resolutions (image sizes) and resolution numbers is the same as that shown in FIG. 4. As shown in FIG. 4, an image with the lowest resolution has resolution number 0, and the width and height of an image are doubled every time the resolution number is incremented by 1. For example, an image of resolution number 3 (Resolution 3) in FIG. 4 has a width and height twice those of an image of resolution number 2 (Resolution 2).

In each resolution, data are arranged in ascending order of layer number, as shown in FIG. 25. The layer number corresponds to the S/N ratio of an image to be decoded to an original image, and the S/N ratio lowers with decreasing layer number.

More specifically, the maximum values of the resolution number, layer number, and component number in image data compression-encoded by JPEG2000 are set in advance by an encoder. These maximum values are encoded according to set parameters, and are stored in encoded data.

The number of components matches the number of dimensions of a color space of an image. In this embodiment, when the color space of an objective image is a three-dimensional YCbCr color space, the number of components is 3. Furthermore, a packet is one management unit in image data. Since each layer is formed by one packet, one component includes packets as many as (the number of layers)×(the number of resolutions)×(the number of positions).

The view that shows an example of the recording medium 3 used in this embodiment is the same as that shown in FIG. 5. Note that the recording medium used in this embodiment is an optical disk. In general, since the optical disk can access data recorded on an inner peripheral recording region faster than data recorded on an outer peripheral recording region, the inner peripheral recording region is defined as “special region” for recording special data. On the other hand, since the access time to the outer peripheral recording region becomes longer than that to the inner peripheral region, the outer peripheral recording region is defined as “general region” for recording normal data. That is, the present invention is characterized in that the recording medium 3 is an optical disk, and the first recording region (special region 31) is assured on the inner peripheral portion of the optical disk.

Also, this embodiment adopts Universal Disk Format (UDF) as the file system of the optical disk. In the UDF, one file can be segmented and written at a plurality of positions. The file to be segmented and recorded is recorded using UDF entries as many as the number of segments. More specifically, the present invention is characterized in that the file system which manages color images recorded on the recording medium 3 is Universal Disk Format.

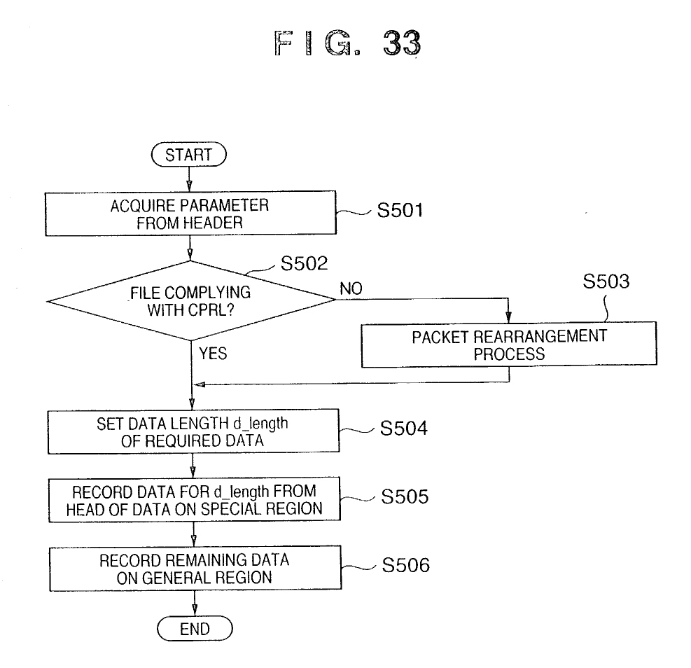

A case will be explained below wherein the YCbCr color space is used as the color space of a color image. In this case, Y, Cb, and Cr component data are respectively allocated in the first, second, and third colors in encoded data. FIG. 33 is a flow chart for explaining the write sequence on the disk when the YCbCr color space is used.

Header information in an encoded color image is read to acquire parameters such as a maximum layer number, a maximum resolution number, the number of components, a resolution number corresponding to a predetermined image size, a stream recording method, and the like in the data (step S501). It is then checked based on the acquired stream recording method if data are arranged according to CPRL described above (step S502). As a result, if the datastreams comply with CPRL mode (Yes), the flow advances to step S504. On the other hand, if the datastreams do not comply with CPRL mode (No), the flow advances to step S503.

In step S503, the storage order of packets in the stream is rearranged according to CPRL mode, and the stream recording method in the header information is also corrected to CPRL mode. Upon completion of this process, the flow advances to step S504.

In step S504, the data length d_length of data to be recorded on the special region 31 is checked. In this embodiment, this data length d_length is a fixed length. Then, a part with the length d_length from the head of the encoded data is written on the special region 31 using the UDF function (step S505). Subsequently, a part after the length d_length from the head of the encoded data is written on the general region 32 (step S506). That is, the information recording apparatus according to the present invention is characterized in that the first recording unit 13 records data associated with a predetermined component of a color image required to decode an image having predetermined image quality on the first recording region (special region 31). Also, the present invention is characterized in that the first recording unit 13 records a bitstream with a predetermined bit length on the first recording region (special region 31).

Therefore, since Y component data is stored as the first color in the color image compression-encoded by JPEG2000, when encoded data for one color from the head of the file is written on the special region 31 using the aforementioned flow, the Y component data can be written on the special region 31 of the recording medium 3. That is, the information recording apparatus according to the present invention is characterized in that the color image is defined by a YCbCr color space, and the predetermined component is a Y component of the color image.

A method of reading out data written on the recording medium 3 in the sequence shown in FIG. 33 will be explained below. The flow chart for explaining the processing sequence for reading out and decoding only the Y component of a color image written on the special region 31 shown in FIG. 5 is the same as that shown in FIG. 7.

More specifically, UDF entries of a file to be read out are acquired (step S701). Only an entry indicating a part of the special region is selected from the UDF entries selected in step S701 (step S702). Then, a color image of the selected part is read and decoded (step S703).

In this embodiment, data to be recorded on the special region 31 corresponds to a color image of a Y component. Then, Y component data are recorded together on the special region 31 by applying the process shown in FIG. 31, and are read out by applying the process in the sequence of the flow chart shown in FIG. 7. In this way, upon reading out Y component data associated with a large number of image files at the same time, no seek upon accessing the disk occurs, or the seek time can be short if it has occurred.

Furthermore, when a color image is compression-encoded by JPEG2000, even when it is broken in the middle of a stream, a decoding process can be done using that encoded data. In this manner, using an image (monochrome image) of only a Y component, a plurality of image data can be quickly browsed using an image display device or the like (not shown).

The flow chart used to explain the processing sequence for reading out and decoding all encoded data divisionally recorded on the recording medium 3 is the same as that shown in FIG. 8.

More specifically, UDF entries of image data to be read out are acquired (step S801). All pieces of information are read out in accordance with the information of the UDF entries (step S802). Furthermore, the readout data are decoded (step S803). In this manner, color images obtained by decoding all color components encoded in the YCbCr color space can be displayed on an image display device or the like (not shown).

In this embodiment, data to be recorded on the special region 31 has a fixed length. Alternatively, header information may be read to acquire the resolution number and layer number of the required resolution and required S/N ratio, and the data length of data to be recorded on the special region 31 may be determined.

In above description of this embodiment, the color image compression-encoded by JPEG2000 is stored in the order of Y, Cb, and Cr components in advance. If a color image is stored not in this order, the same sequence can be applied by replacing the order of color components.

Note that in place of always recording color components other than a predetermined color component of image data, which is recorded on the special region, on the general region, the predetermined color component may be preferentially recorded on the special region, and the remaining color components may also be recorded on the special region. That is, the present invention may also be directed to an information recording apparatus 1 for recording image data, which is compression-encoded by JPEG2000, on a recording medium 3 having different access speeds depending on recording position, characterized by comprising an input unit 10 for inputting image data compression-encoded by JPEG2000, and recording means (first recording unit 13) for recording predetermined color component data in the input image data on a recording region (first recording region 31) that allows high-speed access in preference to the remaining color component data. The same applies to the subsequent embodiments.

<22nd Embodiment>

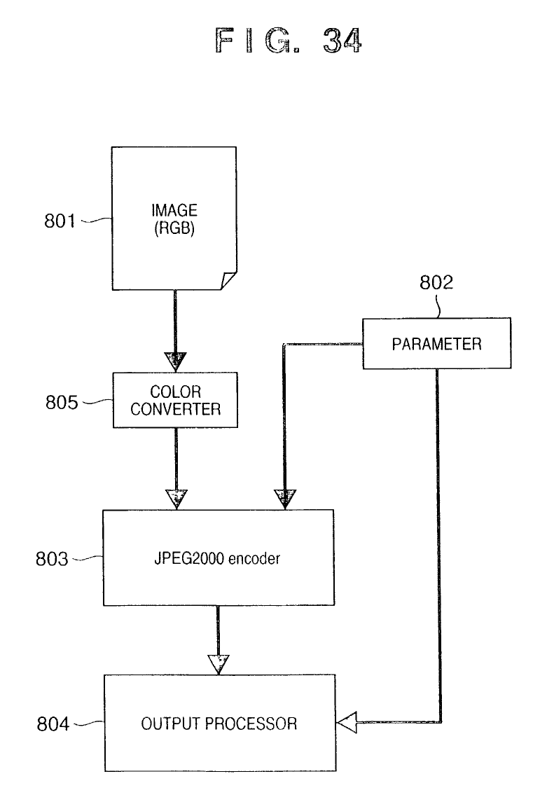

FIG. 34 is a block diagram for explaining the arrangement of an information recording apparatus, and the flows of data according to the 22nd embodiment. An original image 801 defined by an RGB color space is input to a color converter 805, and is converted into a YCrCb color space. The color image defined by the YCrCb color space is input to a JPEG2000 encoder 803. The JPEG2000 encoder 803 encodes image data. In this case, encoding is done based on the contents of control parameters 802. These parameters are recorded in the color image as header information.

The parameters 802 include a maximum value of Resolution as resolution scalability, a maximum value of Layer as S/N ratio scalability, Component indicating the number of dimensions of a color space, and the like upon encoding a color image. Note that the number of components is 3.

The JPEG2000 encoder 803 sequentially outputs a bitstream encoded by JPEG2000 complying with CPRL mode to an output processor 804. The output processor 804 divisionally records the bitstream input from the JPEG2000 encoder 803 on a special region 31 and general region 32 using the parameters 802.

Note that the flow chart used to explain the processing sequence in the output processor 804 is the same as that shown in FIG. 10. Determination conditions of data to be recorded on the inner peripheral region of the optical disk are set using header information of the color image compression-encoded by JPEG2000 (step S1001). For example, in this embodiment, a bitstream that simultaneously meets the following two conditions is recorded on the special region 31:

(1) less than 4 kB from the head of a bitstream; and

(2) encoded data of a Y component.

It is checked if the above two conditions are met (step S1002). As a result, if the two conditions are met (Yes), the bitstream is recorded on the special region 31 (step S1003). On the other hand, if the two conditions are not met (No), the remaining bitstream is recorded on the general region 32 (step S1004).

As described above, the sequence for storing the Y component of the YCbCr color space on the inner peripheral region that allows high-speed access of the optical disk has been explained in this embodiment. Likewise, the present invention can be applied to other color spaces (e.g., a G component in case of an RGB color space, an L component in case of an Lab color space, and so forth).

That is, the information recording apparatus of the present invention is characterized in that the color image is defined by an RGB color space, and the predetermined component is a G component of the color image. Or the information recording apparatus of the present invention is characterized in that the color image is defined by an Lab color space, and the predetermined component is an L component of the color image.

Furthermore, when the resolution scalability is used, only encoded data with a resolution lower than the maximum resolution of an important color component can be stored in the recording region that allows high-speed access.

As described above, since the information recording apparatus of this embodiment records encoded data of a color component important for the user of a plurality of color components in a color image, which is compression-encoded by JPEG2000, on the region that allows high-speed access in the recording medium 3, required data can be accessed at higher speed.

<23rd Embodiment>

In this embodiment, a method of recording a bitstream of a color moving image compression-encoded by Motion JPEG2000 on a recording medium will be explained.

A Motion JPEG2000 file will be briefly explained first. The Motion JPEG2000 file records bitstreams, which are compression-encoded by JPEG2000 for respective frames, in the playback order as a single file. The Motion JPEG2000 file is as has been explained using FIG. 13. That is, in FIG. 13, a header of the file stores information required to manage this file. Each frame is obtained by compression-encoding only image data of that frame by JPEG2000. Note that the data format of each frame of a moving image used in this embodiment is the same as that of the color image in the 21st embodiment described above.

The flow chart used to explain the frame selection method of selecting a frame from a plurality of frames on the basis of a given condition is the same as that shown in FIG. 15.

More specifically, a counter LC used to count frames is reset to zero (step S1501). A frame number FLC of the frame to be selected is compared with the value of the counter LC (step S1502). Note that a selection condition in this embodiment is determined using the frame number, and for example, when 10 frames are input, one frame is selected. That is, when the value of the counter LC reaches 10, that frame is selected.

If the selection condition is satisfied in step S1502 (Yes), the flow advances to step S1503. On the other hand, if the selection condition is not satisfied in step S1502 (No), the flow advances to step S1504.

Step S1503 corresponds to a recording process on the special region 31 and step S1504 corresponds to a recording process on the general region 32. In this case, the write method of encoded data of the frame of interest is the same as that explained in the 21st embodiment using FIG. 33.

Upon completion of the process in step S1503 or S1504, it is checked if the above process is complete for all input frames (step S1505). If the above process is complete for all frames (Yes), selection of frames is to end. On the other hand, if the above process is not complete for all frames (No), the frame number is incremented, and the flow returns to step S1502, thus repeating the above process.

In general, a Motion JPEG2000 file is defined by the YCbCr color space to deal with moving image data. When a color moving image encoded by JPEG2000 is defined by the YCbCr color space, Y component data is normally stored as the first color. Therefore, by storing encoded data for one color from the head of the JPEG2000 file on the special region 31 using the aforementioned processing sequence, Y component data can be stored in the special region 31.

That is, the information recording apparatus of the present invention is characterized in that the color moving image is defined by a YCbCr color space, and the predetermined component is a Y component of the color moving image.

In this embodiment, as shown in FIG. 17, data from a header to a part corresponding to encoded data of an important color component (e.g., Y component) of frame 0 (first frame) is recorded on the special region 31, and the remaining encoded data of that frame is stored on the general region 32. Then, encoded data from frame 1 (second frame) to frame 9 (10th frame) are stored on the general region 32. A part corresponding to encoded data of an important color component of frame 10 (11th frame) is stored on the special region 31 as in frame 0, and the remaining encoded data of frame 10 is stored on the general region 32.

That is, the information recording apparatus of the present invention is characterized in that the file system which manages color moving images recorded on the recording medium 3 is Universal Disk Format. Also, the information recording apparatus of the present invention is characterized in that the first recording unit 13 records data associated with a predetermined component of a color moving image required to decode a moving image having predetermined image quality on the first recording region (special region 31). Also, the present invention is characterized in that the first recording unit 13 records a bitstream with a predetermined bit length of the input color moving image on the first recording region (special region 31).

After data are recorded on the recording medium 3, as described above, by reading out only a part recorded on the special region 31 of UDF entries, an important color component can be accessed at high speed. For example, when image data is defined by the YCbCr color space, a moving image formed by monochrome image data that can be decoded using only Y component data can be played back. In this way, a plurality of frames of image data formed of only important color component data can be sequentially displayed, and a moving image can be displayed consequently.

Note that such data read process is the same as the processing sequence in the 21st embodiment described above.

That is, the information recording apparatus of the present invention is directed to an information recording apparatus for recording a color moving image, which is compression-encoded by Motion JPEG2000, on a recording medium 3 having two recording regions with different access speeds, characterized by comprising an input unit 10 for inputting a color moving image compression-encoded by Motion JPEG2000, a first recording unit 13 for recording data associated with a predetermined component of the input color moving image on the first recording region (special region 31), and a second recording unit 14 for recording data other than the data associated with the predetermined component of the color moving image recorded on the first recording region (special region 31) on the second recording region (general region 32).

Also, the present invention is characterized by further comprising a header information reading unit 11 for reading header information of the input color moving image, and a bitstream arranging unit 12 for rearranging the bitstream of the input color moving image to a predetermined bitstream on the basis of the read header information.

Furthermore, in the description of this embodiment, the YCbCr color space is used as the color space of a color moving image. Also, moving images defined by other color spaces may be used (e.g., a G component in case of an RGB color space, an L component in case of an Lab color space, and so forth). In this manner, a color component important for the user, a most easily identifiable color component of human eyes, or the like in each color space can be similarly stored in the special region 31.

That is, the information recording apparatus of the present invention is characterized in that the color moving image is defined by an RGB color space, and the predetermined component is a G component of the color moving image. Or the information recording apparatus of the present invention is characterized in that the color moving image is defined by an Lab color space, and the predetermined component is an L component of the color moving image.

<24th Embodiment>

This embodiment will explain the process when the arrangement of the information recording apparatus according to the 23rd embodiment includes an encoder. The arrangement of the information recording apparatus according to this embodiment is the same as that of FIG. 34 described in the 22nd embodiment. Since each frame of moving image data is encoded as still image data, a JPEG2000 encoder of this embodiment can use the same one as that in the process of a color image according to the 22nd embodiment.

Furthermore, when the number of bytes of encoded data of each frame to be recorded on the special region 31 has a fixed length, the encoded data recorded on the special region 31 is rarely delimited at an appropriate position but is often broken in the middle of the stream due to the syntax of the JPEG2000 bitstream. However, even in such case, only such encoded data can be decoded and displayed. In this case, upon displaying moving image data in only the special region 31, they can be continuously read out without any seek upon accessing the disk.

As described above, since the information recording apparatus according to this embodiment records encoded data of an important color component of a plurality of color components in a color moving image compression-encoded by JPEG2000 on the region that allows high-speed access in the recording medium 3, required data can be accessed at high speed.

Furthermore, the present invention has the following advantages over the problems of the prior arts.

The present invention can solve the problem of Japanese Patent Laid-Open No. 03-053381 “Image Information High-speed Search Method”, data of a predetermined part of variable-length encoded data is recorded on the special region 31 while maintaining full compatibility with the standardized JPEG2000 format. Also, even when JPEG2000 data is broken at an arbitrary position from the head of data, an image can be played back using only that data. Hence, whether or not data to be recorded on the special region 31 is complete need not be checked.

As for the problem of Japanese Patent Laid-Open No. 07-123346 “Image Recording/Reproduction Method and Apparatus”, the present invention can prevent data from being repetitively recorded on a region that allows high-speed access, and another region, and can improve the use efficiency of the recording medium 3.

Furthermore, as for the problem of Japanese Patent Laid-Open No. 08-077325 “Still Image Data Recording Apparatus”, the present invention can obtain the same effect not only for fixed-length encoded image data but also for variable-length encoded data.

As described above, according to the present invention, of image data to be recorded on a recording medium, image data that requires high-speed access upon reading out data is recorded on a region that allows high-speed access of the recording medium, thus shortening the access time to recorded data.

<25th Embodiment>

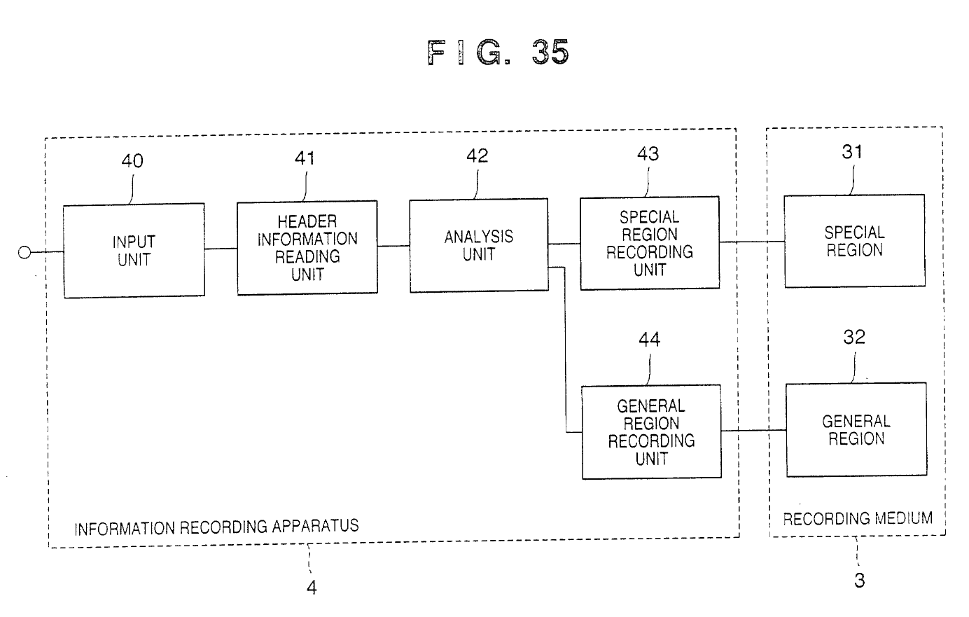

FIG. 35 is a block diagram for explaining the arrangement of an information recording apparatus according to the 25th embodiment of the present invention. The information recording apparatus 4 of this embodiment records image data, which is compression-encoded by JPEG2000 complying with ISO/IEC-15444, on a recording region of a detachable recording medium 3. Note that a bitstream of image data, which is compression-encoded by JPEG2000, will be referred to as a JPEG2000 bitstream hereinafter. The recording region of the recording medium 3 is divided into a general region 32 for recording a given component of image data, and a special region 31 for recording image data other than the component recorded on the general region 32, as shown in FIG. 35.

The information recording apparatus 4 comprises an input unit 40 for inputting a JPEG2000 bitstream, a header information reading unit 41 for reading header information from the input JPEG2000 bitstream, an analysis unit 42 for analyzing encoded data in each packet of image data on the basis of the read header information, a general region recording unit 44 for recording a given component of the JPEG2000 bitstream on the general region 32 of the recording medium 3 on the basis of the analysis result, and a special region recording unit 43 for recording the JPEG2000 bitstream other than the component recorded on the general region 32 on the special region 31.

Note that a packet is one management unit in image data, and is obtained by arranging data to a frame having a given format, and appending address data and the like to it. Each packet is formed of a packet header that manages information (header information) of code blocks stored in that packet, and encoded data of the code blocks.

That is, the present invention is directed to an information recording apparatus for recording image data, which is compression-encoded by JPEG2000, on a recording medium 3 having two recording regions with different access speeds, characterized by comprising an input unit 40 for inputting image data which is compression-encoded by JPEG2000 and consists of a plurality of packets, a first recording unit (general region recording unit 44) for recording header information of each packet of the input image data on a first recording region (general region 32), and a second recording unit (special region recording unit 43) for recording image data other than the header information recorded on the first recording region (general region 32) on a second recording region (special region 31).

The schematic diagram used to explain the electrical arrangement that implements the operation of the information recording apparatus 4 (FIG. 35) which records a JPEG2000 bitstream on the recording medium 3 is the same as that shown in FIG. 2. Referring to FIG. 2, a CPU 101 is an arithmetic device for controlling the operation of the overall information recording apparatus 900. A secondary storage unit 103 is a hard disk that stores a computer program and the like. A primary storage unit 102 is a memory used to load and store the computer program stored in the secondary storage unit 103 when that program is executed by the CPU 101. In general, the capacity of the primary storage unit 102 is smaller than that of the secondary storage unit 103, and a computer program, data, and the like that cannot be stored in the primary storage unit 102 are stored in the secondary storage unit 103. Also, data and the like, which must be stored for a long period of time, are stored in the secondary storage unit 103.

An input device 104 comprises a mouse, keyboard, and the like, and is used to send an interrupt signal upon execution of the computer program. An output device 105 comprises a monitor, printer, and the like. Using the electrical arrangement shown in FIG. 2, the processes in the analysis unit 42, special region recording unit 43, and general region recording unit 44 of the information recording apparatus 4 shown in FIG. 35 are implemented. Furthermore, when the input unit 40 shown in FIG. 35 is connected to the electrical arrangement in FIG. 2, a JPEG2000 bitstream can be input.

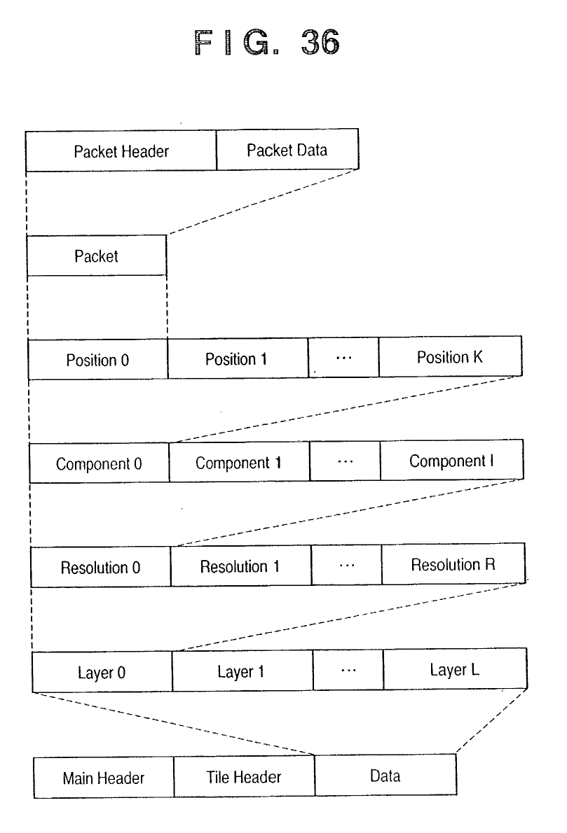

Encoded data which is compression-encoded by general JPEG2000 will be explained below. FIG. 36 is a schematic view for explaining the detailed format of image data, which is compression-encoded by JPEG2000 according to Layer—Resolution level—Component—Position Progression (to be referred to as “LRCP” hereinafter) mode. In this embodiment, since image data is encoded by LRCP mode, data of a bitstream are recorded in the order of Layer, Resolution, Component, and Position. That is, the present invention is characterized in that data in a predetermined bitstream are arranged in the order of Layer, Resolution, Component, and Position.

In this embodiment, as shown in FIG. 4, an image with the lowest resolution has resolution number 0, and the width and height of an image are doubled every time the resolution number is incremented by 1. For example, an image of resolution number 3 (Resolution 3) in FIG. 4 has a width and height twice those of an image of resolution number 2 (Resolution 2).

In each resolution, data are arranged in ascending order of layer number, as shown in FIG. 36. The layer number corresponds to the S/N ratio of an image to be decoded to an original image, and the S/N ratio lowers with decreasing layer number.

Assume that the maximum values of the resolution number, layer number, and component number in image data encoded by JPEG2000 (JPEG2000 bitstream) are set in advance by an encoder in this embodiment. These parameters are encoded as header information, and an original image is encoded according to those parameters, thus generating a JPEG2000 bitstream of the image.

Note that the component number matches the number of dimensions of a color space of an image. For example, when the color space of an objective image is a three-dimensional RGB color space, the component number=3. In case of LRCP mode used in this embodiment, each position is formed by one packet. Therefore, one layer includes packets as many as (the number of resolutions)×(the number of components)×(the number of positions).

Assume that the recording medium used in this embodiment is an optical disk, as shown in FIG. 5. In general, the optical disk can access data recorded on an inner peripheral recording region faster than data recorded on an outer peripheral recording region. In this embodiment, the inner peripheral recording region is defined as “special region” for recording an image data main body with a large data size. Since the access time to the outer peripheral recording region becomes longer than that to the inner peripheral recording region, the outer peripheral recording region is defined as “general region” for recording header information with a small data size other than the data recorded on the special region.

That is, the present invention is characterized in that first recording means (general region recording unit 44) records header information of image data on the first recording region (general region 32). Also, the present invention is characterized in that second recording means (special region recording unit 43) records image data other than header information contained in each packet on the second recording region (special region 31).

Also, this embodiment adopts Universal Disk Format (UDF) as the file system of the optical disk. In the UDF, one file can be segmented and written at a plurality of positions. The file to be segmented and recorded is recorded using UDF entries as many as the number of segments. More specifically, the present invention is characterized in that the file system which manages image data recorded on the recording medium 3 is Universal Disk Format.

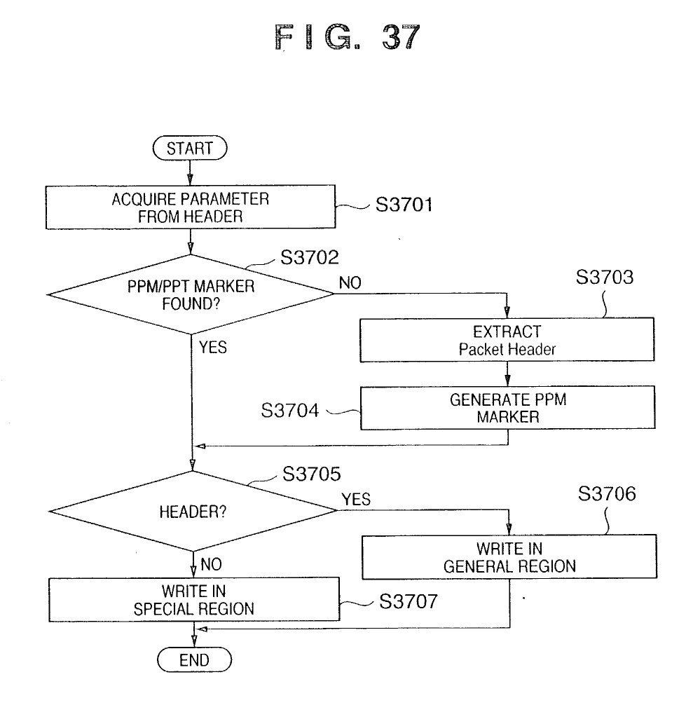

FIG. 37 is a flow chart for explaining the processing sequence upon recording an input JPEG2000 bitstream on the optical disk using the information recording apparatus 4 according to this embodiment.

The header information reading unit 41 reads header information in a JPEG2000 bitstream as an input file input so as to acquire parameters such as a maximum layer number, maximum resolution number, component number, stream recording method, and the like in the file (step S3701). Then, the analysis unit 42 analyzes a marker code in the information acquired in step S3701 to check if a PPM marker or PPT marker is used (step S3702).

That is, the present invention is characterized by further comprising a header information recording unit 41 for reading header information of input image data, and an analysis unit 42 for analyzing header information of each packet on the basis of the header information.

The PPM marker and PPT marker will be explained below. PPM (Packed packet headers, main header) is a set of packet headers for a main header, which are stored in the main header of JPEG2000. Also, PPT (Packed packet headers, tile-part header) is a set of packet headers for a tile header, which are stored in the tile header.

More specifically, in JPEG2000, each packet data is formed of a packet header and data. This data means a set of encoded data of a plurality of code blocks which form the packet. The packet header is used to manage the states and the like of code blocks of the data. Hence, in order to decode a packet, a value stored in a packet header is obtained by decoding the packet header, and each code block is processed based on that value.

As a storage method of such packet headers, methods using a PPM marker code and PPT marker code are available. For example, when a set of packet headers in respective packets are stored together in a main header, the PPM marker is used; when a set of packet headers in respective packets are stored together in a tile header, the PPT marker is used. Therefore, data in each packet in such case is only packet data.

That is, the present invention is characterized by further comprising a first storage unit for storing header information of each packet in header information of image data on the basis of a marker contained in the header information of the image data. Or the present invention is characterized by further comprising a second storage unit for storing header information of each packet in a tile header on the basis of a marker contained in the tile header of image data.

In this embodiment, packet data is compressed as variable-length data, and is stored in encoded data. For this reason, in order to access packet data, a packet header must be decoded to decode packet data based on that information. However, when a packet header is processed by repeating that process for each packet, the processing time is prolonged. Therefore, when packet headers are stored in the PPM marker or PPT marker, data of respective code blocks can be accessed by a single header process.

As a result of checking in step S3702 of this embodiment if the PPM or PPT marker is used, if it is determined that either of these markers is already used (Yes), the flow advances to step S3705. On the other hand, if neither of these markers are used (No), the flow advances to step S3703.

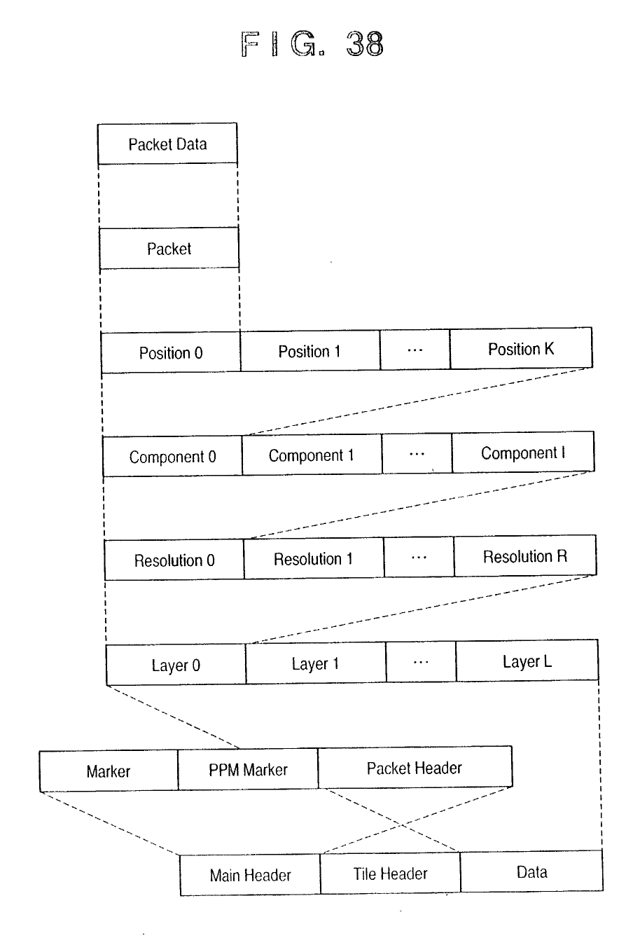

In steps S3703 and S3704, encoded data shown in FIG. 36 is converted into a format of encoded data shown in FIG. 38. FIG. 38 is a schematic view for explaining the detailed format of encoded data after the encoded data shown in FIG. 36 is converted. In the encoded data shown in FIG. 38, a PPM marker and packet header are stored in a main header. Each packet stores packet data alone.

This packet header is obtained by extracting packet headers from data of respective packets shown in FIG. 36, and moving them to the main header with a PPM marker. The storage format at that time is an encoding format based on JPEG2000. That is, packet headers stored in respective packets are extracted (step S3703). By converting information of all the packet headers extracted in step S3703 into data of a PPM marker code, a PPM marker is generated (step S3704).

After that, the analysis unit 42 checks if the encoded data to be currently output corresponds to a header (step S3705). As a result, if the encoded data corresponds to a header, it is recorded on the general region 32 (step S3706). On the other hand, if the encoded data is other than the header (No), it is recorded on the special region 31 (step S3707).

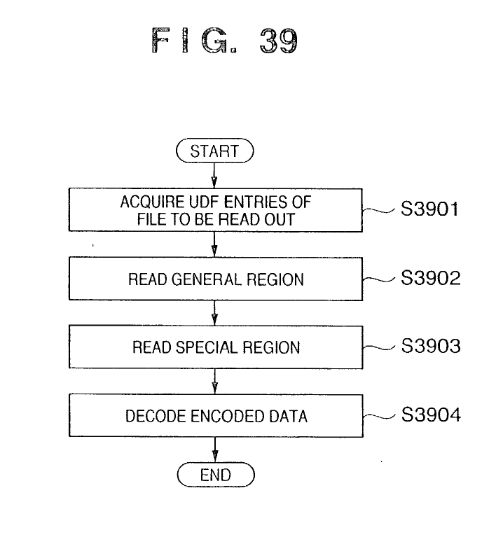

A method of accessing predetermined data of the data written on the optical disk in the sequence shown in FIG. 37 at high speed will be explained below. FIG. 39 is a flow chart for explaining the processing sequence for reading out data written on the recording medium in the sequence shown in FIG. 37. In this embodiment, a process for reading out a file which is divisionally recorded on the recording medium as a logically single file, and decoding the readout file will be explained.

UDF entries of a file to be read out are acquired (step S3901). Based on information of the UDF entries, encoded data stored in the general region 32 is read out (step S3902) to process packet headers of all packets of a JPEG2000 file. Then, encoded data recorded on the special region 31 is read out (step S3903), i.e., the remaining data other than the header in the encoded data of the JPEG2000 file is read out. Finally, the readout encoded data is decoded (step S3904). In this manner, single image data is fully decoded.

In this case, in the read process of encoded data recorded on the general region 32 in step S3902, encoded data of the header that contains the PPM marker code is read out from the head of the file. This header may be repetitively read out when decoding of the identical file is repeated (e.g., decoding for respective layers, decoding for respective resolutions, and the like). In this case, information used to make required calculations by reading out only a required part in encoded data stored in packet headers can be accessed at high speed.

On the other hand, a JPEG2000 file decoder reads out and decodes partial data from one encoded data in accordance with user's request independently of the progression order stored in the file. In this manner, an image can be decoded using two different scalabilities, i.e., resolution scalability and SNR scalability.

In the decoding process at that time, encoded data stored for respective packets must be processed while changing the order they are read out in accordance with each scalability in decoding, in place of reading out encoded data of respective code blocks in the storage order of the file. In such case, by loading the packet headers onto a memory in advance, the read process of the packet headers themselves and decoding process can be done at high speed, and encoded data of required code blocks can be accessed and decoded at high speed.

<26th Embodiment>

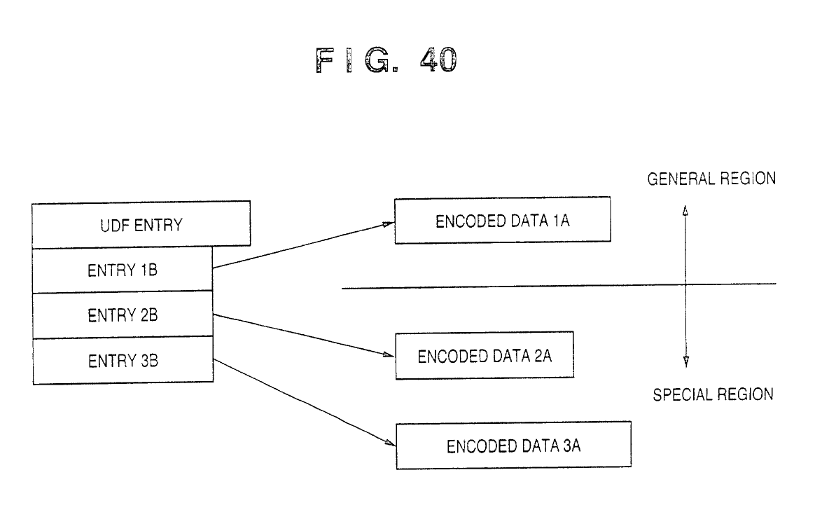

In the 25th embodiment described above, data recorded in the general region 32 are headers of all JPEG2000 encoded data each containing the PPM marker code. The data length of data to be recorded on the general region 32 may be a fixed length. In the 26th embodiment, a case will be explained below wherein the data length of data to be recorded on the general region 32 is a fixed length. FIG. 40 is a schematic view for explaining the data allocation of a JPEG2000 file on a recording medium. In FIG. 40, encoded data 1A corresponds to a header of a JPEG2000 file, is stored in the general region 32, and has a fixed length. Encoded data 3A corresponds to encoded data of each code block other than the header, and is recorded on the special region 31.

As described above, in this embodiment, encoded data 1A and 3A are recorded on independent regions. In this case, if the data length of data to be recorded on the general region 32 is a fixed length, the header of the JPEG2000 file may exceed the fixed length. In this case, in order to record fixed-length data on the general region 32, header information more than the number of bytes of the fixed length is recorded on the special region 31 as encoded data 2A.

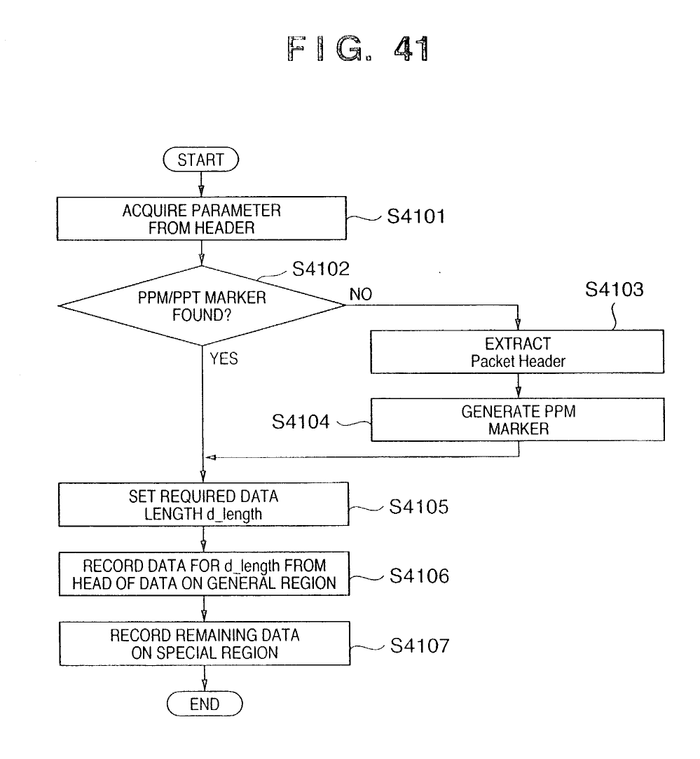

The aforementioned processing sequence will be explained using the drawing. FIG. 41 is a flow chart for explaining the processing sequence when the data length of data to be recorded on the general region 32 is a fixed length. In FIG. 41, the processes in steps S4101 to S4104 are the same as those in the 25th embodiment described above.

After the process in step S4102 or S4104, the number of bytes d_length of data to be written in the general region 32 is calculated (step S4105). In this embodiment, the number of bytes d_length is a fixed length. Data (encoded data 1A) for the number of bytes d length calculated in step S4105 from the head of the file is recorded on the general region 32 of the recording medium using the UDF function (step S4106). After that, data (encoded data 2A) after the (d_length)-th byte from the head of the file is recorded on the special region 31 of the recording medium (step S4107).

That is, the present invention is characterized in that first recording means (general region recording unit 44) records header information with a predetermined data length of each packet on a first recording region (general region 32). In this manner, fixed-length data can be recorded on the general region 32.

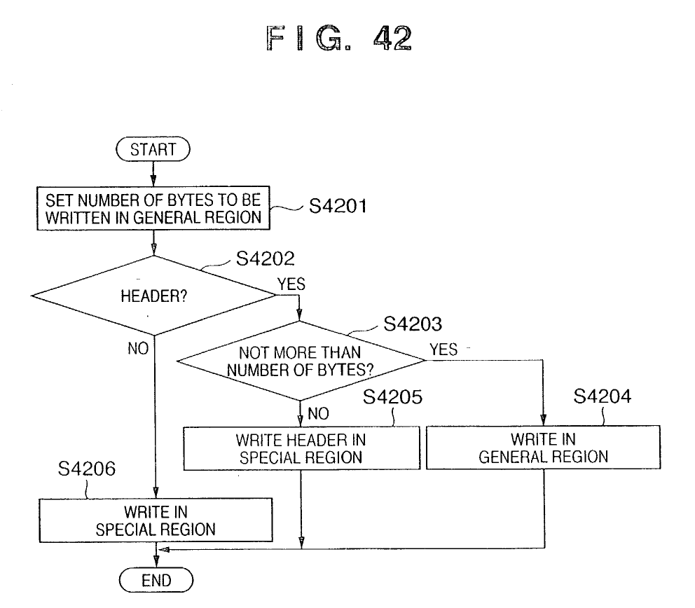

The processing sequence when the contents of processes after step S4105 in FIG. 41 have been changed will be described in detail below. FIG. 42 is a flow chart for explaining the processing sequence when the recording sequence on the recording medium in the processing sequence of the flow chart in FIG. 41 has been changed. The number of bytes of fixed-length data to be recorded on the general region 32 is set (step S4201).

It is then checked if a predetermined part of data recorded on the recording medium is a header in JPEG2000 encoded data (step S4202). As a result, if the predetermined part is other than the header (No), that data is recorded on the special region 31 (step S4206). On the other hand, if the predetermined part is the header (Yes), it is checked if the number of bytes recorded on the general region 32 so far is larger than that set in step S4201 (step S4203).

As a result, if the former number of bytes is smaller (Yes), that data is recorded on the special region 31 (step S4204) to update the number of bytes recorded on the special region 31. On the other hand, if the former number of bytes is larger (No), that data is recorded on the general region 32 (step S4205). By executing the aforementioned process for input encoded data, the recording method shown in FIG. 40 can be implemented.

Furthermore, the aforementioned process can be executed while simultaneously executing recording on the special region 31 and recording on the general region 32. In this case, packet headers and packet data are extracted from data of respective packets, packet data are recorded on the special region 31, and packet headers are recorded on the general region 32. In such case, only when a given part of packet header cannot be recorded on the general region 32, that part may be recorded on the special region 31.

<27th Embodiment>

In the 25th and 26th embodiments, the recording method of a JPEG2000 file under the assumption that the already encoded JPEG2000 file is present has been explained. Hence, this embodiment will explain a process when the aforementioned arrangement of the information recording apparatus 4 includes an encoder.

The block diagram used to explain the arrangement around an encoder added to the information recording apparatus 4 to be explained in the 27th embodiment is the same as that shown in FIG. 9. That is, in FIG. 9, an original image 901 is an RGB color original image to be compression-encoded. The image 901 is compression-encoded by a JPEG2000 encoder 903. Upon compression encoding in the JPEG2000 encoder 903, control parameters 902 are required. The control parameters 902 include a maximum value of resolution scalability (Resolution), a maximum value of SNR scalability (Layer), the number of dimensions of a color space (Component), and the like upon compression encoding.

Also, the encoder is set to store packet headers in a header using a PPM marker code. In this manner, the JPEG2000 encoder 903 sequentially outputs a JPEG2000 bitstream to an output processor 904 in accordance with the parameters 902. The encoded data output from the JPEG2000 encoder 903 is shown in FIG. 7 above. The output processor 904 divisionally records the bitstream input from the JPEG2000 encoder 903 on a special region 31 and a general region 32 using the parameters 902.

The flow chart for explaining details of the process in the output processor 904 is the same as that shown in FIG. 12. Using the header information of the JPEG2000 bitstream, determination conditions of data to be recorded on an outer peripheral region (general region 32) on the optical disk are set (step S1201). For example, in this embodiment, data that simultaneously meets the following two conditions are recorded on the outer peripheral region:

(1) less than 4 kB from the head of a stream; and

(2) a header.

It is checked if the above two conditions are met (step S1202). As a result, if the two conditions are met (Yes), the bitstream is recorded on the general region 32 (step S1203). On the other hand, if the two conditions are not met (No), the remaining bitstream is recorded on the special region 31 (step S1204).

As described above, the information recording apparatus of this embodiment records data with a large data size other than packet headers on a region that allows high-speed access (special region 31) of the recording medium, and records the packet headers with a small data size on the other region (general region 31). In this way, the entire data can be accessed at high speed. Since the packet headers are recorded together on the single region, when a very large number of files are to be accessed, the packet headers with a small data size are accessed first and are stored on a memory, thus allowing high-speed access to required files.

<28th Embodiment>

In this embodiment, a case will be described below wherein headers of packets which form image data are recorded on an inner peripheral region that allows high-speed access of an optical disk using an information recording apparatus shown in FIG. 35 having the same arrangement as that in the above embodiment.

That is, the present invention is directed to an information recording apparatus 4 for recording image data, which is compression-encoded by JPEG2000, on a recording medium 3 having two recording regions with different access speeds, characterized by comprising an input unit 40 for inputting image data which is compression-encoded by JPEG2000 and consists of a plurality of packets, first recording means (special region recording unit 43) for recording header information of each packet of the input image data on a first recording region (special region 31) that allows high-speed access, and second recording means (general region recording unit 44) for recording image data other than the header information recorded on the first recording region (special region 31) on a second recording region (general region 32).

The present invention is also characterized in that the recording medium 3 is an optical disk, and the first recording region (special region 31) is assured on an inner peripheral portion of the optical disk.

Also, the electrical arrangement that implements the operation of the information recording apparatus 4 is the same as that in FIG. 2. Furthermore, in this embodiment, encoded data is compression-encoded according to Layer—Resolution level—Component—Position Progression (LRCP) mode.

The flow chart used to explain the processing sequence upon recording an input JPEG2000 bitstream on the optical disk using the information recording apparatus 4 of this embodiment is substantially the same as FIG. 37, except for processes executed when the analysis unit 42 determines whether or not the encoded data to be currently output is a header (step S3705).

That is, if the encoded data is a header, it is recorded on the special region 31 in place of the general region 32. On the other hand, if the encoded data is other than the header, it is recorded on the general region 32 in place of the special region 31. In this manner, upon reading out and decoding a file, which is divisionally recorded on the recording medium, as a logically single file, header information can be accessed at high speed, thus allowing higher-speed access to required information. That is, information used to make required calculations by reading out only a required part in encoded data stored in packet headers can be accessed at high speed.

The same applies to the 26th and 27th embodiments described above. Therefore, when packet header information is recorded on the region that allows high-speed access of the recording medium 3, required data can be accessed at higher speed.

<29th Embodiment>

In this embodiment, a method of divisionally recording an already generated JPEG2000 file on a recording medium will be explained.

This embodiment will be explained in detail below using the accompanying drawings. Note that the arrangement of an information recording apparatus according to this embodiment is the same as that of the information recording apparatus 4 according to the 25th embodiment. Also, the electrical arrangement that implements the operation of the information recording apparatus for recording an input JPEG2000 bitstream on the recording medium is the same as that shown in FIG. 2.

Furthermore, the recording medium used in this embodiment is an optical disk with the structure shown in FIG. 5, as in the above embodiments. That is, the present invention is characterized in that the recording medium 3 is an optical disk, and a first recording region (special region 31) is assured on an inner peripheral portion of the optical disk.

Moreover, the logical format of the disk in this embodiment is UDF, and a file to be segmented and recorded is recorded using UDF entries as many as the number of segments. That is, the present invention is characterized in that the file system which manages image data recorded on the recording medium 3 is Universal Disk Format (UDF).

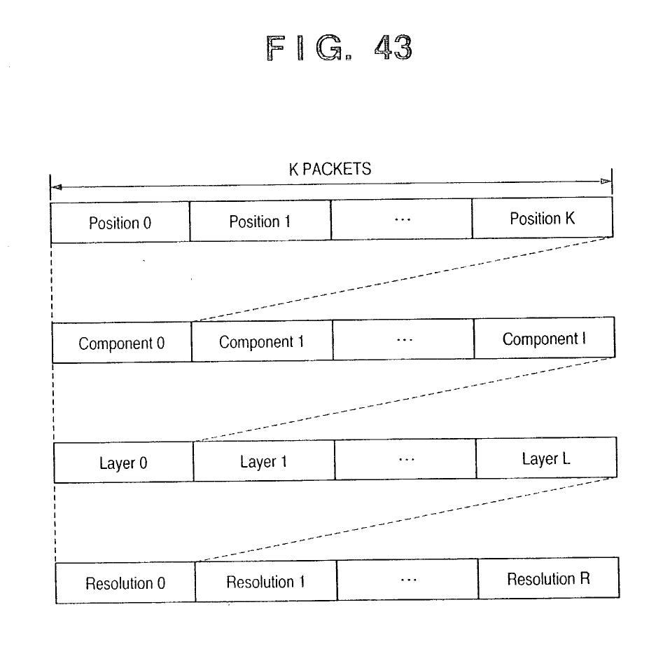

An outline of a JPEG2000 bitstream used in this embodiment will be described below. FIG. 43 is a schematic view for explaining the detailed format of image data, which is compression-encoded by JPEG2000 according to Resolution level—Layer—Component—Position Progression (to be referred to as “RLCP” hereinafter) mode. In this embodiment, since image data is encoded by RLCP mode, data of a bitstream are recorded in the order of Resolution, Layer, Component, and Position. That is, the present invention is characterized in that data in a predetermined bitstream are arranged in the order of Resolution, Layer, Component, and Position.

Also, the relationship between the resolutions (image sizes) and resolution numbers is shown in FIG. 4 as in the above embodiments. As shown in FIG. 4, an image with the lowest resolution has resolution number 0, and the width and height of an image are doubled every time the resolution number is incremented by 1. In each resolution, data are arranged in ascending order of layer number, as shown in FIG. 43. The layer number corresponds to the S/N ratio of an image to be decoded to an original image, and the S/N ratio lowers with decreasing layer number.

Assume that the maximum values of the resolution number, layer number, and component number in image data encoded by JPEG2000 (JPEG2000 bitstream) are set in advance by an encoder in this embodiment. These parameters are encoded as header information, and an original image is encoded according to those parameters, thus generating a JPEG2000 bitstream of the image.

In addition, Layer—Resolution level—Component—Position Progression (to be referred to as “LRCP” hereinafter) mode for recording data in the order of Layer, Resolution, Component, and Position and the like are available. In this embodiment, a bitstream according to RLCP mode is used. Note that a bitstream according to LRCP mode can be similarly processed.

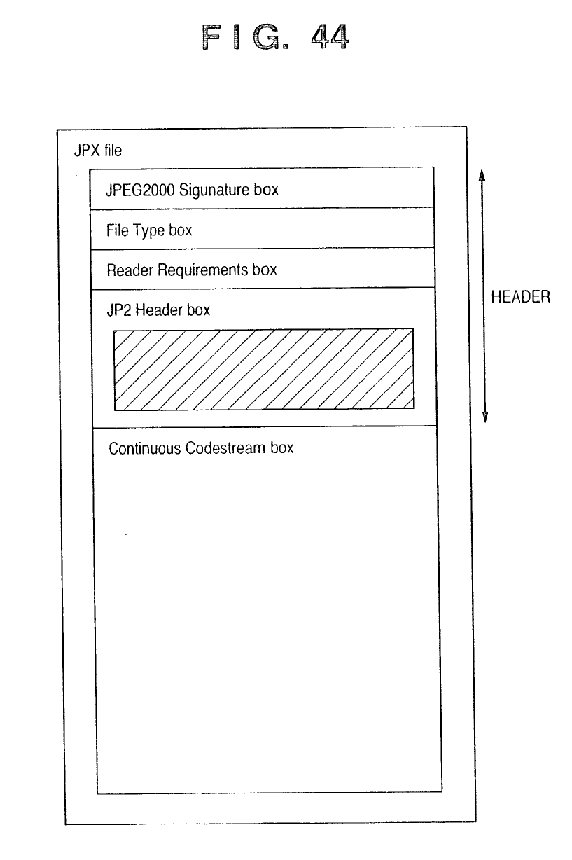

On the other hand, the file format used to store a JPEG2000 bitstream in a file is specified in advance in the JPEG2000 standards. FIG. 44 is a schematic view showing an example of the file format used to store a JPEG2000 bitstream in a file. As shown in FIG. 44, a JPEG2000 file of this embodiment must comprise, at its head position, a total of four boxes, i.e., three boxes including a JPEG2000 Signature box, File Type box, and Reader Requirements box, and a JP2 Header box (or Codestream Header box). In this embodiment, fields of these four boxes will be generally referred to as a header hereinafter.

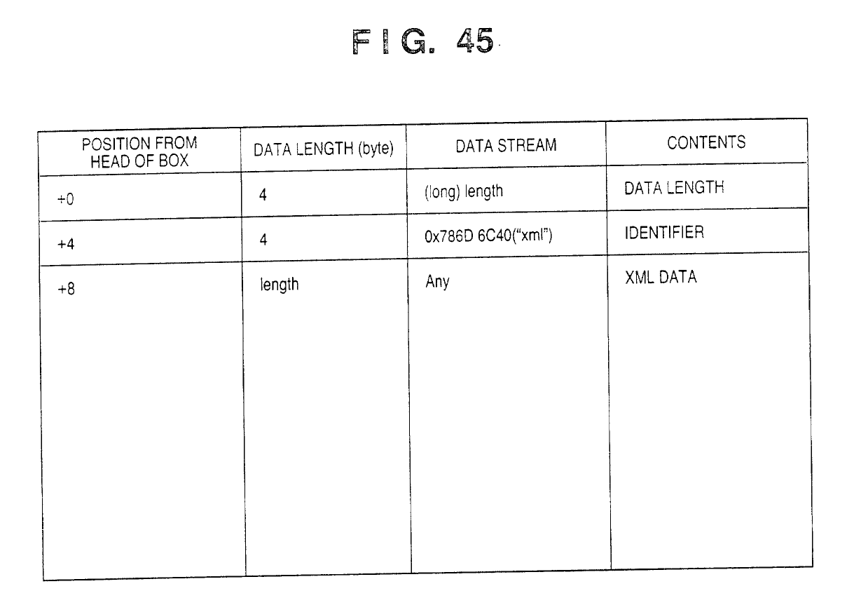

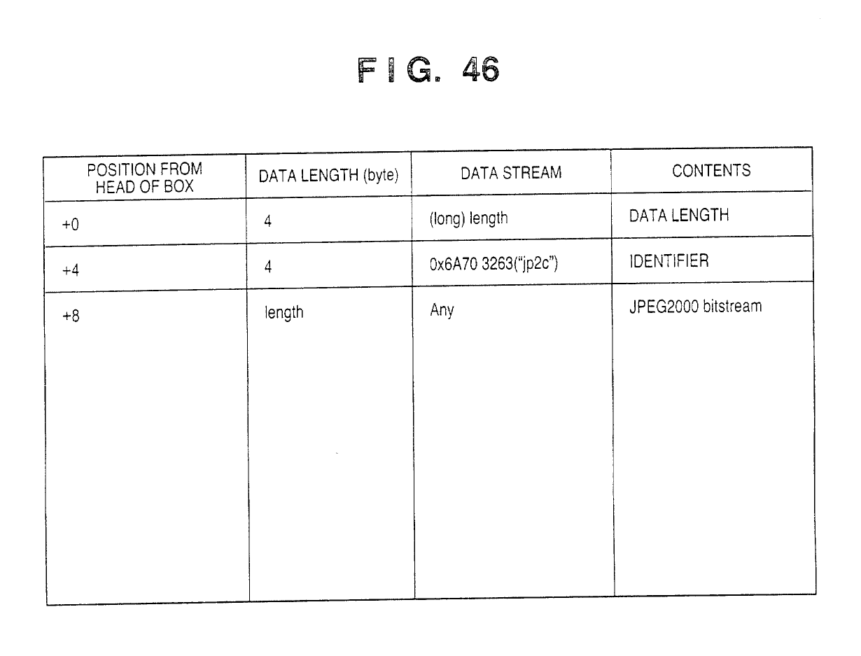

In the JPEG2000 file, an XML box and Continuous Codestream box are allocated after the aforementioned header. FIG. 45 shows the data contents stored in the XML box. Also, FIG. 46 shows the contents stored in the Continuous Codestream box. As shown in FIGS. 45 and 46, the XML box stores XML data, and the Continuous Codestream box stores a JPEG2000 bitstream.

Note that the order of data except for the JPEG2000 Signature box, File Type box, and Reader Requirements box is not particularly specified.

The processing sequence for recording a head part of such file, i.e., meta data and thumbnail image data, on the special region 31, will be explained below. The flow chart for explaining details of the recording sequence of data on the recording medium using the information recording apparatus according to the 29th embodiment is the same as that shown in FIG. 6. The input unit 40 inputs a JPEG2000 file to the information recording apparatus, and its header information is read (step S601). In this manner, information including a maximum layer number, maximum resolution number, component number, resolution number corresponding to a predetermined image size, stream recording method, and the like in the file can be acquired.

In this case, before the header information of the input JPEG2000 file is read, the contents of the JPEG2000 file are scanned to change the order of boxes and the like to an order of a header, XML box, and remaining image (encoded) data. That is, the present invention is characterized by further comprising a header information reading unit 41 for reading header information from the input image data, and a bitstream arranging unit 42 for rearranging the bitstream of the input image data to a predetermined bitstream on the basis of the read header information.

In this case, this process can be completed by temporarily loading the whole input JPEG2000 file onto a memory, and outputting data by rearranging the file in the order of a header, XML box, and image data from the head of the file. However, in this embodiment, a process executed when the memory size is small and the whole input JPEG2000 file cannot be loaded onto the memory will be explained.

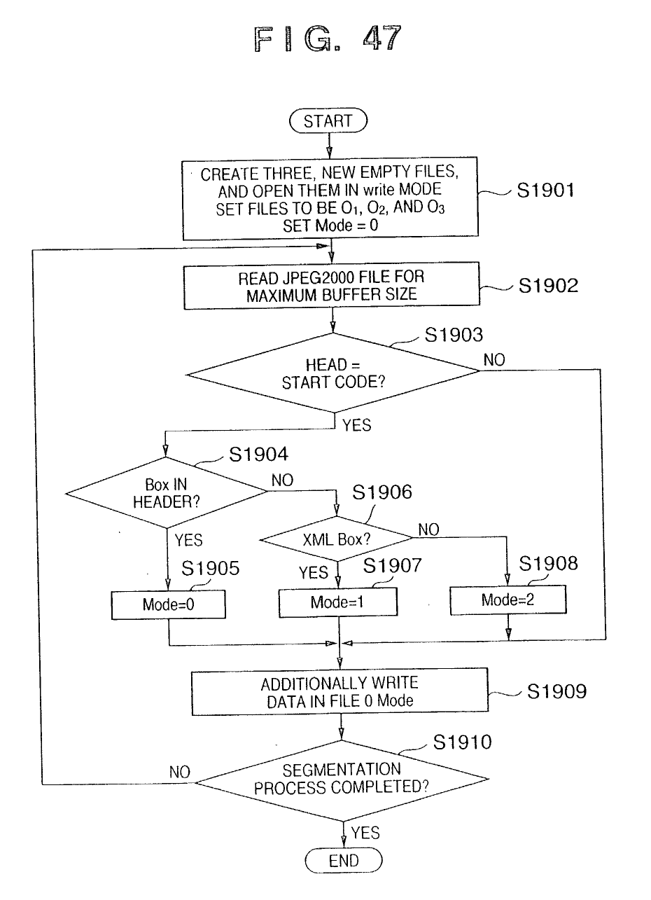

FIG. 47 is a flow chart for explaining the processing sequence of file segmentation upon executing a process for changing the order of boxes in an input JPEG2000 file. Three new empty files are created, and are opened in a write mode. Let O₁, O₂, and O₃ be the three new files to be created. Also, a constant Mode is set to be zero (step S1901).

The JPEG2000 file to be divisionally recorded is read onto a recording device such as a buffer or the like (step S1902). When the data to be read onto the buffer or the like contains a start code of a given box, data immediately before that code is read. In this manner, the start code of the box is always allocated at the head on the buffer or the like. Also, buffer_data_length indicates the data length of data read onto the buffer or the like.

It is then checked if the head of the data read onto the buffer or the like is a start code of a box (step S1903). As a result, if the head of the data is the start code (Yes), the flow advances to step S1904. On the other hand, if the head of the data is not the start code (No), the flow jumps to step S1909.

It is checked in step S1904 if the box of interest is that of the header. If the box of interest is that of the header (Yes), the flow advances to step S1905. On the other hand, if the box of interest is not that of the header (No), it is checked if the box of interest is an XML box (step S1906). As a result, if the box of interest is the XML box (YES), the flow advances to step S1907. On the other hand, if the box of interest is not the XML box (No), the flow advances to step S1908. If the file contains data other than the header, XML box, and image data, it must also be checked if the data is image data. However, in this embodiment, assume that a file contains no data except for the aforementioned three types of data, i.e., the header, XML box, and image data.

If the start code is that of a box that belongs to the header, Mode is set to be 0 (step S1905), and the flow advances to step S1909. On the other hand, if the start code is that of an XML box, Mode is set to be 1 (step S1907), and the flow advances to step S1909. If the start code is that of data other than the header and XML box, Mode is set to be 2 (step S1908), and the flow advances to step S1909.

In step S1909, a process for additionally writing data stored in the buffer or the like in file O_{Mode} indicated by the value of Mode, i.e., file O₁, O₂, or O₃ is executed. Note that the data length of the data to be written in this process is equal to buffer data length as that of the data read onto the buffer or the like. Finally, it is checked if the whole JPEG2000 file is read (step S1910). As a result, if the whole file is read (Yes), the segmentation process ends. On the other hand, if data to be read still remains (No), the flow returns to step S1902 to repeat the aforementioned process.

With this process, the JPEG2000 file as a target can be segmented into three types of files, i.e., the header, XML box, and image data, and data can be rearranged by joining these files in the order of the header, XML box, and image data.

Since a process for the already generated JPGE2000 file has been exemplified in this embodiment, the order of arrangement must be changed. However, when a bitstream is to be generated, an XML box is output before a Continuous Codestream box is output so as to record only required data on the special region 31, and to record the remaining data on the general region 32.

That is, the present invention is directed to an information recording apparatus for recording image data, which is compression-encoded by JPEG2000, on a recording medium having two recording regions with different access speeds, characterized by comprising an input unit 40 for inputting image data including encoded data which is compression-encoded by JPEG2000, an XML box moving unit for moving an XML box in the input image data to a position before a box that stores the encoded data, first recording means (special region recording unit 43) for recording data with a predetermined data length from the head of the image data on a first recording region (special region 31) that allows high-speed access, and second recording means (general region recording means 44) for recording image data, other than the data recorded on the first recording region (special region 31), on a second recording region (general region 32).

After the parameters are acquired from the header in step S601 above, it is checked if the bitstream recording method of that file complies with RLCP mode (step S602). If the file is recorded according to the RLCP mode (Yes), the flow advances to step S604. On the other hand, if the file is recorded according to a mode other than RLCP mode (No), the flow advances to step S603.

In step S603, a packet rearrangement process is executed. That is, the storage order of packets in the input JPEG2000 bitstream is rearranged according to RLCP mode, and the stream recording method in header information is corrected to RLCP mode. Upon completion of the packet rearrangement process, the flow advances to step S604.

In step S604, the data length d_length of data to be recorded on the special region 31 is checked. Note that the data length d_length in this embodiment is a fixed length. Data for d_length from the head of the file is written on the special region 31 using the UDF function (step S605). Subsequently, the remaining data is written on the general region 32 (step S606).

As a setup example of the data length d_length, the number of bytes that can contain the size of XML data and data of the resolution corresponding to a thumbnail image may be set.

That is, the present invention is characterized in that the first recording means (special region recording unit 43) records image data with a predetermined data length on the first recording region (special region 31). Also, the present invention is characterized in that the first recording means (special region recording unit 43) records image data with a data length that covers up to at least the end of an XML box on the first recording region (special region 31).

The sequence for reading out data recorded on the recording medium in the processing sequence shown in FIG. 6 will be explained below. The flow chart that shows the processing sequence for reading out and decoding only data recorded on the special region 31 that allows high-speed access on the recording medium is the same as that shown in FIG. 7. UDF entries of a file to be read out are acquired (step S701). Only an entry indicating a part of the special region 31 is selected from the UDF entries selected in step S701 (step S702). Then, data of the selected part is read and decoded (step S703).

For example, in this embodiment, data to be recorded on the special region 31 is that required to decode image data with a size as small as a thumbnail. Such data are recorded together on the special region 31 by applying the process shown in FIG. 6, and the recorded data are read out by applying the process shown in FIG. 7. In this manner, upon displaying a large number of image files, images which are recorded on the special region 31 and have a size as small as thumbnails can be easily displayed, and no seek time upon accessing the optical disk is generated or the seek time is short if it is generated. That is, the present invention is characterized in that the first recording means (special region recording unit 43) records image data with a resolution corresponding to a thumbnail image on the first recording region (special region 31).

In case of a file compression-encoded by JPEG2000, even when the data is broken in the middle of encoded data, a decoding process of an image with given image quality can be made using that encoded data. In this manner, even when data with the highest image quality corresponding to a thumbnail size image is not available, a thumbnail image with given image quality can be displayed.

The flow chart showing the processing sequence for reading out and decoding all files which are divisionally recorded on the recording medium is the same as that shown in FIG. 8. UDF entries of image data to be read out are acquired (step S801). All pieces of information are read out in accordance with the information of the UDF entries (step S802). Furthermore, the readout data are decoded (step S803). In this manner, all encoded data can be decoded, and image data recorded on the recording medium can be displayed without any image quality drop.

In this embodiment, the data to be recorded on the special region 31 has a fixed length. Alternatively, header information may be read to calculate the number of packets to be stored in the special region 31, and the data length of data to be recorded on the special region 31 may be determined. In this manner, all image data corresponding to thumbnails can be recorded on the special region 31 that allows high-speed access. Also, meta data can be accessed at high speed, and desired image data can be searched quickly.

<30th Embodiment>

In the 29th embodiment, the process for a JPEG2000 file has been explained. In this embodiment, a process for a Motion JPEG2000 file will be explained.

Even when a Motion JPEG2000 file is used, the same process as in the 29th embodiment can be applied to the head frame. Then, a frame used as a thumbnail is selected according to a specific condition, and the same process as in the 29th embodiment is then applied to the selected frame, thus implementing a moving thumbnail image function.

A Motion JPEG2000 file will be briefly explained first using FIG. 13. The Motion JPEG2000 file records bitstream data, which are compression-encoded by JPEG2000 for respective frames, in the playback order. This embodiment uses the same bitstream as that shown in FIG. 43 in the 29th embodiment as JPGE2000 bitstreams contained in the Motion JPEG2000 file. That is, bitstreams complying with RLCP mode are used in this embodiment.

That is, the present invention is directed to an information recording apparatus for recording moving image data, which is compression-encoded by Motion JPEG2000, on a recording medium having two recording regions with different access speeds, characterized by comprising an input unit 40 for inputting moving image data is compression-encoded by Motion JPEG2000, a selection unit for selecting a frame image that satisfies a predetermined selection condition from the input moving image data, first recording means (special region recording unit 43) for recording predetermined data of the selected frame image on a first recording region (special region 31), and second recording means (general region recording unit 44) for recording moving image data, other than the predetermined data of the frame image recorded on the first recording region (special region 31), on a second recording region (general region 32).

Also, the present invention is characterized in that the first recording means (special region recording unit 43) records an XML box and data with a predetermined data length of each frame selected by the frame selection unit on the first recording region (special region 31).

A processing sequence upon recording a Motion JPEG2000 file input by the input unit 40 on a recording medium 3 will be explained below.

As in the above embodiment, data in a bitstream are rearranged to move an XML box to a position immediately before a box that stores frame data. Note that details of this process are the same as those in the 29th embodiment described above.

The flow chart used to explain the processing sequence for recording thumbnails of a Motion JPEG2000 file on the special region 31 is the same as that shown in FIG. 15. That is, a counter LC used to count frames is reset to zero (step S1501). It is then checked if frame FLC with a frame number equal to the value of the counter LC meets a predetermined selection condition (step S1502). Note that the selection condition in this embodiment is that the frame number of zero or an integer multiple of 10.

As a result, if the frame of interest meets the selection condition (Yes), data of that frame is recorded on the special region 31 (step S1503). Note that-details of the process for recording data on the special region 31 are the same as the processing sequence shown in FIG. 6 explained in the 29th embodiment. On the other hand, if the frame of interest does not meet the selection condition (No), data of that frame is recorded on the general region 32 (step S1504).

Upon completion of the process in step S1503 or S1504, it is checked if the above process is complete for all input frames (step S1505). As a result, if all the frames are recorded on either recording region of the recording medium 3 (Yes), this process is to end. On the other hand, if frames to be recorded still remain (No), the flow returns to step S1502 to execute a recording process of the next frame.

The schematic view which shows the recording positions of the Motion JPEG2000 file on the recording medium in this embodiment is the same as that in FIG. 17. Data from a header to a thumbnail corresponding part of frame 0 are recorded on the special region 31, and the remaining data of frame 0 is recorded on the general region 32. Data from frame 1 to frame 9 are recorded on the general region 32. Data of a thumbnail corresponding part of frame 10 is recorded on the special region 31, and the remaining data of frame 10 is recorded on the general region 32. After that, data of a thumbnail corresponding part is recorded on the special region 31 every 10 frames. That is, the present invention is characterized in that the first recording unit (special region recording unit 44) records data required to form an image with predetermined image quality of each frame image selected by the frame selection unit on the first recording region (special region 31) in addition to an XML box.

After the Motion JPEG2000 file is recorded on the recording medium, as described above, thumbnail data can be accessed at high speed by reading only data recorded on the special region 31 of UDF entries, thus playing back a moving image formed of only thumbnail data. Such data read process is the same as that shown in FIG. 7 in the 29th embodiment described above.

Note that data to be recorded on the special region 31 has a fixed length. Alternatively, header information may be read to acquire the resolution number and layer number of the required resolution and required S/N ratio, and the data length of data to be recorded on the special region 31 may be determined, as in the 29th embodiment.

As described above, using the information recording apparatus of the 29th and 30th embodiments, since data that must be read out in large quantity are allocated on the inner peripheral portion (special region 31) that allows high-speed access of the recording medium, the access speed to the whole data can be improved. Also, meta data such as a search keyword or the like can be accessed quickly to implement a selection process upon displaying thumbnails, and an image search process at high speed.

Furthermore, the present invention has the following advantages over the problems of the prior arts.

The present invention can solve the problem of Japanese Patent Laid-Open No. 03-053381 “Image Information High-speed Search Method”, since data of a predetermined part of variable-length encoded data is recorded on the special region 31 while maintaining full compatibility with the standardized JPEG2000 format. Also, even when JPEG2000 data is broken at an arbitrary position from the head of data, an image can be played back using only that data. Hence, whether or not data to be recorded on the special region 31 is complete need not be checked.

As for the problem of Japanese Patent Laid-Open No. 07-123346 “Image Recording/Reproduction Method and Apparatus”, the present invention can prevent data from being repetitively recorded on a region that allows high-speed access, and another region, and can improve the use efficiency of the recording medium.

Furthermore, as for the problem of Japanese Patent Laid-Open No. 08-077325 “Still Image Data Recording Apparatus”, the present invention can obtain the same effect not only for fixed-length encoded image data but also for variable-length encoded data.

As described above, according to the present invention, of image data to be recorded on a recording medium, an image data main body other than header information is recorded on a region that allows high-speed access of the recording medium, and the header information is recorded on another region, thus shortening the access time to full recorded image data.

<31st Embodiment>

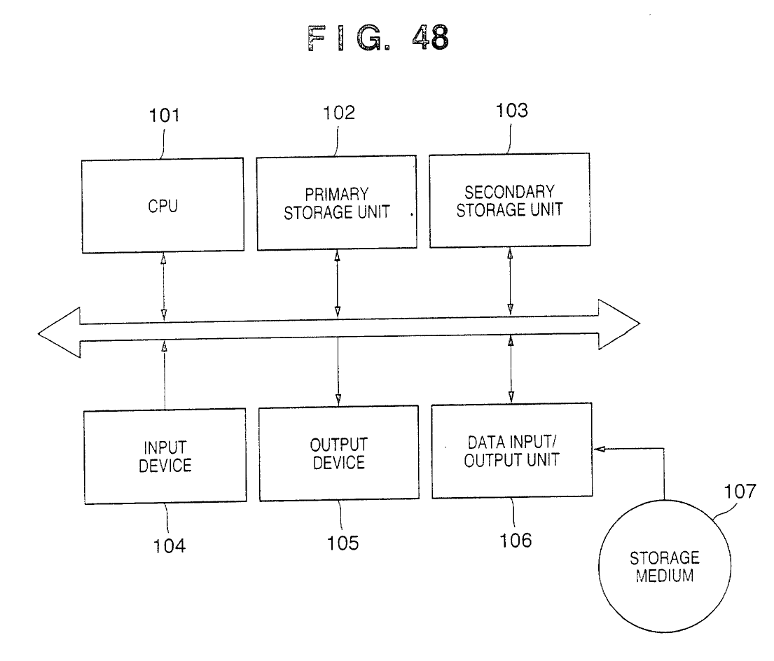

FIG. 48 is a block diagram showing the basic arrangement of an information recording apparatus according to the 31st embodiment. A CPU 101 controls the operation of the overall apparatus and executes programs stored in a primary storage unit 102. The primary storage unit 102 serves as a rewritable memory represented by a RAM, and stores programs, data, and the like read out from a secondary storage unit 103 by the CPU 101.

The secondary storage unit 103 serves as a large-capacity storage device represented by a hard disk, and its storage capacity is normally larger than that of the primary storage unit 102. Hence, a computer program, data, and the like that cannot be stored in the primary storage unit 102 are stored in the secondary storage unit 103. Also, data and the like, which must be stored for a long period of time, are stored in the secondary storage unit 103. In general, programs are stored in the secondary storage unit 103, and when the CPU 101 executes a program, that program is loaded from the secondary storage unit 103 onto the primary storage unit 102.

An input device 104 comprises a pointing device such as a mouse, keyboard, and the like, a speech input device, or the like, and is used to input various instructions to the CPU 101. An output device 105 comprises a monitor, printer, and the like. A data input/output unit 106 is a device for reading/writing programs and data on a storage medium 107 on/from which they can be written and read out. If the storage medium 107 is a CD-RW, the data input/output unit 106 is a CD-ROM drive.

A process executed when the information recording apparatus with the above arrangement writes data stored in the secondary storage unit 103 on the storage medium 107 via the data input/output unit 106 will be explained below. Assume that data to be written is encoded image data according to JPEG2000 in this embodiment.

In this embodiment, as shown in FIG. 25, JPEG2000 encoded data complying with LRCP mode has a format in which data are allocated in the order of Layer/Resolution/Component/Position. Note that a header field is not shown in FIG. 25 for the sake of simplicity.

JPEG2000 encoded data can be roughly classified into data for respective Layers. Data of respective Layers are encoded data of bitplanes which are obtained by known bitplane encoding, and are arranged in turn from a bitplane on the MSB side (Layer0) to a bitplane on the LSB side (LayerL). A Layer number corresponds to the S/N ratio of an image to be decoded to an original image, and the S/N ratio impairs (lowers) with decreasing Layer number. That is, respective Layer data are arranged in the JPEG2000 data in FIG. 25 in ascending order of S/N.

Furthermore, data of each Layer consists of data of respective Resolutions. Data of respective Resolutions are arranged in an order according to resolution numbers corresponding to resolutions (image sizes). The relationship between the resolutions and Resolution numbers is as shown in FIG. 4. An image with the lowest resolution has Resolution number 0, and the width and height of an image are doubled every time the Resolution number is incremented by 1. In each Layer, data are stored in ascending order of Resolution number.

Data of each Resolution consists of data of respective Components. Data of respective Components correspond to color data of an image. For example, if an image is formed by R, G, and B data, data of Component0, Component1, and Component2 respectively correspond to R, G, and B component data. That is, the number of Components matches the number of dimensions of the color space of the image.

Assume that maximum numbers of the Resolution number, Layer number, and Component number in a single JPEG2000 file are set in advance by an encoder, and data indicating these maximum values are contained in a header (not shown) appended to the data shown in FIG. 25.

An information storage portion of the storage medium 107 is as shown in FIG. 5. Assume that the storage medium 107 is a data rewritable optical disk such as a CD-RW or the like. In general, a device (e.g., a CD-ROM drive) that reads information recorded on a disk can access an inner peripheral region (e.g., inner sectors corresponding to 30% of the total number of sectors) of the optical disk faster than an outer peripheral region (sectors included in a region other than the inner peripheral region) as the access position becomes closer to the inner periphery. In the following description, the inner peripheral region will be referred to as a special region. Also, the outer peripheral region will be referred to as a general region hereinafter.

Furthermore, in this embodiment, the disk (storage medium 107) adopts UDF as its logical format. If the UDF format is used, one file can be segmented and written at a plurality of positions on the storage medium 107. The segmented data are recorded on the storage medium 107 using UDF entries as many as the number of segments.

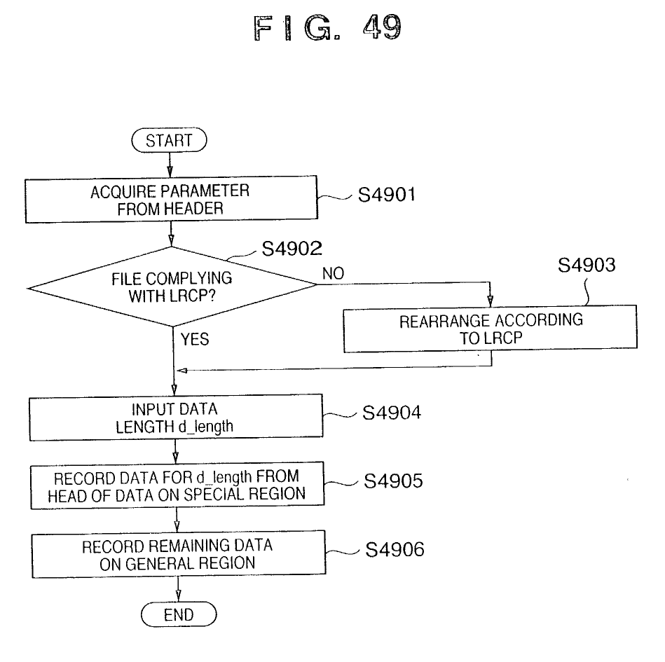

FIG. 49 is a flow chart showing the process for writing JPEG2000 data stored in the secondary storage unit 103 on the storage medium 107 by the data input/output unit 106.

The CPU 101 reads out encoded data stored in the secondary storage unit 103 onto the primary storage unit 102, and acquires the maximum Layer number, Resolution number, Component number, a Resolution number corresponding to a predetermined image size, and a stream recording method with reference to the header (step S4901).

The CPU 101 checks if the stream (encoded data shown in FIG. 25) recording method is LRCP (step S4902). If NO in step S4902, the CPU 101 rearranges encoded data (rearranges packets) according to LRCP mode, and corrects the stream recording method recorded in the header to LRCP (step S4903).

Then, a data length d_length of data to be written in the special region is input (step S4904). In this embodiment, this data length d_length is stored in the secondary storage unit 103 as a fixed length, and is read out onto the primary storage unit 102 under the control of the CPU 101 in this step. Also, the data length d_length may be input using the input device 104, and may be similarly stored in the primary storage unit 102. Note that the data length d_length can be set to be the number of bytes of data required to form images with the lowest S/N ratio, e.g., all data contained in Layer0. In this embodiment, the data length d_length indicates the number of bytes of data required to form images with the lowest S/N ratio, i.e., images with lowest image quality.

The CPU 101 controls the data input/output unit 106 to write encoded data for d_length from the head of the encoded data on the special region of the storage medium 107 using the UDF function (step S4905) and to write remaining data (data after the number of bytes for d_length from the head of the encoded data) on the general region of the storage medium 107 (step S4906).

With the aforementioned process, images with lowest image quality can be recorded on the region that allows high-speed access. For example, when encoded data of a plurality of images are to be recorded on the storage medium 107 and a list of these images is to be displayed, at least images with lowest image quality can be displayed on the display screen of the output device 105 as thumbnail images of the respective images. With the above process, thumbnail images can be read out quicker than a case wherein encoded data are recorded irrespective of the information storage region of the storage medium 107.

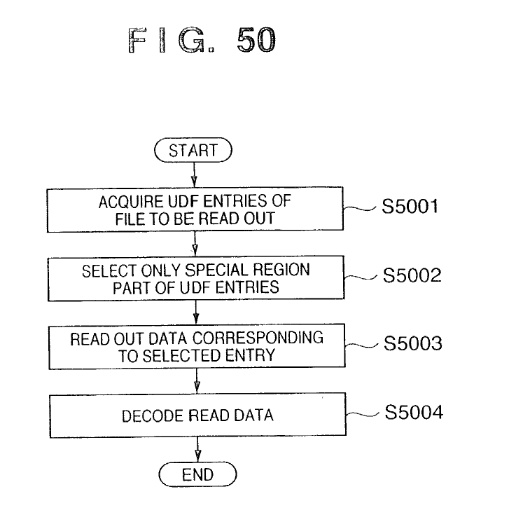

A method of reading out encoded data from the storage medium 107 on which the encoded data is recorded by the aforementioned method will be explained below. FIG. 50 is a flow chart showing the process for reading out only data recorded on the special region, i.e., only image data with lowest image quality.

The CPU 101 instructs the data input/output unit 106 to seek the storage medium 107, thus acquiring entries used to record encoded data to be read out (step S5001). The CPU 101 selects only entries indicating the special region from the acquired entries (step S5002). The CPU 101 instructs the data input/output unit 106 to read out data, which are recorded using the selected entries, onto the primary storage unit 102 (step S5003). The CPU 101 then decodes the data read out onto the primary storage unit 102 (step S5004). Note that a program used to decode data is stored in the secondary storage unit 103, and is read out onto the primary storage unit 102 as needed.

The flow chart of the process for reading out data recorded on the special and general regions, i.e., one encoded data, is the same as that shown in FIG. 8. That is, the CPU 101 instructs the data input/output unit 106 to seek the storage unit 107 to require entries used to record encoded data to be read out (step S801). The CPU 101 instructs the data input/output unit 106 to read out data, which are recorded using the acquired entries, onto the primary storage unit 102 (step S802). The CPU 101 then decodes data read out onto the primary storage unit 102 (step S803). Note that a program used to decode data is stored in the secondary storage unit 103, and is read out onto the primary storage unit 102 as needed.

As described above, since the information recording apparatus according to this embodiment can record data, which allows the user to roughly recognize the contents of images, on a region that allows high-speed access of the storage medium, even when a plurality of encoded data are recorded on the storage medium, thumbnail data of images recorded on the storage medium can be browsed quicker than the conventional apparatus.

The information recording apparatus according to this embodiment can solve the problem of Japanese Patent Laid-Open No. 03-053381, since data of a predetermined part of variable-length encoded data is recorded on the special region while maintaining full compatibility with the standardized JPEG2000 format. Also, even when JPEG2000 data is broken at an arbitrary position from the head of data, an image can be played back using only that data. Hence, whether or not data to be recorded on the special region is complete need not be checked.

Also, the information recording apparatus according to this embodiment can solve the problem of Japanese Patent Laid-Open No. 07-123346, since data can be prevented from being repetitively recorded on a region that allows high-speed access, and another region, and the use efficiency of the storage medium can be improved.

Furthermore, the information recording apparatus according to this embodiment can solve the problem of Japanese Patent Laid-Open No. 08-077325, since the same effect can be obtained not only for fixed-length encoded image data but also for variable-length encoded data.

In this embodiment, images with lowest image quality are recorded on the special region. However, the present invention is not limited to this. As described above, since at least images with the lowest S/N ratio need only be stored, data of Layer0 and Layer1 may be recorded on the special region, and subsequent data may be recorded on the general region.

In this embodiment, data to be recorded on the special region has a fixed length of a predetermined size. Alternatively, header information may be read to acquire the Resolution number and Layer number of the required resolution and required S/N ratio, and the data length of data to be recorded on the special region may be determined.

<32nd Embodiment>

The information recording apparatus according to the 31st embodiment records encoded data, which has already been encoded by JPEG2000, on the storage medium. An information recording apparatus according to this embodiment comprises an encoder, receives an original image which is not encoded, encodes the input image by JPEG2000, and then records the encoded data on the storage medium, as described in the 31st embodiment.

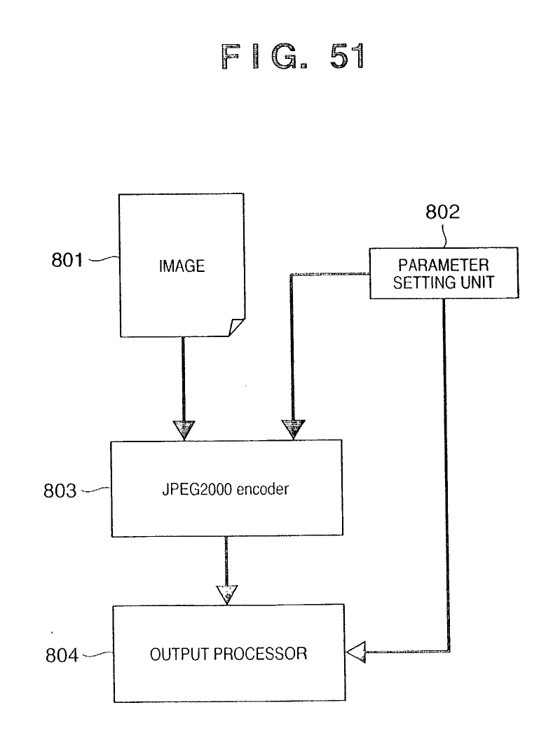

The information recording apparatus according to this embodiment will be described below. FIG. 51 is a schematic diagram showing the functional arrangement of the information recording apparatus according to the 32nd embodiment, and an original image to be input to that apparatus.

An image 801 is to be input to the information recording apparatus, and is to be encoded according to JPEG2000. A parameter setting unit 802 sets parameters required to control the operation of a JPEG2000 encoder 803 (to be described later). The parameters to be set include a maximum value of Resolution as resolution scalability, a maximum value of Layer as S/N ratio scalability, Component indicating the number of dimensions of a color space, and the like. Note that the number of Components indicates the number of color components of the input original image 801. The parameters may be set using a keyboard, mouse, or the like, and in this case, the parameter setting unit 802 serves as the aforementioned input device 104.

The JPEG2000 encoder 803 encodes the input image 801 by JPEG2000 in accordance with the parameters input by the parameter setting unit 802. Since encoding according to JPEG2000 is the state-of-the-art technique, a description thereof will be omitted.

An output processor 804 executes a process for recording encoded data on the storage medium, and serves as the aforementioned data input/output unit 106. The flow chart of the process to be executed by the output processor 804 is as shown in FIG. 10. That is, the data length (e.g., 4 kB) of data to be recorded on the special region is set with reference to the header of encoded data generated by the JPEG2000 encoder 803 (step S1001). In this case, for example, the Resolution number and Layer number of the required resolution and required S/N ratio are acquired with reference to the header, thus determining the data length of data to be recorded on the special region.

It is checked if the determined data length exceeds a predetermined threshold value (step S1002). If the determined data length does not exceed the threshold value, data for the determined data length from the head of the encoded data is recorded on the special region of the storage medium (step S1003), and the remaining data is recorded on the general region (step S1004).

<33rd Embodiment>

In the 31st and 32nd embodiments, encoded data according to JPEG2000 is recorded on the storage medium. This is because the encoding method has scalability in the image quality direction. In addition to JPEG2000, Progressive JPEG also has scalability in the image quality direction, and allows divisional recording.

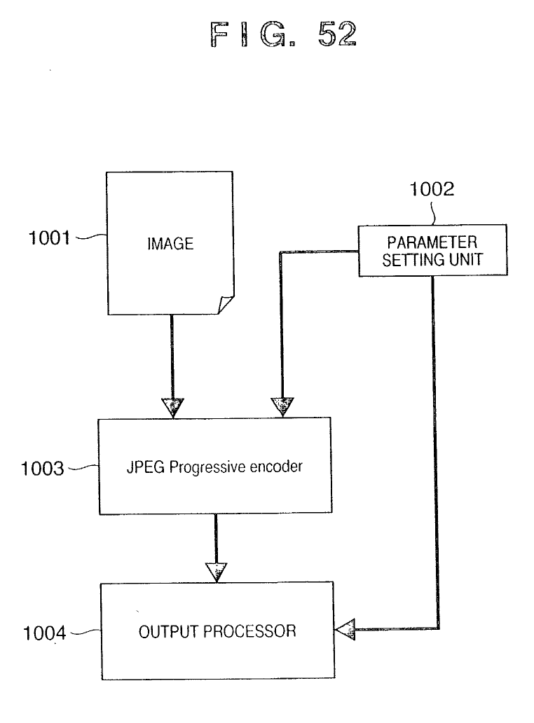

FIG. 52 is a schematic diagram showing the functional arrangement of an information recording apparatus for encoding an input image by Progressive JPEG according to set parameters, and divisionally recording the generated encoded data on a storage medium, and an image to be input. An image 1001 is to be encoded by Progressive JPEG. A parameter setting unit 1002 sets parameters required to control the operation of a JPEG Progressive encoder 1003, and has substantially the same functions as the parameter setting unit 802, except for parameters to be set. That is, the parameter setting unit 1002 sets the number of scans upon encoding as a parameter.

The JPEG Progressive encoder 1003 encodes the image 1001 by an encoding method according to Progressive JPEG. Since the encoding method according to Progressive JPEG is a state-of-the-art technique, a description thereof will be omitted. Since an output processor 1004 is the same as the output processor 804, a description thereof will be omitted.

With the above arrangement, even encoded data according to Progressive JPEG can be divisionally recorded in the same manner as encoded data according to JPEG2000.

As described above, according to the present invention, at least images with lowest image quality can be accessed at high speed.

<34th Embodiment>

The diagram which shows the basic arrangement of an information recording apparatus according to this embodiment is the same as that shown in FIG. 48. That is, a CPU 101 controls the operation of the overall apparatus and executes programs stored in a primary storage unit 102. The primary storage unit 102 serves as a rewritable memory represented by a RAM, and stores programs, data, and the like read out from a secondary storage unit 103 by the CPU 101.

The secondary storage unit 103 serves as a large-capacity storage device represented by a hard disk, and its storage capacity is normally larger than that of the primary storage unit 102. Hence, a computer program, data, and the like that cannot be stored in the primary storage unit 102 are stored in the secondary storage unit 103. Also, data and the like, which must be stored for a long period of time, are stored in the secondary storage unit 103. In general, programs are stored in the secondary storage unit 103, and when the CPU 101 executes a program, that program is loaded from the secondary storage unit 103 onto the primary storage unit 102.

An input device 104 comprises a pointing device such as a mouse, keyboard, and the like, a speech input device, or the like, and is used to input various instructions to the CPU 101. An output device 105 comprises a monitor, printer, and the like. A data input/output unit 106 is a device for reading/writing programs and data on a storage medium 107 on/from which they can be written and read out. If the storage medium 107 is a CD-RW, the data input/output unit 106 is a CD-ROM drive.

A process executed when the information recording apparatus with the above arrangement writes data stored in the secondary storage unit 103 on the storage medium 107 via the data input/output unit 106 will be explained below. Assume that data to be written is encoded image data according to JPEG2000 in this embodiment.

In this embodiment, as has been explained in the 31st embodiment using FIG. 25, JPEG2000 encoded data complying with LRCP mode has a format in which data are allocated in the order of Layer/Resolution/Component/Position.

JPEG2000 encoded data can be roughly classified into data for respective Layers. Data of respective Layers are encoded data of bitplanes which are obtained by known bitplane encoding, and are arranged in turn from a bitplane on the MSB side (Layer0) to a bitplane on the LSB side (LayerL). A Layer number corresponds to the S/N ratio of an image to be decoded to an original image, and the S/N ratio impairs (lowers) with decreasing Layer number. That is, respective Layer data are arranged in the JPEG2000 data in FIG. 25 in ascending order of S/N.

Furthermore, data of each Layer consists of data of respective Resolutions. Data of respective Resolutions are arranged in an order according to resolution numbers corresponding to resolutions (image sizes). The relationship between the resolutions and Resolution numbers is as shown in FIG. 4. An image with the lowest resolution has Resolution number 0, and the width and height of an image are doubled every time the Resolution number is incremented by 1. In each Layer, data are stored in ascending order of Resolution number.

Data of each Resolution consists of data of respective Components. Data of respective Components correspond to color data of an image. For example, if an image is formed by R, G, and B data, data of Component0, Component1, and Component2 respectively correspond to R, G, and B component data. That is, the number of Components matches the number of dimensions of a color space of the image.

Assume that maximum numbers of the Resolution number, Layer number, and Component number in a single JPEG2000 file are set in advance by an encoder, and data indicating these maximum values are contained in a header (not shown) appended to the data shown in FIG. 25. An information storage portion of the storage medium 107 is the same as that shown in FIG. 5. Assume that the storage medium 107 is a data rewritable optical disk such as a CD-RW or the like. In general, a device (e.g., a CD-ROM drive) that reads information recorded on a disk can access an inner peripheral region (e.g., inner sectors corresponding to 30% of the total number of sectors) of the optical disk faster than an outer peripheral region (sectors included in a region other than the inner peripheral region) as the access position becomes closer to the inner periphery. In the following description, the inner peripheral region will be referred to as a special region. Also, the outer peripheral region will be referred to as a general region hereinafter.

Furthermore, in this embodiment, the disk (storage medium 107) adopts UDF as its logical format. If the UDF format is used, one file can be segmented and written at a plurality of positions on the storage medium 107. The segmented data are recorded on the storage medium 107 using UDF entries as many as the number of segments.

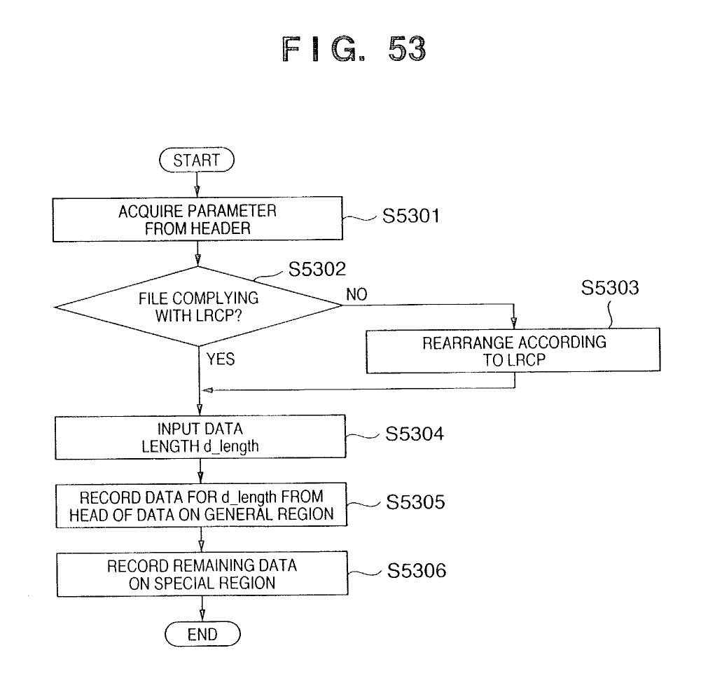

FIG. 53 is a flow chart showing the process for writing JPEG2000 data stored in the secondary storage unit 103 on the storage medium 107 by the data input/output unit 106 in the 34th embodiment.

The CPU 101 reads out encoded data stored in the secondary storage unit 103 onto the primary storage unit 102, and acquires the maximum Layer number, Resolution number, Component number, a Resolution number corresponding to a predetermined image size, and a stream recording method with reference to the header (step S5301).

The CPU 101 checks if the stream (encoded data shown in FIG. 25) recording method is LRCP (step S5302). If NO in step S5302, the CPU 101 rearranges encoded data (rearranges packets) according to LRCP mode into the arrangement shown in FIG. 2, and corrects the stream recording method recorded in the header to LRCP (step S5303).

Then, a data length d_length of data to be written in the special region is input (step S5304). In this embodiment, this data length d_length is stored in the secondary storage unit 103 as a fixed length, and is read out onto the primary storage unit 102 under the control of the CPU 101 in this step. Also, the data length d_length may be input using the input device 104, and may be similarly stored in the primary storage unit 102. Note that the data length d_length can be set to be the number of bytes of data required to form images with the lowest S/N ratio, e.g., all data contained in Layer0.

However, the data length d_length must be not more than half the total data length of encoded data. In the subsequent process, data for the data length d_length is recorded on the generation region as a region which is accessed at lower speed than the inner peripheral region. In general, the time required to read out full encoded data is shortened as the size of data recorded on the general region is smaller than that of data recorded on the special region. Hence, the data length d_length is preferably not more than a half of the total data length of encoded data. In this embodiment, the data length d_length indicates the number of bytes of data required to form images with the lowest S/N ratio, i.e., images with lowest image quality.

The CPU 101 controls the data input/output unit 106 to write encoded data for d_length from the head of the encoded data on the general region of the storage medium 107 using the UDF function (step S5305) and to write remaining data (data after the number of bytes for d_length from the head of the encoded data) on the special region of the storage medium 107 (step S5306).

With the aforementioned process, a data with a larger size (in this embodiment, data other than data required to form an image with lowest image quality in encoded data) can be recorded on the region that allows higher-speed access. In this manner, encoded data (data recorded on the general and special regions) recorded on the storage medium can be read out faster than a case wherein encoded data is recorded irrespective of the information storage region of the storage medium 107.

When encoded data of a plurality of images are to be recorded on the storage medium 107 and a list of these images is to be displayed, at least images with lowest image quality can be displayed on the display screen of the output device 105 as thumbnail images of the respective images. In this case, since each thumbnail image has a small size, even when the thumbnail image is recorded on the general region from which data is read out at an access speed lower than that of the special region, the time required to read out thumbnail images is not considerably prolonged.

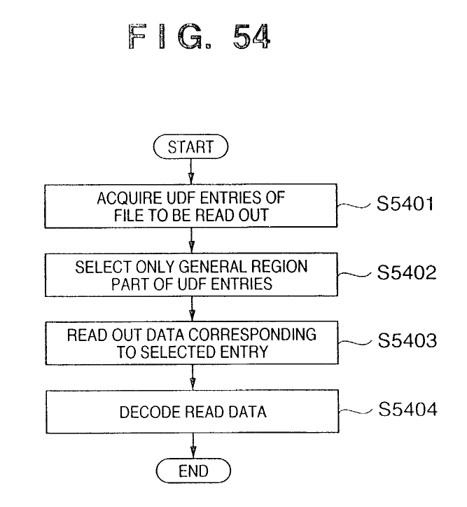

A method of reading out encoded data from the storage medium 107 on which the encoded data is recorded by the aforementioned method will be explained below. FIG. 54 is a flow chart showing the process for reading out only data recorded on the general region, i.e., only image data with lowest image quality.

The CPU 101 instructs the data input/output unit 106 to seek the storage medium 107, thus acquiring entries used to record encoded data to be read out (step S5401). The CPU 101 selects only entries indicating the special region from the acquired entries (step S5402). The CPU 101 instructs the data input/output unit 106 to read out data, which are recorded using the selected entries, onto the primary storage unit 102 (step S5403). The CPU 101 then decodes the data read out onto the primary storage unit 102 (step S5404). Note that a program used to decode data is stored in the secondary storage unit 103, and is read out onto the primary storage unit 102 as needed.

The flow chart of the process for reading out data recorded on the special and general regions, i.e., one encoded data, is the same as that shown in FIG. 8. That is, the CPU 101 instructs the data input/output unit 106 to seek the storage unit 107 to require entries used to record encoded data to be read out (step S801). The CPU 101 instructs the data input/output unit 106 to read out data, which are recorded using the acquired entries, onto the primary storage unit 102 (step S802). The CPU 101 then decodes data read out onto the primary storage unit 102 (step S803). Note that a program used to decode data is stored in the secondary storage unit 103, and is read out onto the primary storage unit 102 as needed.

As described above, since the information recording apparatus according to this embodiment can record data, which has a larger data size and is other than data required to form at least an image with lowest image quality, on a region (special region) that allows high-speed access of the storage medium, the entire encoded data can be accessed faster.

Even when data which has a smaller size and is required to form at least an image with lowest image quality is recorded on the general region, since the size of the image to be recorded is small, the time required to read out that image is not prolonged considerably.

The information recording apparatus according to this embodiment can solve the problem of Japanese Patent Laid-Open No. 03-053381, since data of a predetermined part of variable-length encoded data is recorded on the general region while maintaining full compatibility with the standardized JPEG2000 format. Also, even when JPEG2000 data is broken at an arbitrary position from the head of data, an image can be played back using only that data. Hence, whether or not data to be recorded on the general region is completed need not be checked.

Also, the information recording apparatus according to this embodiment can solve the problem of Japanese Patent Laid-Open No. 07-123346, since data can be prevented from being repetitively recorded on a region that allows high-speed access, and another region, and the use efficiency of the storage medium can be improved.

Furthermore, the information recording apparatus according to this embodiment can solve the problem of Japanese Patent Laid-Open No. 08-077325, since the same effect can be obtained not only for fixed-length encoded image data but also for variable-length encoded data.

In this embodiment, images with lowest image quality are recorded on the general region. However, the present invention is not limited to this. As described above, since at least images with the lowest S/N ratio need only be stored, data of Layer0 and Layer1 may be recorded on the general region, and subsequent data may be recorded on the special region.

In this embodiment, data to be recorded on the general region has a fixed length of a predetermined size. Alternatively, header information may be read to acquire the Resolution number and Layer number of the required resolution and required S/N ratio, and the data length of data to be recorded on the general region may be determined.

<35th Embodiment>

The information recording apparatus according to the 34th embodiment records encoded data, which has already been encoded by JPEG2000, on the storage medium. An information recording apparatus according to this embodiment comprises an encoder, receives an original image which is not encoded, encodes the input image by JPEG2000, and then records the encoded data on the storage medium, as described in the 34th embodiment.

The information recording apparatus according to this embodiment will be described below. The diagram showing the functional arrangement of the information recording apparatus according to this embodiment, and an original image to be input to that apparatus is the same as that shown in FIG. 51.

An image 801 is to be input to the information recording apparatus, and is to be encoded according to JPEG2000. A parameter setting unit 802 sets parameters required to control the operation of a JPEG2000 encoder 803 (to be described later). The parameters to be set include a maximum value of Resolution as resolution scalability, a maximum value of Layer as S/N ratio scalability, Component indicating the number of dimensions of a color space, and the like. Note that the number of Components indicates the number of color components of the input original image 801. The parameters may be set using a keyboard, mouse, or the like, and in this case, the parameter setting unit 802 serves as the aforementioned input device 104.

The JPEG2000 encoder 803 encodes the input image 801 by JPEG2000 in accordance with the parameters input by the parameter setting unit 802. Since encoding according to JPEG2000 is a state-of-the-art technique, a description thereof will be omitted.

An output processor 804 executes a process for recording encoded data on the storage medium, and serves as the aforementioned data input/output unit 106. The flow chart of the process to be executed by the output processor 804 is as shown in FIG. 12. That is, the data length (e.g., 4 kB) of data to be recorded on the special region is set with reference to the header of encoded data generated by the JPEG2000 encoder 803 (step S1201). In this case, for example, the Resolution number and Layer number of the required resolution and required S/N ratio are acquired with reference to the header, thus determining the data length of data to be recorded on the special region.

It is checked if the determined data length exceeds a predetermined threshold value (step S1202). If the determined data length does not exceed the threshold value, data for the determined data length from the head of the encoded data is recorded on the general region of the storage medium (step S1203), and the remaining data is recorded on the special region (step S1204).

<36th Embodiment>

In the 34th and 35th embodiments, encoded data according to JPEG2000 is recorded on the storage medium. This is because the encoding method has scalability in the image quality direction. In addition to JPEG2000, Progressive JPEG also has scalability in the image quality direction, and allows divisional recording.

The diagram showing the functional arrangement of an information recording apparatus for encoding an input image by Progressive JPEG according to set parameters, and divisionally recording the-generated encoded data on a storage medium, and an image to be input is the same as that shown in FIG. 52. An image 1001 is to be encoded by Progressive JPEG. A parameter setting unit 1002 sets parameters required to control the operation of a JPEG Progressive encoder 1003, and has substantially the same functions as the parameter setting unit 802, except for parameters to be set. That is, the parameter setting unit 1002 sets the number of scans upon encoding as a parameter.

The JPEG Progressive encoder 1003 encodes the image 1001 by an encoding method according to Progressive JPEG. Since the encoding method according to Progressive JPEG is a state-of-the-art technique, a description thereof will be omitted. Since an output processor 1004 is the same as the output processor 804, a description thereof will be omitted.

With the above arrangement, even encoded data according to Progressive JPEG can be divisionally recorded in the same manner as encoded data according to JPEG2000.

As described above, according to the present invention, data with a larger size in encoded data can be accessed faster.

<Another Embodiment>

Note that the present invention may be applied to either a system constituted by a plurality of devices (e.g., a host computer, interface device, reader, printer, and the like), or an apparatus consisting of a single equipment (e.g., a copying machine, facsimile apparatus, or the like).

The objects of the present invention are also achieved by supplying a recording medium (or storage medium), which records a program code of a software program that can implement the functions of the above-mentioned embodiments to the system or apparatus, and reading out and executing the program code stored in the storage medium by a computer (or a CPU or MPU) of the system or apparatus. In this case, the program code itself read out from the storage medium implements the functions of the above-mentioned embodiments, and the storage medium which stores the program code constitutes the present invention.

The functions of the above-mentioned embodiments may be implemented not only by executing the readout program code by the computer but also by some or all of actual processing operations executed by an operating system (OS) running on the computer on the basis of an instruction of the program code.

Furthermore, the functions of the above-mentioned embodiments may be implemented by some or all of actual processing operations executed by a CPU or the like arranged in a function extension card or a function extension unit, which is inserted in or connected to the computer, after the program code read out from the storage medium is written in a memory of the extension card or unit.

When the present invention is applied to the recording medium, that recording medium stores program codes corresponding to the aforementioned flow charts.

As described above, according to the present invention, image data that requires high-speed access upon reading data of image data to be recorded on a recording medium can be recorded on a region that allows high-speed access of the recording medium, thus shortening the access time to the recorded data.

The present invention is not limited to the above embodiments and various changes and modifications can be made within the spirit and scope of the present inventions. Therefore, to apprise the public of the scope of the present invention, the following claims are made.

What is claimed is:

1. An information recording apparatus for recording image data, which is compression-encoded by JPEG2000, on a recording medium having different access speeds depending on recording positions, comprising:
input means for inputting image data compression-encoded by JPEG2000; and
recording means for recording component data indicating a reduced-scale image in the input image data on a recording region that allows high-speed access in preference to remaining component data.

2. The apparatus according to claim 1, wherein said recording means records a bitstream for a predetermined length from a head of a bitstream of the input image data on the recording region.

3. An information recording apparatus for recording image data, which is compression-encoded by JPEG2000, on a recording medium having different access speeds depending on recording positions, comprising:
input means for inputting image data compression-encoded by JPEG2000; and
recording means for recording component data other than component data indicating a reduced-scale image in the input image data on a recording region that allows high-speed access in preference to the component data indicating the reduced-scale image.

4. The apparatus according to claim 3, wherein said recording means records a bitstream other than a bitstream for a predetermined length from a head of a bitstream of the input image data on the recording region.

5. The apparatus according to claim 1, wherein the recording medium is an optical disk, and
the recording region that allows high-speed access is assured on an inner peripheral portion of the optical disk.

6. The apparatus according to claim 1, wherein the reduced-scale image in the input image data is a thumbnail of the image data.

7. The apparatus according to claim 1, further comprising second recording means for recording component data other than predetermined component data of the image data, which is recorded on the recording region, on a second recording region.

8. The apparatus according to claim 1, further comprising designation means for designating component data that indicates the reduced-scale image from the input image data.

9. The apparatus according to claim 1, further comprising:
header information reading means for reading header information of the input image data; and
bitstream arranging means for rearranging the bitstream of the input image data to a predetermined bitstream on the basis of the read header information.

10. The apparatus according to claim 1, wherein a file system used to manage image data to be recorded on the recording medium is Universal Disk Format.

11. The apparatus according to claim 1, wherein data in the bitstream of the image data are arranged in the order of Resolution level, Layer, Component, and Position.

12. A method of controlling an information recording apparatus for recording image data, which is compression-encoded by JPEG2000, on a recording medium having different access speeds depending on recording positions, comprising:
the input step of inputting image data compression-encoded by JPEG2000; and
the recording step of recording component data indicating a reduced-scale image in the input image data on a recording region that allows high-speed access in preference to remaining component data.

13. A method of controlling an information recording apparatus for recording image data, which is compression-encoded by JPEG2000, on a recording medium having different access speeds depending on recording positions, comprising:
the input step of inputting image data compression-encoded by JPEG2000; and
the recording step of recording component data other than component data indicating a reduced-scale image in the input image data on a recording region that allows high-speed access in preference to the component data indicating the reduced-scale image.

14. A computer program for controlling an information recording apparatus for recording image data, which is compression-encoded by JPEG2000, on a recording medium having different access speeds depending on recording positions, comprising:
a program code of the input step of inputting image data compression-encoded by JPEG2000; and
a program code of the recording step of recording component data indicating a reduced-scale image in the input image data on a recording region that allows high-speed access in preference to remaining component data.

15. A recording medium storing a computer program of claim 14.

16. The apparatus according to claim 1, wherein said image data is a moving image data.

17. The apparatus according to claim 3, wherein said image data is a moving image data.

18. An information recording apparatus for recording image data, which is compression-encoded by JPEG2000, on a recording medium having different access speeds depending on recording positions, comprising:
input means for inputting image data, which is compression-encoded by JPEG2000, and in which image data of a predetermined image region is allocated on the most significant bit side;
designation means for designating the image data of the predetermined image region, which is allocated on the most significant bit side of the input image data; and
recording means for recording the designated image data on the most significant bit side on a recording region that allows high-speed access in preference to remaining image data.

19. The apparatus according to claim 18, wherein said recording means records a bitstream for a predetermined length from a head of a bitstream of the input image data on the recording region.

20. An information recording apparatus for recording image data, which is compression-encoded by JPEG2000, on a recording medium having different access speeds depending on recording positions, comprising:
input means for inputting image data compression-encoded by JPEG2000;
designation means for designating image data of a predetermined image region, which is allocated on the most significant bit side of the input image data; and
recording means for recording image data other than the designated image data on the most significant bit side on a recording region that allows high-speed access in preference to the image data on the most significant bit side.

21. The apparatus according to claim 20, wherein said recording means records a bitstream other than a bitstream for a predetermined length from a head of a bitstream of the input image data on the recording region.

22. The apparatus according to claim 18, wherein the recording medium is an optical disk, and
the recording region that allows high-speed access is assured on an inner peripheral portion of the optical disk.

23. The apparatus according to claim 18, further comprising second recording means for recording a bitstream other than a predetermined bitstream of the image data, which is recorded on the recording region, on a second recording region of the recording medium.

24. The apparatus according to claim 18, further comprising:
header information reading means for reading header information of the input image data; and
bitstream arranging means for rearranging a bitstream of the input image data to a predetermined bitstream on the basis of the read header information.

25. The apparatus according to claim 18, wherein a file system used to manage image data to be recorded on the recording medium is Universal Disk Format.

26. The apparatus according to claim 18, wherein data in a bitstream of the image data are arranged in the order of Layer, Resolution level, Component, and Position.

27. The apparatus according to claim 18, further comprising:
image region designation means for designating a predetermined image region of input image data;
compression encoding means for arranging image data of the predetermined image region on the most significant bit side, and compression-encoding the input image data by JPEG2000; and
parameter input means for inputting a predetermined parameter used upon compression-encoding by JPEG2000.

28. A method of controlling an information recording apparatus for recording image data, which is compression-encoded by JPEG2000, on a recording medium having different access speeds depending on recording positions, comprising:
the input step of inputting image data, which is compression-encoded by JPEG2000, and in which image data of a predetermined image region is allocated on the most significant bit side;
the designation step of designating the image data of the predetermined image region, which is allocated on the most significant bit side of the input image data; and
the recording step of recording the designated image data on the most significant bit side on a recording region that allows high-speed access in preference to remaining image data.

29. A method of controlling an information recording apparatus for recording image data, which is compression-encoded by JPEG2000, on a recording medium having different access speeds depending on recording positions, comprising:
the input step of inputting image data compression-encoded by JPEG2000;
the designation step of designating image data of a predetermined image region, which is allocated on the most significant bit side of the input image data; and
the recording step of recording image data other than the designated image data on the most significant bit side on a recording region that allows high-speed access in preference to the image data on the most significant bit side.

30. A computer program for controlling an information recording apparatus for recording image data, which is compression-encoded by JPEG2000, on a recording medium having different access speeds depending on recording positions, comprising:
a program code of the input step of inputting image data, which is compression-encoded by JPEG2000, and in which image data of a predetermined image region is allocated on the most significant bit side;
a program code of the designation step of designating the image data of the predetermined image region, which is allocated on the most significant bit side of the input image data; and
a program code of the recording step of recording the designated image data on the most significant bit side on a recording region that allows high-speed access in preference to remaining image data.

31. A recording medium storing a computer program of claim 30.

32. The apparatus according to claim 18, wherein said image data is a moving image data.

33. The apparatus according to claim 20, wherein said image data is a moving image data.

34. An information recording apparatus for recording an image, which is compression-encoded by JPEG2000, on a recording medium, a recording region of which is divided into a first recording region for recording a predetermined image component of the image, and a second recording region for recording remaining image components of the image, comprising:
input means for inputting an image, which is compression-encoded by JPEG2000, and is formed of a plurality of bitplanes;
first recording means for recording an image component formed by a predetermined number of bitplanes of the input image on the first recording region; and
second recording means for recording image components, other than the image component recorded on the first recording region, on the second recording region.

35. The apparatus according to claim 34, further comprising:
header information reading means for reading header information of the input image; and
bitstream arranging means for rearranging a bitstream of the input image to a predetermined bitstream on the basis of the read header information.

36. The apparatus according to claim 34, wherein said first recording means records an image component, which is formed by bitplanes required to decode an image with predetermined image quality, on the first recording region.

37. The apparatus according to claim 34, wherein said second recording means records image components, which are formed of a bitstream after a bitstream of the image component recorded on the first recording region, of a bitstream of the input image on the second recording region.

38. The apparatus according to claim 34, wherein said first recording means records an image component, which is formed by bitplanes for 8 bits from the most significant bit of a plurality of bitplanes that form the input image, on the first recording region.

39. The apparatus according to claim 34, wherein a file system used to manage image components of an image to be recorded on the recording medium is Universal Disk Format.

40. The apparatus according to claim 34, wherein said image data is a moving image data.

41. The apparatus according to claim 34, wherein data in a predetermined bitstream are arranged in the order of Layer, Resolution level, Component, and Position.

42. The apparatus according to claim 34, wherein the first recording region is assured on a portion that allows high-speed access in the recording medium.

43. The apparatus according to claim 34, wherein the recording medium is an optical disk, and
the first recording region that allows high-speed access is assured on an inner peripheral portion of the optical disk.

44. A method of controlling an information recording apparatus for recording a still image, which is compression-encoded by JPEG2000, on a recording medium, a recording region of which is divided into a first recording region for recording a predetermined image component of the still image, and a second recording region for recording remaining image components of the still image, comprising:
the input step of inputting a still image, which is compression-encoded by JPEG2000, and is formed of a plurality of bitplanes;
the first recording step of recording an image component formed by a predetermined number of bitplanes of the input still image on the first recording region; and
the second recording step of recording image components, other than the image component recorded on the first recording region, on the second recording region.

45. A computer program for controlling an information recording apparatus for recording a still image, which is compression-encoded by JPEG2000, on a recording medium, a recording region of which is divided into a first recording region for recording a predetermined image component of the still image, and a second recording region for recording remaining image components of the still image, comprising:
a program code of the input step of inputting a still image, which is compression-encoded by JPEG2000, and is formed of a plurality of bitplanes;
a program code of the first recording step of recording an image component formed by a predetermined number of bitplanes of the input still image on the first recording region; and
a program code of the second recording step of recording image components, other than the image component recorded on the first recording region, on the second recording region.

46. A recording medium storing a computer program of claim 45.

47. An information recording apparatus for recording a color image, which is compression-encoded by JPEG2000, on a recording medium having two recording regions with different access speeds, comprising:
input means for inputting a color image compression-encoded by JPEG2000;
first recording means for recording data associated with a predetermined component of the input color image on a first recording region that allows high-speed access; and
second recording means for recording data, other than the data associated with the predetermined component of the color image recorded on the first recording region, on a second recording region.

48. The apparatus according to claim 47, further comprising:
header information reading means for reading header information of the input color image; and
bitstream arranging means for rearranging a bitstream of the input color image to a predetermined bitstream on the basis of the read header information.

49. The apparatus according to claim 47, wherein a file system used to manage a color image to be recorded on the recording medium is Universal Disk Format.

50. The apparatus according to claim 47, wherein said first recording means records data associated with a predetermined component of the color image, which is required to decode an image with predetermined image quality, on the first recording region.

51. The apparatus according to claim 47, wherein said first recording means records a bitstream with a predetermined bit length of the input color image on the first recording region.

52. The apparatus according to claim 47, wherein the color image is defined by a YCbCr color space, and
the predetermined component is a Y component of the color image.

53. The apparatus according to claim 47, wherein the color image is defined by an RGB color space, and
the predetermined component is a G component of the color image.

54. The apparatus according to claim 47, wherein the color image is defined by an Lab color space, and
the predetermined component is an L component of the color image.

55. The apparatus according to claim 47, wherein said image data is a moving image data.

56. The apparatus according to claim 48, wherein data in the predetermined bitstream are arranged in the order of Component, Position, Resolution level, and Layer.

57. The apparatus according to claim 47, wherein the recording medium is an optical disk, and
the first recording region that allows high-speed access is assured on an inner peripheral portion of the optical disk.

58. A method of controlling an information recording apparatus for recording a color image, which is compression-encoded by JPEG2000, on a recording medium having two recording regions with different access speeds, comprising:
the input step of inputting a color image compression-encoded by JPEG2000;
the first recording step of recording data associated with a predetermined component of the input color image on a first recording region that allows high-speed access; and
the second recording step of recording data, other than the data associated with the predetermined component of the color image recorded on the first recording region, on a second recording region.

59. A computer program for controlling an information recording apparatus for recording a color image, which is compression-encoded by JPEG2000, on a recording medium having two recording regions with different access speeds, comprising:
a program code of the input step of inputting a color image compression-encoded by JPEG2000;
a program code of the first recording step of recording data associated with a predetermined component of the input color image on a first recording region that allows high-speed access; and
a program code of the second recording step of recording data, other than the data associated with the predetermined component of the color image recorded on the first recording region, on a second recording region.

60. A recording medium storing a computer program of claim 59.

61. An information recording apparatus for recording image data, which is compression-encoded by JPEG2000, on a recording medium having two recording regions with different access speeds, comprising:
input means for inputting image data, which is compression-encoded by JPEG2000, and consists of a plurality of packets;
first recording means for recording header information of each packet of the input image data on a first recording region; and
second recording means for recording image data, other than the header information recorded on the first recording region, on a second recording region that allows high-speed access.

62. The apparatus according to claim 61, wherein the recording medium is an optical disk, and
the second recording region is assured on an inner peripheral portion of the optical disk.

63. The apparatus according to claim 61, wherein said first recording means records header information of the image data on the first recording region.

64. The apparatus according to claim 61, wherein said second recording means records image data, other than the header information contained in each packet, on the second recording region.

65. The apparatus according to claim 61, wherein said first recording means records only header information with a predetermined data length of each packet on the first recording region.

66. An information recording apparatus for recording image data, which is compression-encoded by JPEG2000, on a recording medium having two recording regions with different access speeds, comprising:
input means for inputting image data, which is compression-encoded by JPEG2000, and consists of a plurality of packets;
first recording means for recording header information of each packet of the input image data on a first recording region that allows high-speed access; and
second recording means for recording image data, other than the header information recorded on the first recording region, on a second recording region.

67. The apparatus according to claim 66, wherein the recording medium is an optical disk, and
the first recording region is assured on an inner peripheral portion of the optical disk.

68. The apparatus according to claim 66, further comprising first storage means for storing the header information of each packet in header information of the image data on the basis of a marker contained in the header information of the image data.

69. The apparatus according to claim 66, further comprising second storage means for storing the header information of each packet in a tile header of the image data on the basis of a marker contained in the tile header.

70. The apparatus according to claim 66, further comprising:
header information reading means for reading header information of the input image data; and
analysis means for analyzing the header information of each packet on the basis of the read header information.

71. The apparatus according to claim 66, wherein a file system used to manage image data to be recorded on the recording medium is Universal Disk Format.

72. The apparatus according to claim 66, wherein data in a predetermined bitstream are arranged in the order of Layer, Resolution level, Component, and Position.

73. A method of controlling an information recording apparatus for recording image data, which is compression-encoded by JPEG2000, on a recording medium having two recording regions with different access speeds, comprising:
the input step of inputting image data, which is compression-encoded by JPEG2000, and consists of a plurality of packets;
the first recording step of recording header information of each packet of the input image data on a first recording region; and
the second recording step of recording image data, other than the header information recorded on the first recording region, on a second recording region that allows high-speed access.

74. A computer program for controlling an information recording apparatus for recording image data, which is compression-encoded by JPEG2000, on a recording medium having two recording regions with different access speeds, comprising:
a program code of the input step of inputting image data, which is compression-encoded by JPEG2000, and consists of a plurality of packets;
a program code of the first recording step of recording header information of each packet of the input image data on a first recording region; and
a program code of the second recording step of recording image data, other than the header information recorded on the first recording region, on a second recording region that allows high-speed access.

75. A recording medium storing a computer program of claim 74.

76. An information recording apparatus for recording image data, which is compression-encoded by JPEG2000, on a recording medium having two recording regions with different access speeds, comprising:
input means for inputting image data, which contains encoded data compression-encoded by JPEG2000;
XML box moving means for moving an XML box in the input image data to a position before a box that stores the encoded data;
first recording means for recording data with a predetermined data length from a head of the image data on a first recording region that allows high-speed access; and
second recording means for recording image data, other than the data recorded on the first recording region, on a second recording region.

77. The apparatus according to claim 76, further comprising:
header information reading means for reading header information from the input image data; and
bitstream arranging means for rearranging a bitstream of the input image data to a predetermined bitstream on the basis of the read header information.

78. The apparatus according to claim 76, wherein a file system used to manage image data to be recorded on the recording medium is Universal Disk Format.

79. The apparatus according to claim 76, wherein data in the predetermined bitstream are arranged in the order of Resolution level, Layer, Component, and Position.

80. The apparatus according to claim 76, wherein the recording medium is an optical disk, and the first recording region is assured on an inner peripheral portion of the optical disk.

81. The apparatus according to claim 76, wherein said first recording means records image data with the predetermined data length on the first recording region.

82. The apparatus according to claim 76, wherein said first recording means records image data with a data length at least to an end of the XML box on the first recording region.

83. The apparatus according to claim 76, wherein said first recording means records image data with a resolution corresponding to a thumbnail image on the first recording region in addition to the XML box.

84. The apparatus according to claim 61, wherein said image data is a moving image data.

85. An information recording apparatus for recording encoded data of an image, which is encoded by an encoding method having scalability in an image quality direction, on a disk-like storage medium having inner and outer peripheral regions, comprising:
recording means for recording data required to form an image with predetermined image quality of the encoded data of the image on the inner peripheral region of the storage medium.

86. The apparatus according to claim 85, wherein said recording means further records data, other than the data required to form the image with predetermined image quality, of the encoded data of the image on the outer peripheral region of the storage medium.

87. The apparatus according to claim 85, wherein said recording means comprises instruction means for instructing a data length of the data required to form the image with predetermined image quality.

88. The apparatus according to claim 85, further comprising encoding means for encoding an image by the encoding method, and
wherein said recording means records encoded data obtained by said encoding means on the storage medium.

89. The apparatus according to claim 85, wherein the encoding method is JPEG2000.

90. The apparatus according to claim 85, wherein the encoding method is Progressive JPEG.

91. An information recording method for recording encoded data of an image, which is encoded by an encoding method having scalability in an image quality direction, on a disk-like storage medium having inner and outer peripheral regions, comprising:
the recording step of recording data required to form an image with predetermined image quality of the encoded data of the image on the inner peripheral region of the storage medium.

92. A program for making a computer function as an information recording apparatus of claim 85.

93. A program for making a computer implement an information recording method of claim 91.

94. A computer readable recording medium storing a program of claim 92.

95. An information recording apparatus for recording encoded data of an image, which is encoded by an encoding method having scalability in an image quality direction, on a disk-like storage medium having inner and outer peripheral regions, comprising:
recording means for recording first data required to form an image with predetermined image quality of the encoded data of the image on the outer peripheral region of the storage medium.

96. The apparatus according to claim 95, wherein said recording means further records second data, other than the first data of the encoded data of the image on the inner peripheral region of the storage medium.

97. The apparatus according to claim 96, wherein a size of the first data is smaller than a size of the second data.

98. The apparatus according to claim 95, wherein said recording means comprises instruction means for instructing a data length of data required to form an image with predetermined image quality.

99. The apparatus according to claim 95, further comprising encoding means for encoding an image by the encoding method, and
wherein said recording means records encoded data obtained by said encoding means on the storage medium.

100. The apparatus according to claim 95, wherein the encoding method is JPEG2000.

101. The apparatus according to claim 95, wherein the encoding method is Progressive JPEG.

102. An information recording method for recording encoded data of an image, which is encoded by an encoding method having scalability in an image quality direction, on a disk-like storage medium having inner and outer peripheral regions, comprising:
the recording step of recording first data required to form an image with predetermined image quality of the encoded data of the image on the outer peripheral region of the storage medium.

103. A program for making a computer function as an information recording apparatus of claim 95.

104. A program for making a computer implement an information recording method of claim 102.

105. A computer readable recording medium storing a program of claim 103.
